(19) United States
(12) Patent Application Publication
(10) Pub. No.: US 2026/0202644 A1
(43) Pub. Date: Jul. 16, 2026

(54) OPTICAL SYSTEM AND CAMERA MODULE

(71) Applicant: LG INNOTEK CO., LTD., Seoul (KR)

(72) Inventors: Sang Yeon HAN, Seoul (KR); Duk Keun KWON, Seoul (KR)

(21) Appl. No.: 19/139,008

(22) PCT Filed: Dec. 13, 2023
(86) PCT No.: PCT/KR2023/020593

§ 371 Date: Jun. 13, 2025

(30) Foreign Application Priority Data
Dec. 13, 2022 (KR) 10-2022-0174251
Dec. 13, 2022 (KR) 10-2022-0174252
Dec. 19, 2022 (KR) 10-2022-0178790

(51) Int. Cl. G02B 9/62; G02B 13/00

(52) U.S. Cl. CPC G02B 9/62; G02B 13/0045

(57) ABSTRACT

An optical system according to an embodiment of the present invention comprises: a first lens formed to have a ring shape and a third lens disposed in the center portion of the first lens and having an object-side reflective surface; a second lens formed to have a ring shape and having an image-side reflective surface; a fourth lens; a fifth lens; and a sixth lens, the first to sixth lenses being arranged in sequence from an object side to a sensor side, wherein the first lens has positive (+) refractive power and the third lens has negative (−) refractive power.

### TECHNICAL FIELDS

The present invention relates to an optical system, a camera module including the same, and a camera module including a miniaturized lens module.

### BACKGROUND OF ARTS

Mobile communication devices, computers, laptops, vehicles, and other devices are equipped with cameras that can display or capture video information from their surroundings. As mobile communication devices become slimmer and computers and laptops become smaller, there is a growing demand for cameras that are compact, lightweight, and high-resolution.

In camera devices, to improve image quality, image stabilization (optical image stabilization, OIS) is required to correct image blur caused by user movement. In camera devices, image stabilization is achieved by moving the lens in a direction perpendicular to the optical axis.

However, with the recent trend toward higher resolution, the diameter of lenses has increased, leading to heavier lenses and, consequently, larger camera modules.

### DETAILED DESCRIPTION OF THE INVENTION

### Technical Subjects

The technical problem that the present invention seeks to solve is to provide a camera module that includes a miniaturized lens module.

The present invention aims to provide an imaging lens capable of wide-angle shooting.

Additionally, it aims to provide an imaging lens suitable for high resolution and compact in size.

Furthermore, it aims to provide an imaging lens with excellent aberration characteristics and good aberration correction capability.

### Technical Solution

To solve the above technical problems, the lens module according to an embodiment of the present invention may comprise: a lens barrel including a first opening at one end and a second opening at the other end; a first lens group disposed in the lens barrel and close to the first aperture; and a second lens group disposed within the lens barrel and close to the second opening, wherein the diameter of the first lens group is larger than the diameter of the second lens group, and the inner surface of the lens barrel may include an inclined surface formed between the portion where the first lens group is disposed and the portion where the second lens group is disposed.

Preferably, but not necessarily, the first lens group may include a first lens near the first opening and a second lens near the second lens group, and the second lens may be disposed by being spaced apart from the inclined surface of the lens barrel.

Preferably, but not necessarily, the second lens group may include at least one lens, and the distance between the first lens and the second lens in the optical axis direction may be the largest among the gaps between adjacent two lenses in the first lens group and the second lens group.

Preferably, but not necessarily, the second lens may include a flange and an effective diameter area, and at least a portion of the effective diameter area of the second lens in the optical axis direction may overlap with the inclined surface.

Preferably, but not necessarily, the second lens may include one surface in the direction of the first opening and another surface in the direction of the second opening, and in the optical axis direction, the other surface of the second lens may include a first reflective surface that overlaps with the inclined surface of the lens barrel.

Preferably, but not necessarily, the first lens may include one surface of a direction to the first opening and the other surface of a direction to the second opening, and in the optical axis direction, the one surface of the first lens may include a second reflective surface that overlaps with the second lens group.

Preferably, but not necessarily, the second lens group may include at least one lens, and the lens in the second lens group that is closest to the first lens group may have a fixed member fixed by an adhesive member on one surface.

Preferably, but not necessarily, a fixed member fixed by an adhesive member may be disposed on one surface of the lens adjacent to the first opening in the first lens group.

Preferably, but not necessarily, an inner surface of the lens barrel may include a first accommodation part where the flange of the second lens is disposed and a second accommodation part where the fixed member is disposed, and the inclined surface of the lens barrel may be formed by connecting the first accommodation part and the second accommodation part.

To solve the above technical problems, the lens module according to an embodiment of the present invention may comprise a lens barrel including a first opening at one end and a second opening at the other end; and a plurality of lenses disposed to a second opening direction from the first opening within the lens barrel, wherein, in the optical axis direction, the plurality of lenses includes a first lens and a second lens having the greatest distance between adjacent two lenses, and a third lens disposed between the second lens and the second opening, and wherein a fixed member may be disposed on one surface of the third lens and fixed thereto by an adhesive member.

Preferably, but not necessarily, an inclined surface may be formed between the portion where the second lens is disposed and the portion where the third lens is disposed on the inner surface of the lens barrel.

Preferably, but not necessarily, the second lens may be disposed in a spaced-apart manner from the inclined surface of the lens barrel.

Preferably, but not necessarily, the second lens may include one surface to the first opening direction (in the direction of the first opening) and other surface to the second opening direction (in the direction of the second opening), and the second lens may include a flange and an effective diameter area. In the optical axis direction, at least a portion of the effective diameter area of the second lens may overlap with the inclined surface.

Preferably, but not necessarily, the second lens may include one surface to a first opening direction (in the direction of the first opening) and other surface to a second opening direction (in the direction of the second opening), and in the optical axis direction, the other surface of the second lens may include a first reflective surface that overlaps with the inclined surface of the lens barrel.

Preferably, but not necessarily, the first lens may include one surface to the first opening direction (in the direction of the first opening) and other surface to the second opening direction (in the direction of the second opening), and in the optical axis direction, the surface of the first lens may include a second reflective surface that overlaps with the third lens.

To solve the above technical problems, an optical system according to another embodiment of the present invention may comprise: in order from the object side to the sensor side, a first lens formed in a ring shape and a third lens disposed at the center portion of the first lens and having a reflective surface on the object side; a second lens formed in a ring shape and having a reflective surface on the upper side; a fourth lens; a fifth lens; and a sixth lens, wherein the first lens has a positive (+) refractive power, and the third lens has a negative (−) refractive power.

Preferably, but not necessarily, the second lens may have a negative (−) refractive power.

Preferably, but not necessarily, the third lens may have a convex meniscus shape to the sensor side.

Preferably, but not necessarily, the diameter of a hole in the second lens may be larger than the effective diameter of the third lens.

Preferably, but not necessarily, the fourth lens and fifth lens may have a positive (+) refractive power, and the sixth lens may have a negative (−) refractive power.

Preferably, but not necessarily, the optical system may satisfy the following condition equation.

$$5 < \vert f 4 ∼ 6 / f 1 ∼ 3 \vert < 20 \qquad 〈 Condition equation 〉$$

(In the above condition equation, f1~3 is a composite focal length of the first lens group (LG1), which consists of the first to third lenses, and f4~6 is a composite focal length of the second lens group (LG2), which consists of the fourth to sixth lenses).

Preferably, but not necessarily, the optical system may satisfy the following condition equation.

$$0.5 < F / f 1 ∼ 3 < 1 \qquad 〈 Condition equation 〉$$

(In the above condition equation, F is the total focal length of the optical system, and f1~3 is the composite focal length of the first lens group (LG1), which consists of first to third lenses).

To solve the above technical problems, the optical system according to another embodiment of the present invention may comprise: in order from the object side to the sensor side, a first lens having a reflective surface on the object side of a center portion; a second lens including a hole in the center portion and having a reflective surface on the sensor side; and at least one lens disposed on the sensor side of the second lens, wherein the first lens has refractive indices of the center portion and the peripheral portion, excluding the center portion, that may have different signs.

Preferably, but not necessarily, the peripheral portion of the first lens may have a positive (+) refractive index, and the center portion of the first lens and the second lens may have a negative (−) refractive index.

Preferably, but not necessarily, the effective diameter of the center portion of the first lens may be smaller than the size of the hole of the second lens.

Preferably, but not necessarily, the curvature radius of the object side surface of the center portion of the first lens may have a negative (−) value, and the curvature radius of the sensor side surface of the center portion of the first lens may have a negative (−) value.

Preferably, but not necessarily, the at least one lens disposed on the sensor side of the second lens may include a fourth lens having a positive (+) refractive power; a fifth lens having a positive (+) refractive power; and a sixth lens having a negative (−) refractive power.

Preferably, but not necessarily, the optical system may satisfy the following condition equation.

$$10 < FOV < 30 \qquad 〈 Condition equation 〉$$

(In the above condition equation, FOV refers to the diagonal angle of view of the above optical system.)

Preferably, but not necessarily, the optical system may satisfy the following condition equation.

$$1 < Fno < 1.5 \qquad 〈 Condition equation 〉$$

(In the above condition equation, Fno may refer to the F-number of the above optical system.)

Preferably, but not necessarily, the optical system may satisfy the following condition equation:

$$1 < TTL / ImgH < 1.5 \qquad 〈 Condition equation 〉$$

(In the above condition, TTL is the optical axis distance from the object side surface of the first lens to the image sensor, and ImgH is the diagonal length of the image sensor.)

To solve the above technical problems, an optical system according to still another embodiment of the present invention may comprise: in order from the object side to the sensor side, a first lens including a hole in the center portion; a third lens disposed opposite to the hole of the first lens and having a reflective surface on the object side; a second lens formed in a ring shape and having a reflective surface on the upper side, a fourth lens disposed at the center portion of the second lens; a fifth lens; and a sixth lens, wherein the first lens has a positive (+) refractive power, and the third lens has a negative (−) refractive power.

Preferably, but not necessarily, the second lens and the fourth lens may have a negative (−) refractive power.

Preferably, but not necessarily, the third lens may have a convex meniscus shape to the sensor side.

Preferably, but not necessarily, a diameter of the hole in the first lens may be larger than the effective diameter of the third lens.

Preferably, but not necessarily, the fourth lens and the sixth lens may have a negative (−) refractive power, and the fifth lens may have a positive (+) refractive power.

Preferably, but not necessarily, the following condition equation may be satisfied.

$$1 < \vert f 1 ∼ 4 / f 5 ∼ 6 \vert < 2 \qquad 〈 Condition equation 〉$$

(In the above condition, f1~4 is a composite focal length of the first to fourth lenses (LG1), which is the first lens group (LG1) and f5~6 is a composite focal length of the fifth and sixth lenses (LG2) which is the second lens group (LG2)).

Preferably, but not necessarily, the following condition equation may be satisfied.

$$10 < FOV < 30 \qquad 〈 Condition equation 〉$$

(In the above condition, FOV is the diagonal angle of view (degrees) of the optical system).

To solve the above technical problem, an optical system according to an embodiment of the present invention may comprise: in order from the object side to the sensor side, a first lens including a hole in the center portion; a third lens having a reflective surface on the object side; a second lens including a reflective surface formed in a ring shape on the sensor side; and at least one lens disposed on the sensor side of the second lens, wherein the second lens may have different refractive indices in the center portion and the peripheral portion excluding the center portion.

Preferably, but not necessarily, the size of the hole in the first lens may be larger than the effective diameter of the third lens.

Preferably, but not necessarily, the at least one lens disposed on the sensor side of the second lens may include a fifth lens having a positive (+) refractive power and a sixth lens having a negative (−) refractive power.

Preferably, but not necessarily, the second lens may have a convex meniscus shape to the sensor side.

Preferably, but not necessarily, the third lens may have a convex meniscus shape to the sensor side.

Preferably, but not necessarily, the following condition equation may be satisfied.

$$2 < F / ImgH < 3 \qquad 〈 Condition equation 〉$$

(In the above condition, F denotes the total effective focal length and ImgH denotes the diagonal length of the image sensor.)

Preferably, but not necessarily, the following condition equation may be satisfied.

$$1.5 < Fno < 2 \qquad 〈 Condition equation 〉$$

(In the above condition equation, Fno may represent the F-number of the optical system.)

Preferably, but not necessarily, the following condition must be satisfied.

$$2.5 < CA\_Max / CA\_Min < 3 \qquad 〈 Condition equation 〉$$

(In the above condition, CA_Max refers to the maximum effective diameter of the lenses in the optical system, and CA_Min refers to the minimum effective diameter of the lenses in the optical system.)

### Advantageous Effects

According to the present embodiments, it is possible to provide a camera module that can be miniaturized and has a long focal length, enabling optimized telephoto (Tele) shooting (photographing).

Additionally, the camera module can provide fixed zoom (zoom) shooting without changing the magnification.

The optical system and camera module according to the embodiments can have improved optical characteristics. Specifically, in the optical system according to the embodiments, multiple lenses can have a set thickness, refractive power, and gap between adjacent lenses. As a result, the optical system and camera module according to the embodiment may have improved MTF characteristics, aberration control characteristics, resolution characteristics, etc., within a set field of view range, and may have good optical performance in the peripheral areas of the field of view.

Additionally, the optical system and camera module according to the embodiment can satisfy the specified field of view and achieve excellent optical characteristics. As a result, the optical system can provide a slimmer camera module. Therefore, the optical system and camera module can be provided for various applications and devices.

### BRIEF DESCRIPTION OF DRAWINGS

FIG. 1 is a perspective view of a camera module according to the present embodiment.

FIG. 2 is an exploded perspective view of a camera module according to the present embodiment.

FIG. 3 is a perspective view of a lens module according to the present embodiment.

FIG. 4 is a side view of a lens module according to the present embodiment.

FIG. 5 is a rear view of a lens module according to the present embodiment.

FIG. 6 is an exploded perspective view of a lens module according to the present embodiment.

FIGS. 7 and 8 are side sectional views of a lens module according to the present embodiment.

FIG. 9 is a perspective view of a lens module according to another embodiment of the present invention.

FIG. 10 is a side sectional view of an optical system according to the first embodiment and a camera module having the same.

FIG. 11 is a table showing the values of the aspheric coefficients of each lens surface and the conic constant (k) in the optical system according to the first embodiment.

FIG. 12 is a graph showing data for the diffraction MTF (Modulation Transfer Function) of the optical system according to the first embodiment.

FIG. 13 is a graph showing data for the aberration characteristics of the optical system according to the first embodiment.

FIG. 14 is a side cross-sectional view of an optical system according to a second embodiment and a camera module having the same.

FIG. 15 is a table showing the values of the aspheric coefficients of each lens surface and conic constants (k) in the optical system according to the second embodiment.

FIG. 16 is a graph showing data for the diffraction MTF (Modulation Transfer Function) of an optical system according to the second embodiment.

FIG. 17 is a graph showing data for the aberration characteristics of an optical system according to the second embodiment.

FIG. 18 is a side cross-sectional view of an optical system according to a third embodiment and a camera module comprising the same.

FIG. 19 is a table showing the values of the aspheric coefficients and conic constant (k) of each lens surface in an optical system according to the third embodiment.

FIG. 20 is a graph showing the data for the diffraction MTF (Modulation Transfer Function) of an optical system according to the third embodiment.

FIG. 21 is a graph showing data on the aberration characteristics of an optical system according to the third embodiment.

FIG. 22 is a side cross-sectional view of an optical system according to a fourth embodiment and a camera module comprising the same.

FIG. 23 is a table showing the values of the aspheric coefficients and conic constant (k) of each lens surface in an optical system according to the fourth embodiment.

FIG. 24 is a graph showing data on the diffraction MTF (Modulation Transfer Function) of an optical system according to the fourth embodiment.

FIG. 25 is a graph showing data on the aberration characteristics of an optical system according to the fourth embodiment.

FIG. 26 is an exploded perspective view of a camera module according to the present embodiment.

### BEST MODES

The preferred embodiments of the present invention will be described in detail below with reference to the accompanying drawings.

However, the technical concept of the present invention is not limited to the embodiments described herein, but may be implemented in various forms, and within the scope of the technical concept of the present invention, one or more components of the embodiments may be selectively combined or substituted.

Furthermore, the terms used in the embodiments of the present invention (including technical and scientific terms) shall be interpreted as having the meanings generally understood by those skilled in the art to which the present invention pertains, unless they are explicitly defined and described. Terms that are commonly used and defined in advance shall be interpreted in accordance with their meanings in the context of the relevant art.

Furthermore, the terms used in the embodiments of the present invention are for the purpose of describing the embodiments and are not intended to limit the scope of the invention.

In this specification, unless otherwise specified, singular terms include plural terms, and ‘at least one (or more than one)’ of A, B, and C means any combination of A, B, and C.

Furthermore, in describing the components of the embodiments of the present invention, terms such as ‘first,’ ‘second,’ ‘A,’ ‘B,’ ‘(a),’ and ‘(b)’ may be used. These terms are used solely to distinguish the components from one another and do not limit the nature, order, or sequence of the components.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

In the description of the invention, ‘object side surface’ may refer to the surface of the lens facing the object side with respect to the optical axis (OA), and ‘sensor side surface’ may refer to the surface of the lens facing the imaging surface (image sensor) with respect to the optical axis. ‘Object side surface’ may be referred to as “object surface,” and “sensor side surface” may be referred to as “image surface.” A convex surface of a lens may refer to a convex shape in the optical axis or paraxial region, and a concave surface of a lens may refer to a concave shape in the optical axis or paraxial region. The values listed in the table for lens data, such as curvature radius, center thickness, and optical axis spacing between lenses, may refer to values measured along the optical axis (unit: mm). The vertical direction may refer to the direction perpendicular to the optical axis, and the end of a lens or lens surface may refer to the end of the effective area of the lens through which incident light passes. The size of the effective diameter of the lens surface may have a measurement error of approximately ±0.4 mm depending on the measurement method. The term ‘paraxial region (near-axis region)’ refers to a very narrow region near the optical axis, where the distance from the optical axis (OA) to the light rays is almost zero. Hereinafter, the term ‘optical axis’ may refer to the center of each lens or a very narrow region near the optical axis.

The effective diameter is the diameter of the effective area where effective light enters each lens. The effective diameter is the length in the direction perpendicular to the optical axis (X, Y), and it is the average of the effective diameters on the object side and the sensor side of each lens. ‘Lens diameter’ may refer to the ‘effective diameter of the lens.’ ‘Lens diameter’ may refer to the overall diameter of the lens, including the flange portion of the lens beyond the effective area. Although the flange of the lens is not shown in the drawing, the flange may be a portion protruding from the side of the lens in a direction perpendicular to the optical axis for the purpose of attaching the lens to a barrel. The flange may not allow effective light to enter. Spacers may be additionally arranged between the flanges of different lenses for the purpose of attaching the lenses to a barrel.

Each lens may include an effective area and an ineffective area. The effective area may be the area through which light incident on each lens passes. In other words, the effective area may be defined as the effective region or effective path where incident light is refracted to realize optical characteristics. The ineffective (non-effective) area may be disposed around the effective area. The ineffective area may be the region where effective light does not enter in multiple lenses. In other words, the ineffective area may be a region unrelated to optical characteristics. Additionally, the edges of the ineffective area may be regions fixed to lens barrels or other structures that accommodate the lenses.

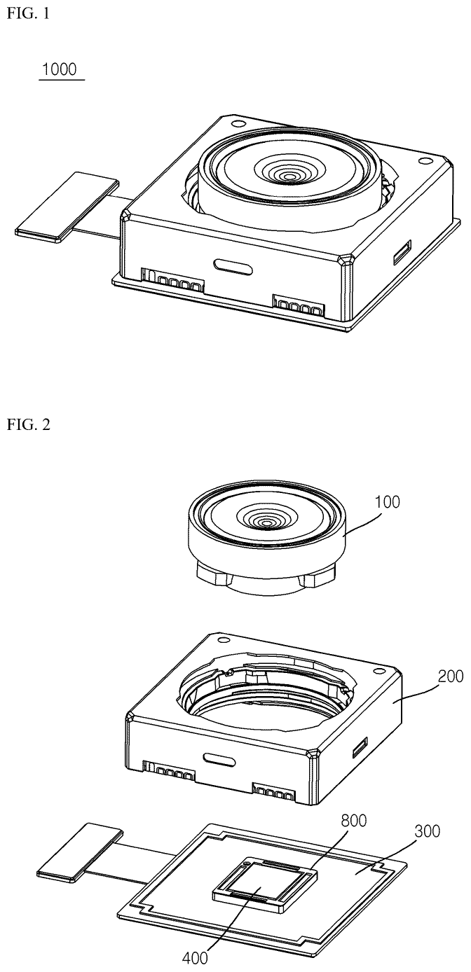

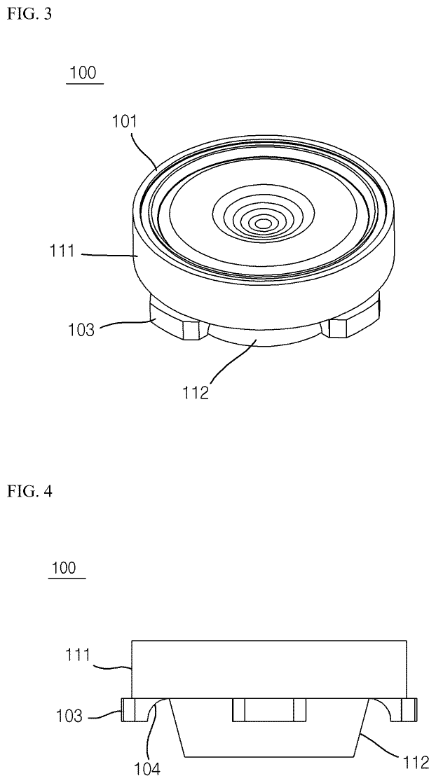

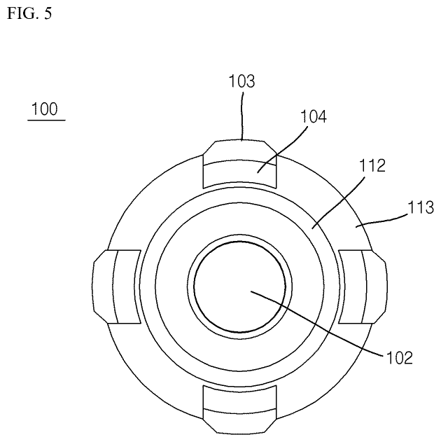

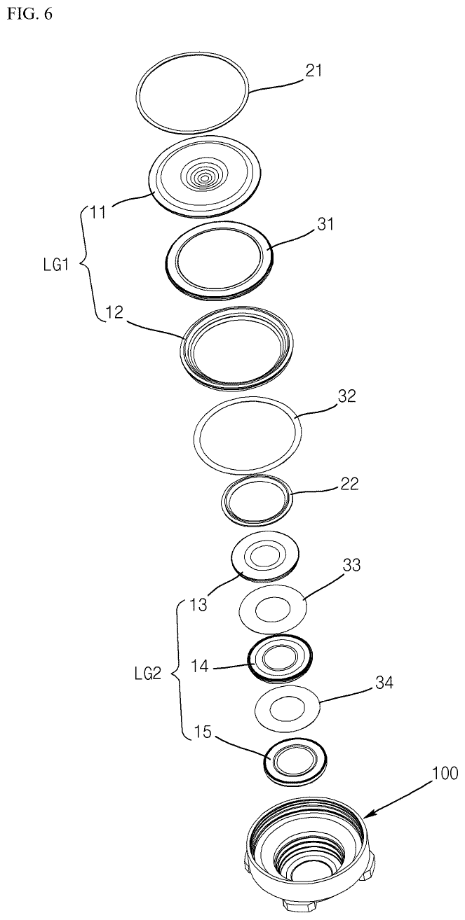

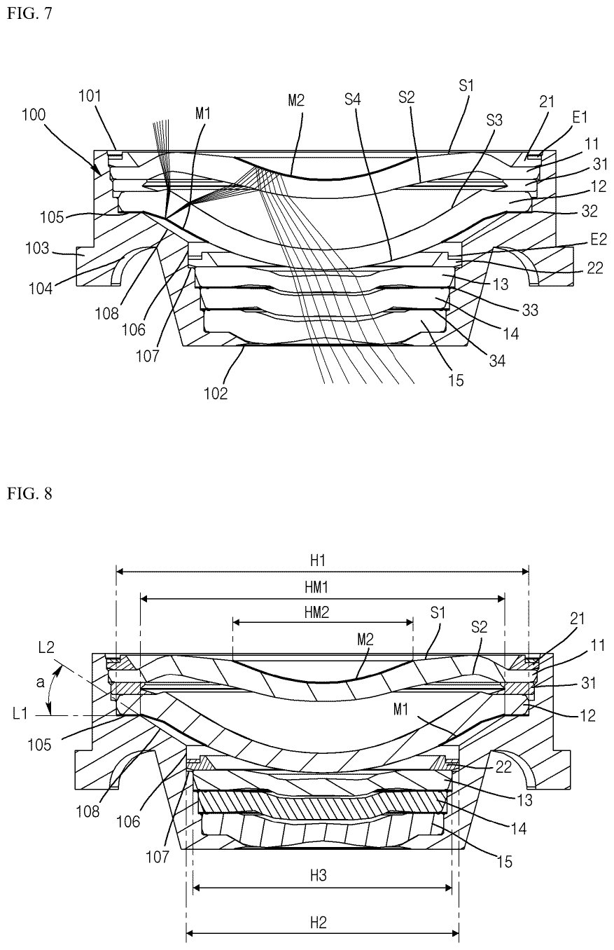

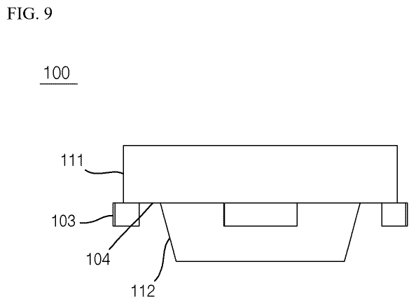

FIG. 1 is a perspective view of a camera module according to the present embodiment, FIG. 2 is an exploded perspective view of a camera module according to the present embodiment, FIG. 3 is a perspective view of a lens module according to the present embodiment, FIG. 4 is a side view of a lens module according to the present embodiment, FIG. 5 is a rear view of a lens module according to the present embodiment, FIG. 6 is an exploded perspective view of a lens module according to the present embodiment, FIGS. 7 and 8 are side sectional views of a lens module according to the present embodiment, and FIG. 9 is a perspective view of a lens module according to another embodiment of the present invention.

A camera module (1000) can capture one or more images or videos. The camera module (1000) may be a camera assembly. The camera module (1000) may be a camera unit. The camera module (1000) may include a lens driving device. The camera module (1000) may include a sensor driving device. The camera module (1000) may include a voice coil motor (VCM). The camera module (1000) may include an autofocus assembly. The camera module (1000) may include an image stabilization assembly. The camera module (1000) may include an autofocus device. The camera module (1000) may include an image stabilization device. The camera module (1000) may include an actuator. The camera module (1000) may include a lens driving actuator. The camera module (1000) may include a sensor driving actuator. The camera module (1000) may include an autofocus actuator. The camera module (1000) may include an image stabilization actuator.

The camera module (1000) may include a substrate (300). The substrate (300) may be a main substrate. The substrate (300) may be a printed circuit board (PCB). The substrate (300) may be connected to a power source of an optical device. The substrate (300) may include a connector connected to the power source of the optical device.

The camera module (1000) may include a base (500). The base (500) may be referred to as a filter holder. The base (500) may be disposed on the substrate (300). The base (500) may be disposed on top of the substrate (300). The base (500) may be disposed above the substrate (300). The base (500) may be fixed to the substrate (300). The base (500) may be coupled to the substrate (300). The base (500) may be adhered to the substrate (300) using an adhesive. The base (500) may be disposed between the substrate (300) and a housing. A filter (400) may be disposed on the base (500). The base (500) may have a window formed at its center with a certain area. The window may be formed larger than the area of the effective image area of an image sensor. A filter (400) may be disposed on the window.

The camera module (1000) may include a filter (400). The filter (400) may be disposed between the lens and the image sensor. The filter (400) may be disposed on the base (500). The filter (400) may be disposed on the window of the base (500). The filter (400) may block light of a specific frequency band from passing through the lens and entering the image sensor. The filter (400) may include an infrared cut-off filter (IRCF). The filter (400) may block infrared light from entering the image sensor.

The camera module (1000) may include a housing. The housing may be disposed on the base (500). The housing may be disposed on top of the base (500). The housing may be disposed above the base (500). The housing may be fixed to the base (500). The housing may be coupled to the base (500). The housing may be adhered to the base (500) using an adhesive. The housing may be disposed on the substrate (300). The housing may be disposed on top of the substrate (300). The housing may be formed as a separate member from the base (500).

The camera module (1000) may include a cover member (200). The cover member (200) may be coupled to the base (500). The cover member (200) may be coupled to the housing. The cover member (200) may be coupled to the substrate (300). The cover member (200) may be fixed to the base (500). The cover member (200) may be fixed to the housing. The cover member (200) may be fixed to the substrate (300). The cover member (200) may cover at least a portion of the base (500). The cover member (200) may cover at least a portion of the housing.

The cover member (200) may be a ‘cover can’ or ‘shield can’. The cover member (200) may be formed of a metal material. The cover member (200) may block electromagnetic interference (EMI). The cover member (200) may be electrically connected to the substrate (300). The cover member (200) may be grounded to the substrate (300).

The camera module (1000) may include a lens module. The lens module may be coupled to a bobbin. The lens module may include a lens barrel (100) and one or more lenses disposed within the lens barrel (100).

The bobbin may be disposed within the housing. The bobbin may be disposed on an inner side of the housing. At least a portion of the bobbin may be accommodated within the housing. The bobbin may be movably disposed within the housing. The bobbin may be movably disposed in the housing in the optical axis direction. The bobbin may be coupled to a lens. The bobbin may include a hollow hole or a hole. The lens may be disposed in the hollow hole or hole of the bobbin. An outer surface of the lens may be coupled to the inner surface of the bobbin.

The camera module (1000) may include a lens. The lens may be coupled to a bobbin. The lens may be fixed to the bobbin. The lens may move integrally with the bobbin. The lens may be screw-coupled to the bobbin. The lens may be adhered to the bobbin by an adhesive. The lens may be disposed at a location corresponding to the image sensor. An optical axis of the lens may align with an optical axis of the image sensor. The optical axis may be the z-axis. The lens may include multiple lenses. The lens may include five or six lenses.

The camera module (1000) may include an image sensor. The image sensor may be disposed on the substrate (300). The image sensor may be disposed between the substrate (300) and the base (500). The image sensor may be electrically connected to the substrate (300). The image sensor may be disposed below the lens module.

Light passing through the lens module and the filter (400) enters the image sensor, where an image is formed. The image sensor may include an effective image area. The image sensor may convert light incident on the effective image area into an electrical signal. The image sensor may include one or more of a CCD (charge-coupled device), MOS (metal oxide semiconductor), CPD, and CID.

The lens module according to this embodiment may include a lens barrel (100) and at least one lens disposed inside the lens barrel (100).

The lens barrel (100) may include a first opening (101) at one end and a second opening (102) at the other end. Light entering the image sensor may be incident through the first opening (101) of the lens barrel (100) and exit through the second opening (102). The lens barrel (100) may accommodate at least one lens formed in the hollow hole formed therein. The diameter of the first opening (101) may be larger than the diameter of the second opening (102).

At least one lens disposed within the lens barrel (100) may include a first lens group (LG1) disposed close to the first opening (101) and a second lens group (LG2) disposed close to the second opening (102).

The first lens group (LG1) may include multiple lenses. The first lens group (LG1) may include a first lens (11) closest to the first opening (101) and a second lens (12) closest to the second opening (102). The first lens group (LG1) may include a first lens (11) closest to the first opening (101) and a second lens (12) closest to the second lens group (LG2). The first lens group (LG1) may include additional lenses other than the first lens (11) and the second lens (12). For example, additional lenses may be disposed between the first lens (11) and the first opening (101) or between the second lens (12) and the second lens group (LG2).

A first spacer (31) may be disposed between the first lens (11) and the second lens (12). A second spacer (32) may be disposed between the second lens (12) and the inner surface of the lens barrel (100). The second lens (12) may be disposed in the first accommodation part, and a second spacer (32) may be disposed between the second lens (12) and the lower surface (105) of the first accommodation part. A first fixed member (21) fixed by an adhesive member (E1) may be disposed on one surface of the first lens (11). The first fixed member (21) may be referred to as a back ring. The first fixed member (21) may include a recessed groove on one surface, and an adhesive member (E1) may be disposed in the groove of the first fixed member (21). The adhesive member (E1) may be epoxy.

A member for fixing the lens to the barrel may include a spacer and a back ring. The spacer may be fixed by contacting both of the adjacent two lenses. The spacer may maintain a gap between the lenses and ensures flatness. The back ring may be fixed by contacting one surface of the lens and may be secured by applying an adhesive material around the back ring. The back ring may have an effect of preventing impact. Therefore, depending on the gap between adjacent lenses, the purpose of fixing the lenses, and the lens design, spacers or back rings may be selectively disposed.

At least one lens included in the first lens group (LG1) may include a reflective surface on one surface. The first lens (11) may include one surface (S1) in the direction of the first opening (101) and the other surface (S2) in the direction of second opening (102). The first lens (11) may include a second reflective surface (M2) at the center portion of the surface (S1) facing the first opening (101). The second lens (12) may include one surface (S3) in the direction of the first opening (101) and the other surface (S4) in the direction of second opening (102). The second lens (12) may include a first reflective surface (M1) in the peripheral portion of the other surface (S4) in the direction of second opening (102). The first reflective surface (M1) and the second reflective surface (M2) may be mirror-coated surfaces. The first reflective surface (M1) and the second reflective surface (M2) may be surfaces coated with a reflective coating. The second reflective surface (M2) may be coated in a hole shape at the center portion of the first lens (11). The first reflective surface (M1) may be coated in a ring shape except for the center portion of the second lens (12).

Light entering the first opening (101) passes through the one surface (S1) and the other surface (S2) of the area excluding the second reflective surface (M2) of the first lens (11), and is reflected in sequence by the first reflective surface (M1) of the second lens (12) and the second reflective surface (M2) of the first lens (11), then passes through the one surface (S3) and the second surface (S4) of the area excluding the first reflective surface (M1) of the second lens (12). This enables the camera module to be miniaturized while maintaining a long focal length, thereby providing a camera module capable of optimized wide-angle photography.

The second lens group (LG2) may include at least one lens. The second lens group (LG2) may include a third lens (13) adjacent to the first lens group (LG1). The second lens group (LG2) may additionally include a fourth lens (14) and a fifth lens (15) between the third lens (13) and the second opening (102). The second lens group (LG2) may additionally include lenses other than the third lens to the fifth lens (13, 14, 15).

A second fixed member (22) fixed by an adhesive member (E2) may be disposed on one surface of the third lens (13). The second fixed member (22) may be referred to as a back ring. The second fixed member (22) may be disposed on the lower surface (107) of the second accommodation part where the second fixed member (22) is disposed. The second fixed member (22) may include a recessed groove on one surface, and the adhesive member (E2) may be disposed in the groove of the second fixed member (22). The adhesive member (E2) may be epoxy. A third spacer (33) may be disposed between the third lens (13) and the fourth lens (14). A fourth spacer (34) may be disposed between the fourth lens (14) and the fifth lens (15).

Since the difference in diameter between the second lens (12) of the first lens group (LG1) and the third lens (13) of the second lens group (LG2) is large, it is more desirable to fix the second lens (12) and the third lens (13) by placing a second fixed member (22) on one surface of the third lens (13) rather than fixing them with a spacer.

In the optical axis direction, the two lenses with the largest gap between adjacent lenses among the lenses included in the first lens group (LG1) and the second lens group (LG2) may be lenses included in the first lens group (LG1). In the optical axis direction, the two lenses with the largest gap between adjacent lenses among the lenses included in the first lens group (LG1) and the second lens group (LG2) may be the two lenses including the reflective surfaces. The distance between the first lens (11) and the second lens (12) in the optical axis direction may be the largest distance between two adjacent lenses included in the first lens group (LG1) and the second lens group (LG2). By increasing the optical axis distance between the first lens (11) and the second lens (12) that form reflective surfaces, stray reflections and flare phenomena caused by the reflective surfaces can be minimized.

The diameter of the first lens group (LG1) may be larger than the diameter of the second lens group (LG2). The lenses included in the first lens group (LG1) may have a diameter that decreases as they move from the first opening (101) toward the second opening (102). When the first lens (11) and the second lens (12) are disposed in the direction from the first opening (101) to the second opening (102), the diameter of the first lens (11) may be larger than the diameter of the second lens (12). Among the lenses included in the first lens group (LG1), the diameter of the first lens (11) may be the largest. Among the lenses included in the first lens group (LG1), the diameter (H1) of the second lens (12) may be the smallest.

The lenses included in the second lens group (LG2) may have a diameter that decreases from the first opening (101) to the second opening (102). When the third lens (13), fourth lens (14), and fifth lens (15) are disposed in the direction from the first opening (101) to the second opening (102), the diameter of the third lens (13) may be larger than the diameter of the fourth lens (14), the diameter of the fourth lens (14) may be larger than the diameter of the fifth lens (15). Among the lenses included in the second lens group (LG2), the diameter (H3) of the third lens (13) may be the largest. Among the lenses included in the second lens group (LG2), the diameter of the fifth lens (15) may be the smallest.

The lenses included in the first lens group (LG1) and the second lens group (LG2) may include an effective area and an ineffective area. The ineffective area may be referred to as a flange. The effective area may be the area through which light incident on each lens passes. In other words, the effective area may be defined as the effective region or effective diameter where incident light is refracted to achieve optical characteristics. The ineffective area may be disposed around the perimeter of the effective area. The ineffective area may be the region where effective light does not enter in multiple lenses. In other words, the ineffective area may be a region unrelated to optical characteristics. Additionally, the ends of the ineffective area may be the region fixed to the lens barrel or other structures that accommodate the lens.

The average effective diameter (CA_LG1_Averg) of the lenses included in the first lens group (LG1) may be greater than the average effective diameter (CA_LG2_Averg) of the lenses included in the second lens group (LG2). For example, it may satisfy the condition 2<CA_LG1_Averg/CA_LG2_Aver<2.5. If the above condition is satisfied, the optical system disposed inside the lens barrel (100) may satisfy the Cassegrain optical system requirements and maintain a balance between the effects of reflection and refraction of light. Preferably, 2<CA_LG1_Averg/CA_LG2_Aver<2.4 may be satisfied.

The diameter (H1) of the second lens (12) may be larger than the diameter (HM1) of the first reflective surface (M1) of the second lens (12). The diameter (H3) of the third lens (13) may be smaller than the diameter (H3) of the second fixed member (22) disposed on one surface of the third lens (13). The diameter (HM2) of the second reflective surface (M2) of the first lens (11) may be smaller than the diameter (H2) of the second fixed member (22) and the diameter (H3) of the third lens (13). In the optical axis direction, the first reflective surface (M1) and the second reflective surface (M2) may not overlap. In the optical axis direction, the first reflective surface (M1) and the second reflective surface (M2) may overlap. In the optical axis direction, the first reflective surface (M1) may not overlap with the third lens (13). In the optical axis direction, the first reflective surface (M1) may overlap with the third lens (13). In the optical axis direction, the second reflective surface (M2) may overlap with the third lens (13).

The inner surface of the lens barrel (100) may have a staircase formed on the surface where the first lens group (LG1) and the second lens group (LG2) lenses are disposed. The inner surface of the lens barrel (100) may have a staircase formed on the surface where the fixed members and spacers, which are disposed between the first lens group (LG1) and the second lens group (LG2), are disposed.

The inner surface of the lens barrel (100) may form an inclined surface (108) between the portion where the first lens group (LG1) is disposed and the portion where the second lens group (LG2) is disposed. The inner surface of the lens barrel (100) may have an inclined surface (108) formed between the portion where the second lens (12) is disposed and the portion where the third lens (13) is disposed.

The inner surface of the lens barrel (100) may include a first accommodation part where the flange of the second lens (12) is disposed and a second accommodation part where the second fixed member (22) is disposed on one surface of the third lens (13). The second accommodation part may be the portion where the third lens (13) is disposed. The inclined surface (108) may be a surface connecting the first accommodation part and the second accommodation part. The first accommodation part may include a first surface (105) that contacts the flange of the second lens (12), and the second accommodation part may include a second surface (106) that contacts the second fixed member (22) and a third surface (107) connected to the second surface (106). The inclined surface (108) may be a surface connecting the first surface (105) and the second surface (106).

The angle (a) formed by an imaginary line (L1) extending from the first surface (105) and an imaginary line (L2) extending from the inclined surface (108) may be formed at an angle of 25 degrees to 40 degrees. The angle (a) formed by a virtual line (L1) extending from the first surface (105) and a virtual line (L2) extending from the inclined surface (108) may be formed at an angle of 30 degrees to 35 degrees. The inclined surface (108) may be formed at an angle of 25 degrees to 40 degrees relative to the first surface (105). The inclined surface (108) may be formed at an angle of 30 degrees to 35 degrees relative to the first surface (105).

The inclined surface (108) may be a necessary configuration for stably arranging the lenses of the first lens group (LG1) and the second lens group (LG2) because the difference in diameter between the lenses of the first lens group (LG1) and the second lens group (LG2) is large. In the optical axis direction, the inclined surface (108) may overlap with the lenses included in the first lens group (LG1). In the optical axis direction, the inclined surface (108) may overlap at least a portion of the second lens (12). In the optical axis direction, the inclined surface (108) may overlap the effective area of the second lens (12). In the optical axis direction, the inclined surface (108) may not overlap the flange of the second lens (12). In the optical axis direction, the inclined surface (108) may not overlap with the second reflective surface (M2) of the first lens (11). In the optical axis direction, the inclined surface (108) may overlap with the first reflective surface (M1) of the second lens (12). In the optical axis direction, the inclined surface (108) may not overlap with the lens included in the second lens group (LG2). In the optical axis direction, the inclined surface (108) may not overlap with the third lens (13).

Among the lenses included in the first lens group (LG1), the lens closest to the second lens group (LG2) may be spaced apart from the inclined surface (108). The second lens (12) may be disposed by being spaced apart at a distance from the inclined surface (108). The first reflective surface (M1) of the second lens (12) may be spaced apart from the inclined surface (108). At least a portion of the first reflective surface (M1) of the second lens (12) may be spaced apart from the inclined surface (108).

The outer surface of the lens barrel (100) may include a first outer surface (111) connected to the first opening (101), a second outer surface (112) connected to the second opening (102), and a third outer surface (113) connecting the first outer surface (111) and the second outer surface (112). The outer surface of the lens barrel (100) may include a protruder (103) that protrudes in a direction perpendicular to the optical axis from the first outer surface (111). The protruder (103) may protrude toward the second opening (102) from the third outer surface (113). Referring to FIG. 5, the protruder (103) may be formed in a plurality of members along the circumferential direction from the third outer surface (113).

The protruder (103) may include a recessed groove (104). The protruder (103) and the groove (104) may constitute a structure for coupling the lens barrel (100) to the bobbin. The groove (104) may be formed as a curved surface to reduce the weight of the lens barrel (100). The groove (104) may be formed as a flat surface, as shown in FIG. 9. It should be apparent that the shapes of the protruder (103) and the groove (104) are not limited to the above examples and may be varied depending on the design of the barrel and the bobbin.

The configuration of the optical system according to the first embodiment of the present invention will be described below with reference to the drawings.

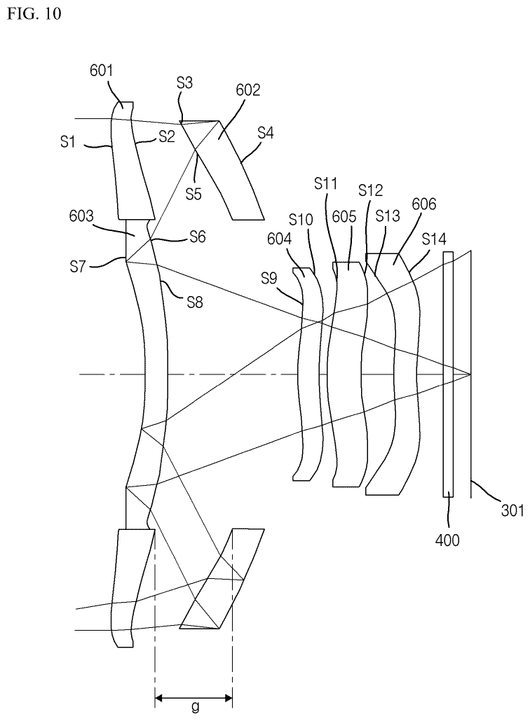

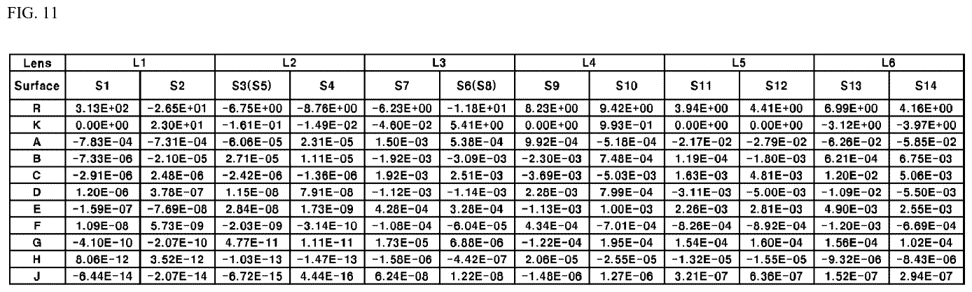

FIG. 10 is a side sectional view of the optical system according to the first embodiment and a camera module having the same.

The optical system according to the first embodiment may comprise a lens unit, which may include a first lens (601) to a sixth lens (606). The first to sixth lenses (601, 602, 603, 604, 605, 606) may be disposed sequentially along the optical path. Light corresponding to the information of the object may pass through the first lens (601) to the sixth lens (606) and the filter (400) and enter the image sensor (301).

The lens unit may be disposed in order from the object side along the optical path toward the image side, comprising the first lens (601), the second lens (602), the third lens (603), the fourth lens (604), the fifth lens (605), and the sixth lens (606). The lens unit may be disposed such that the first lens (601) and the third lens (603), the second lens (602), the fourth lens (604), the fifth lens (605), and the sixth lens (606) are sequentially combined from the object side to the image side.

In the optical system according to the first embodiment, the first lens (601) may be formed in a ring shape, and the third lens (603) may be disposed at the center portion of the first lens (601) and may be formed in a circular shape. Therefore, the lens unit may be disposed in the order of the first lens (601), the third lens (603), the second lens (602), the fourth lens (604), the fifth lens (605), and the sixth lens (606) from the object side toward the image side.

In other embodiments, one or more additional lenses, plates, and optical elements may be added between the first lens (601) and the sixth lens (606). Furthermore, one or more additional lenses, plates, and optical elements may be added in front of the first lens (601) or behind the sixth lens (606). Furthermore, one or more additional lenses, plates, or optical elements may be added between the aperture (STOP) and the lens, between the lens and the filter (400), and between the filter (400) and the image sensor (301). In this case, the filter (400) may be a plate lens. The refractive power of the plate lens may be ‘0’. The refractive power of the flat lens may be zero. Additionally, a filter layer may be disposed between the aperture (STOP) and the lens, between the lens and the filter (400), and between the filter (400) and the image sensor (301). In this case, the filter layer may be coated to function as a filter.

The lens unit may include a first lens (601). The first lens (601) may be closest to the object side. The first lens (601) may be the first lens disposed on the object side. The first lens (601) may be the first lens adjacent to the object side. An additional lens may be disposed between the first lens (601) and the second lens (602). The second to fifth lenses (602, 603, 604, 605) may be disposed between the first lens (601) and the sixth lens (606). An additional lens other than the second to fifth lenses (602, 603, 604, 605) may be disposed between the first lens (601) and the sixth lens (606). A lens may be additionally disposed between at least two of the first to sixth lenses (601, 602, 603, 604, 605, 606).

The first lens (601) may be formed in a ring shape including a hole at the center. The third lens (603) may be disposed at the center portion of the first lens (601). The first lens (601) and the third lens (603) may be formed integrally. The first lens (601) and the third lens (603) may be combined to form a single lens. The first lens (601) may include a center portion and an outer portion excluding the center portion. The curvature radii of the center portion and the peripheral portion of the first lens (601) may mutually be different. The peripheral portion of the first lens (601) may have the curvature radius of the first lens (601) or the curvature radius of the third lens (603). A staircase may be formed at a boundary between the center portion and the peripheral portion of the first lens (601). A staircase may be formed at the portion where the first lens (601) and the third lens (603) are connected. The center portion of the first lens (601) may have one surface mirror-coated. The center portion of the first lens (601) may have its object side mirror-coated. The center portion of the first lens (601) may be mirror-coated to have the curvature radius of the third lens (603).

Hereinafter, the first lens (601) and the third lens (603) are described as separate components from an optical design perspective; however, the first lens (601) may have a configuration where one surface of its center portion is mirror-coated, and the lens data for the first lens (601) may correspond to the outer portion of the first lens (601). The lens data for the third lens (603) may correspond to the center portion of the first lens (601). Therefore, the outer portion of the first lens (601) may refer to the first lens (601), and the center portion of the first lens (601) may refer to the third lens (603).

The first lens (601) may have a positive refractive power. The curvature radius of the object side (S1) of the first lens (601) may be positive. The curvature radius of the image side (S2) of the first lens (601) may be negative. The absolute value of the curvature radius of the object side (S1) of the first lens (601) may be greater than the absolute value of the curvature radius of the image side (S2) of the first lens (601). The first lens (601) may be a solid lens. Both sides of the first lens (601) may be formed as non-spherical surfaces. One of the two surfaces of the first lens (601) may be formed as a spherical surface, and the other surface may be formed as a non-spherical surface.

The first lens (601) may satisfy the range 1.6<N1<1.7. Additionally, the first lens (601) may satisfy the range 1.62<N1<1.68. N1 is the refractive index of the first lens (601). The first lens (601) may satisfy the range 15<V1<25. Additionally, the first lens (601) may satisfy the range 18<V1<22. V1 is the Abbe number of the first lens (601).

The lens unit may include a third lens (603). The third lens (603) may be closest to the object side. The third lens (603) may be the first lens disposed on the object side. The third lens (603) may be the first lens adjacent to the object side. The third lens (603) may be the third lens disposed on the object side along the optical path. An additional lens may be disposed between the third lens (603) and the second lens (602). The second to fifth lenses (602, 603, 604, 605) may be disposed between the third lens (603) and the sixth lens (606). Between the third lens (603) and the sixth lens (606), additional lenses other than the second to fifth lenses (602, 603, 604, 605) may be disposed.

The third lens (603) may be disposed in the hole of the first lens (601). The third lens (603) may be disposed in the center portion of the first lens (601), which is formed in a ring shape. The first lens (601), which is formed in a ring shape, may be disposed on the outer part of the third lens (603). The third lens (603) and the first lens (601) may be formed integrally. The third lens (603) and the first lens (601) may be combined to form a single lens. One surface of the third lens (603) may be mirror-coated. The object side (S7) of the third lens (603) may be mirror-coated. One surface of the third lens (603) may be a reflective surface capable of reflecting light. The object side (S7) of the third lens (603) may be a reflective surface capable of reflecting light.

The third lens (603) may have a negative (−) refractive power. The third lens (603) may have a convex meniscus shape on the sensor side. The third lens (603) may have an object side (S7) formed concavely. The third lens (603) may have the object side (S7) formed concavely relative to the optical axis. The third lens (603) may have the upper side surfaces (S6, S8) formed convexly. The third lens (603) may have the upper side surface (S6, S8) convexly formed relative to the optical axis. The object side or upper side of the third lens (603) may include at least one inflection point.

The curvature radius of the object side (S7) of the third lens (603) may be negative. The curvature radius of the object side (S7) of the third lens (603) relative to the optical axis may be negative. The curvature radius of the upper side (S6, S8) of the third lens (603) may be negative. The curvature radius of the upper surface (S6, S8) of the third lens (603) along the optical axis may be negative. The absolute value of the curvature radius of the object side (S7) of the third lens (603) may be smaller than the absolute value of the curvature radius of the upper surface (S6, S8) of the third lens (603). The third lens (603) may be a solid lens. Both surfaces of the third lens (603) may be formed as aspherical surfaces. One of the two surfaces of the third lens (603) may be formed as a spherical surface, and the other surface may be formed as an aspherical surface.

The third lens (603) may satisfy the range of 1.6<N3<1.7. Additionally, the third lens (603) may satisfy the range of 1.62<N3<1.68. N3 is the refractive index of the third lens (603). The third lens (603) may satisfy the range of 15<V3<25. Additionally, the third lens (603) may satisfy the range of 18<V3<22. V3 is the Abbe number of the third lens (603).

The lens unit may include a second lens (602). The second lens (602) may be the second lens disposed from the object side. The second lens (602) may be the second lens adjacent to the object side. The second lens (602) may be disposed between the first lens (601) and the image side. The second lens (602) may be disposed between the third lens (603) and the image side. The second lens (602) may be disposed between the first lens (601) and the fourth lens (604). An additional lens may be disposed between the second lens (602) and the first lens (601) or between the second lens (602) and the fourth lens (604).

The second lens (602) may be formed in a ring shape including a hole at the center. By including the hole, the second lens (602) can reduce the overall weight of the lens unit. One surface of the second lens (602) may be mirror-coated. The upper side surface (S4) of the second lens (602) may be mirror-coated. One surface of the second lens (602) may be a reflective surface capable of reflecting light. The upper side surface (S4) of the second lens (602) may be a reflective surface capable of reflecting light.

The second lens (602) may have a negative (−) refractive power. The curvature radius of the object side surface (S3, S5) of the second lens (602) may be negative. The curvature radius of the upper side surface (S4) of the second lens (602) may be negative. The absolute value of the curvature radius of the object side surface (S3, S5) of the second lens (602) may be smaller than the absolute value of the curvature radius of the upper side (S4) of the second lens (602). The second lens (602) may be a solid lens. The object side (S3, S5) or the upper side surface (S4) of the second lens (602) may include at least one inflection point.

The second lens (602) may satisfy the range 1.5<N2<1.6. Additionally, the second lens (602) may satisfy the range 1.52<N2<1.55. N2 is the refractive index of the second lens (602). The second lens (602) may satisfy the range 50<V2<60. Furthermore, the second lens (602) may satisfy the range of 52<V2<58. V2 is the Abbe number of the second lens (602).

Light incident from the object side passes through the first surface (S1) of the first lens (601) on the object side, the upper surface (S2) of the second lens (602), and the object side (S3) of the second lens (602), and is reflected at the upper side surface (S4) of the second lens (602), then passes through the object side (S5) of the second lens (602), the sixth surface (S6) of the third lens (603) on the upper side, and is reflected at the seventh surface (S7) of the third lens (603) on the object side, and then passes through the eighth surface (S8) of the third lens (603) on the sensor side. Light incident from the object side is reflected twice at the fourth surface (S4) of the second lens (602) and the seventh surface (S7) of the third lens (130) in the lens unit.

Here, the object side of the second lens (602) is described as being divided into the third surface (S3) and the fifth surface (S5), but the third surface (S3) and the fifth surface (S5) may be the same surface representing the object side surface of the second lens (602). The third surface (S3) of the second lens (602) may be the incident surface of the second lens (602), and the fifth surface (S5) may be the exit surface of the second lens (602). The third surface (S3) and the fifth surface (S5) of the second lens (602) may have different effective diameters. The effective diameter of the third surface (S3) of the second lens (602) may be larger than the effective diameter of the fifth surface (S5) of the second lens (602).

Although the image side of the third lens (603) was described as being divided into the sixth surface (S6) and the eighth surface (S8), the sixth surface (S6) and the eighth surface (S8) may be the same surface indicating the upper side of the third lens (603). The sixth surface (S6) of the third lens (603) may be the incident surface of the third lens (603), and the eighth surface (S8) may be the exit surface of the third lens (603). The sixth surface (S6) and the eighth surface (S8) of the third lens (603) may have different effective diameters. The effective diameter of the sixth surface (S6) of the third lens (603) may be larger than the effective diameter of the eighth surface (S8) of the third lens (603).

The diameter of the hole in the second lens (602) may be the same as the diameter of the third lens (603). The diameter of the hole in the second lens (602) may be larger than the size of the effective diameter of the third lens (603). The diameter of the hole in the second lens (602) may be the same as the size of the effective diameter of the sixth surface (S6) of the third lens (603). The difference between the diameter of the hole in the second lens (602) and the effective diameter of the third lens (603) may be less than 5, and preferably less than 3.

The distance (g) between the object-side edge portion of the hole in the second lens (602) and the upper edge portion of the hole in the first lens (601) may be 1.3 or more and less than 2. The distance (g) between the object-side edge portion of the hole of the second lens (602) and the edge portion of the third lens (603) may be 1.3 or more and less than 2. The distance (g) between the object-side edge portion of the hole in the second lens (602) and the edge portion of the third lens (603) may be the largest among the distances between adjacent lenses in the lens unit. This minimizes flare and ghosting phenomena caused by the reflection and refraction of light through the first to third lenses (601, 602, 603).

The first lens (601) and the third lens (603) may be made of the same material and may have the same refractive index and Abbe number. The difference in Abbe numbers between the first lens (601) and the second lens (602) may be between 30 and 40. The difference in the Abbe number between the third lens (603) and the second lens (602) may be 30 or more and 40 or less. The first lens (601) and the third lens (603) and the second lens (602) may have a large difference in the Abbe number, thereby correcting chromatic aberration caused by the same material. The Abbe number of one of the first to third lenses (601, 602, 603) may have a different value from the Abbe numbers of the remaining lenses.

The lens unit may include a fourth lens (604). The fourth lens (604) may be the fourth lens arranged along the optical (light) path from the object side. The fourth lens (604) may be the third lens disposed from the top. The fourth lens (604) may be disposed between the second lens (602) and the image side. The fourth lens (604) may be disposed between the second lens (602) and the fifth lens (605). An additional lens may be disposed between the fourth lens (604) and the second lens (602) or between the fourth lens (604) and the fifth lens (605).

The fourth lens (604) may have a positive (+) refractive power. The fourth lens (604) may have a convex meniscus shape on the object side. The fourth lens (604) may have the object side (S9) formed convexly. The fourth lens (604) may have the object side (S9) formed convexly relative to the optical axis. The fourth lens (604) may have an upper surface (S10) formed concavely. The fourth lens (604) may have the upper side surface (S10) formed concavely relative to the optical axis. The object side or upper surface of the fourth lens (604) may include at least one inflection point.

The curvature radius of the object side surface (S9) of the fourth lens (604) may be positive. The curvature radius of the object side surface (S9) of the fourth lens (604) in the optical axis may be positive. The curvature radius of the upper side surface (S10) of the fourth lens (604) may be positive. The curvature radius of the fourth lens (604) on the optical axis of the upper surface (S10) may be positive. The absolute value of the curvature radius of the object side surface (S9) of the fourth lens (604) may be smaller than the absolute value of the curvature radius of the upper surface (S10) of the fourth lens (604). The fourth lens (604) may be a solid lens. Both surfaces of the fourth lens (604) may be formed as aspherical surfaces. One of the two surfaces of the fourth lens (604) may be formed as a spherical surface, and the other surface may be formed as an aspherical surface.

The fourth lens (604) may satisfy the range 1.5<N4<1.6. Additionally, the fourth lens (604) may satisfy the range 1.52<N4<1.55. N4 is the refractive index of the fourth lens (604). The fourth lens (604) may satisfy the range 50<V4<60. Additionally, the fourth lens (604) may satisfy the range 52<V4<58. V4 is the Abbe number of the fourth lens (604).

The lens unit may include a fifth lens (605). The fifth lens (605) may be the fifth lens disposed along the optical path from the object side. The fifth lens (605) may be the second lens disposed from the image side. The fifth lens (605) may be disposed between the fourth lens (604) and the image side. The fifth lens (605) may be disposed between the fourth lens (604) and the sixth lens (606). An additional lens may be disposed between the fifth lens (605) and the fourth lens (604) or between the fifth lens (605) and the sixth lens (606).

The fifth lens (605) may have a positive (+) refractive power. The fifth lens (605) may have a convex meniscus shape on the object side. The fifth lens (605) may have the object side surface (S11) formed convexly. The fifth lens (605) may have the object side surface (S11) formed convexly relative to the optical axis. The fifth lens (605) may have an upper side surface (S12) formed concavely. The fifth lens (605) may have an upper side surface (S12) formed concavely relative to the optical axis. The object side surface or upper surface of the fifth lens (605) may include at least one inflection point.

The curvature radius of the object side surface (S11) of the fifth lens (605) may be positive. The curvature radius of the object side surface (S11) of the fifth lens (605) relative to the optical axis may be positive. The curvature radius of the upper side surface (S12) of the fifth lens (605) may be positive. The curvature radius of the upper surface (S12) of the fifth lens (605) along the optical axis may be positive. The absolute value of the curvature radius of the object side (S11) of the fifth lens (605) may be smaller than the absolute value of the curvature radius of the upper surface (S12) of the fifth lens (605). The fifth lens (605) may be a solid lens. Both surfaces of the fifth lens (605) may be formed as aspherical surfaces. One of the two surfaces of the fifth lens (605) may be formed as a spherical surface, and the other surface may be formed as an aspherical surface.

The fifth lens (605) may satisfy the range 1.6<N5<1.7. Additionally, the fifth lens (605) may satisfy the range 1.62<N5<1.69. N5 is the refractive index of the fifth lens (605). The fifth lens (605) may satisfy the range 10<V5<20. Additionally, the fifth lens (605) may satisfy the range 15<V5<20. V5 is the Abbe number of the fifth lens (605).

The lens unit may include a sixth lens (606). The sixth lens (606) may be the sixth lens disposed along the optical path from the object side. The sixth lens (606) may be the first lens disposed on the image side. The sixth lens (606) may be disposed between the fifth lens (605) and the upper side. An additional lens may be disposed between the sixth lens (606) and the image side.

The sixth lens (606) may have a negative (−) refractive power. The sixth lens (606) may have a convex meniscus shape on the object side. The sixth lens (606) may have an object side surface (S13) formed convexly. The sixth lens (606) may have the object side surface (S13) formed convexly relative to the optical axis. The sixth lens (606) may have an upper side surface (S14) formed concavely. The sixth lens (606) may have an upper side surface (S14) that is concave relative to the optical axis. The object side surface or upper side surface of the sixth lens (606) may include at least one inflection point.

The curvature radius of the object side surface (S13) of the sixth lens (606) may be positive. The curvature radius of the object side surface (S13) of the sixth lens (606) relative to the optical axis may be positive. The curvature radius of the upper side surface (S14) of the sixth lens (606) may be positive. The curvature radius of the upper side surface (S14) of the sixth lens (606) along the optical axis may be positive. The absolute value of the curvature radius of the object side surface of the sixth lens (606) may be smaller than the absolute value of the curvature radius of the upper surface of the sixth lens (606). The sixth lens (606) may be a solid lens. Both surfaces of the sixth lens (606) may be formed as aspherical surfaces. One of the two surfaces of the sixth lens (606) may be formed as a spherical surface, and the other surface may be formed as an aspherical surface. The sixth lens (606) may have a surface including one or more inflection points.

The sixth lens (606) may satisfy the range of 1.5<N6<1.6. Additionally, the sixth lens (606) may satisfy the range of 1.52<N6<1.55. N6 is the refractive index of the sixth lens (606). The sixth lens (606) may satisfy the range of 50<V6<60. Additionally, the sixth lens (606) may satisfy the range of 52<V6<58. V6 is the Abbe number of the sixth lens (606).

The lens unit may include multiple lens groups (LG1, LG2). Specifically, each of the multiple lens groups (LG1, LG2) includes at least one lens. For example, the lens unit may include a first lens group (LG1) and a second lens group (LG2) disposed sequentially along the optical axis (OA) toward the image sensor (301) from the object side.

The first lens group (LG1) may include at least one lens. The first lens group (LG1) may have three or fewer lenses. The second lens group (LG2) may include two or more lenses. The second lens group (LG2) may have two to four lenses. The first lens group (LG1) may include at least one lens that includes a reflective surface on one side. The second lens group (LG2) may not include a lens with a reflective surface. The first lens group (LG1) may include the first to third lenses (601, 602, 603). The second lens group (LG2) may include the fourth to sixth lenses (604, 605, 606).

The composite focal length (f1 to f3) of the first lens group (LG1) may be 10 to 20. The composite focal length (f4-6) of the second lens group (LG2) may be −100 to −250. The composite focal length (f1-3) of the first lens group (LG1) may be smaller than the composite focal length (f4-6) of the second lens group (LG2). The power of the first lens group (LG1) may be greater than that of the second lens group (LG2). The first lens group (LG1) is an area where reflection occurs twice, and the power of the first lens group (LG1) may affect the overall power of the lens unit. The second lens group (LG2), which is disposed above the first lens group (LG1), can correct aberrations and may have a smaller influence on the overall power of the lens unit. Additionally, the second lens group (LG2) may include lenses with multiple curvatures on one surface, enabling correction of spherical aberrations and improving the overall optical performance of the lens unit.

The minimum effective diameter of the lenses included in the first lens group (LG1) may be greater than the maximum effective diameter of the lenses included in the second lens group (LG2). The lens with the minimum effective diameter in the first lens group (LG1) is the third lens (603), and the lens with the maximum effective diameter in the second lens group (LG2) is the sixth lens (606). The average effective diameter size of the lenses included in the first lens group (LG1) may be larger than the average effective diameter size of the lenses included in the second lens group (LG2). That is, light entering the lens unit is reflected and refracted in the first lens group (LG1) and directed toward the direction adjacent to the optical axis, then enters the second lens group (LG2). This enables the implementation of narrow-angle and telephoto optical systems.

The lens unit may include an aperture (STOP). The aperture controls the amount of light entering the optical system. For lenses disposed between the object and the aperture, the effective diameter of the lens surfaces tends to increase as they move from the object side toward the aperture. For the lens surfaces disposed between the aperture and the sensor, there is a tendency for the effective diameter of the lens surfaces to decrease as one moves from the aperture toward the sensor side. The tendency for the effective diameter of lens surfaces to increase or decrease does not mean that the effective diameter of lens surfaces only increases or decreases. For example, it also includes cases where the effective diameter of lens surfaces increases and then decreases as moving from the aperture toward the sensor side.

The optical system or camera module may include a filter (400). The filter (400) may be disposed between the lens closest to the sensor side among the lenses of the lens unit (100) and the image sensor (301). For example, the filter (400) may be disposed between the nth lens and the image sensor (301).

The cover glass may be disposed between the filter (400) and the image sensor (301), protecting the upper part of the image sensor (301) and preventing a decrease in the reliability of the image sensor (301). The cover glass may be removed. The cover glass may be a protective glass.

The filter (400) may include an infrared filter or an infrared cut-off filter (IR cut-off). The filter (400) can transmit light within a set wavelength band and filter out light from other wavelength bands. When the filter (400) includes an infrared filter, it can block radiant heat emitted from external light from being transmitted to the image sensor (301). Additionally, the filter (400) can transmit visible light and reflect infrared light.

The following describes the concept of the diagonal field of view (DFOV) of the imaging lens according to the present embodiment.

The imaging lens may have a field of view (FOV) of less than 30°. In this case, the field of view (FOV) may be the diagonal field of view (DFOV). The diagonal field of view (DFOV) may be distinguished from the horizontal field of view (HFOV) and the vertical field of view (VFOV). For example, the horizontal field of view (HFOV) may be 0.8 times the diagonal field of view (DFOV). Additionally, the field of view (FOV) may be distinguished from the horizontal field of view (HFOV). The field of view (FOV) refers to the diameter of an imaginary circle connecting the four corners of the image sensor, while the horizontal field of view (HFOV) may refer to the radius of the aforementioned imaginary circle. In other words, the field of view (FOV) can be twice the horizontal field of view (HFOV).

The diagonal field of view (DFOV) may be calculated using the following mathematical formula.

$$DFOV = arctan ( I mgH / F ) \qquad [ Mathematical Equation ]$$

Here, ImgH denotes the diagonal length of the effective area of the image sensor (301), and F denotes the effective focal length of the entire optical system.

TABLE 1

| | | | | | | Semi | Focal |
|---|---|---|---|---|---|---|---|
| Lens | Surface | Radius | Thickness | nd | vd | Aperture | length |
| L1 | S1 | 313.354 | 0.894 | 1.661 | 20.348 | 5.301 | 36.609 |
| | S2 | −26.455 | 2.003 | | | 5.197 | |
| L2 | S3 | −6.748 | 0.437 | 1.534 | 55.656 | 4.932 | −4.899 |
| | S4 | −8.764 | −0.437 | | | 4.950 | |
| | S5 | −6.748 | −1.970 | | | 4.384 | |
| L3 | S6 | −11.776 | −0.450 | 1.661 | 20.348 | 3.000 | −2.454 |
| | S7 | −6.230 | 0.450 | | | 2.200 | |
| | S8 | −11.776 | 2.570 | | | 2.218 | |
| L4 | S9 | 8.231 | 0.400 | 1.534 | 55.656 | 1.980 | 109.018 |
| | S10 | 9.418 | 0.150 | | | 2.063 | |
| L5 | S11 | 3.940 | 0.680 | 1.671 | 19.238 | 2.044 | 34.560 |
| | S12 | 4.407 | 0.629 | | | 2.195 | |
| L6 | S13 | 6.991 | 0.450 | 1.534 | 55.656 | 2.210 | −20.271 |
| | S14 | 4.159 | 0.529 | | | 2.350 | |
| IR | | Infinity | 0.210 | | | 2.382 | |
| | | Infinity | 0.355 | | | 2.387 | |
| Image | | Infinity | 0.001 | | | 2.400 | |

Table 1 shows the surface number (Surface), curvature radius (Radius), center thickness of each lens or distance between lens surfaces (Thickness), refractive index (Index, nd), Abbe number (Abbe, vd), and focal length (Fcoal length) of the lens according to the first embodiment of the present invention. Here, the units for curvature radius and thickness or distance may be mm.

The first lens (601) and the second lens (602) have a ring shape, so the first lens (601) and the second lens (602) may refer only to the ring-shaped portions of the virtual circular-shaped lens formed by the curvature radius and thickness of the lenses in Table 1. Therefore, the data regarding the thickness of the first lens (601) and the second lens (602) in Table 1 may refer to the lens thickness at the optical axis of the virtual circular-shaped lens formed by the curvature radius and thickness.

TABLE 2

| | First | | First |
|---|---|---|---|
| | embodiment | | embodiment |
| TTL | 6.9000 | ΣIndex | 9.597 |
| TD(L1S1~L6S2) | 5.8052 | ΣAbb | 226.902 |
| F | 13.984 | ΣL_CT | 3.310 |
| f1~3 | 16.286 | CA_Max | 10.600 |
| f4~6 | −244.054 | CA_Min | 3.960 |
| Fno | 1.4047 | CA_Aver | 6.140 |
| ImgH | 4.80 | L_CT_max | 0.894 |
| FOV | 19.1 | L_CT_min | 0.400 |
| EPD | 9.9553 | L_CT_aver | 0.552 |
| BFL | 1.0948 | L2~L3 edge (g) | 1.56 |
| L3~L4 distance | 2.857 | L2 hole size | 6 |

Table 2 shows the characteristics of the imaging lens according to the first embodiment of the present invention.

TTL means the optical axis distance from the object side surface vertex of the first lens (601) to the image surface, TD means the optical axis distance from the object side vertex of the first lens (601) to the upper side of the sixth lens (606), F denotes the total focal length, f1 to f3 denote the composite focal lengths of the first lens (601) to the third lens (603), f4 to f9 denote the composite focal lengths of the fourth lens (604) to the sixth lens (606), Fno denotes the ratio of the focal length to the effective diameter of the lens, ImgH denotes the diagonal distance or maximum diagonal length of the image sensor (301), FOV denotes the diagonal field of view of the optical system, EPD denotes the diameter of the entrance pupil (effective opening), BFL denotes the optical axis distance from the upper surface of the sixth lens (606) to the image surface, L3~L4 distance denotes the distance between the third lens (603) and the fourth lens (604) along the optical axis, ΣIndex denotes the sum of the refractive indices of the first to sixth lenses (601, 602, 603, 604, 605, 606) that constitute the lens unit, ΣAbb denotes the sum of the Abbe numbers of the first to sixth lenses (601, 602, 603, 604, 605, 606) that constitute the lens unit, ΣL_CT denotes the sum of the center thicknesses of the first to sixth lenses (601, 602, 603, 604, 605, 606) that constitute the lens unit, CA_Max denotes the size of the maximum effective diameter among the first to sixth lenses (601, 602, 603, 604, 605, 606) that constitute the lens unit, CA_Min denotes the size of the smallest effective diameter among the first to sixth lenses (601, 602, 603, 604, 605, 606) that constitute the lens unit, CA_Aver denotes the average value of the effective diameter of the first to sixth lenses (601, 602, 603, 604, 605, 606) that constitute the lens unit, L_CT_max denotes the maximum value of the center thickness among the first to sixth lenses (601, 602, 603, 604, 605, 606) that constitute the lens unit, L_CT_min denotes the minimum value of the center thickness of the first to sixth lenses (601, 602, 603, 604, 605, 606) that constitute the lens unit, L_CT_aver denotes the average value of the center thickness of the first to sixth lenses (601, 602, 603, 604, 605, 606) that constitute the lens unit, L2~L3 edge denotes the distance between the edge region of the object side of the second lens (602) and the edge region of the upper side of the third lens (603), and L2 hole size denotes the diameter size of the hole in the second lens (602).

The configuration of the optical system according to the second embodiment of the present invention will be described below with reference to the drawings.

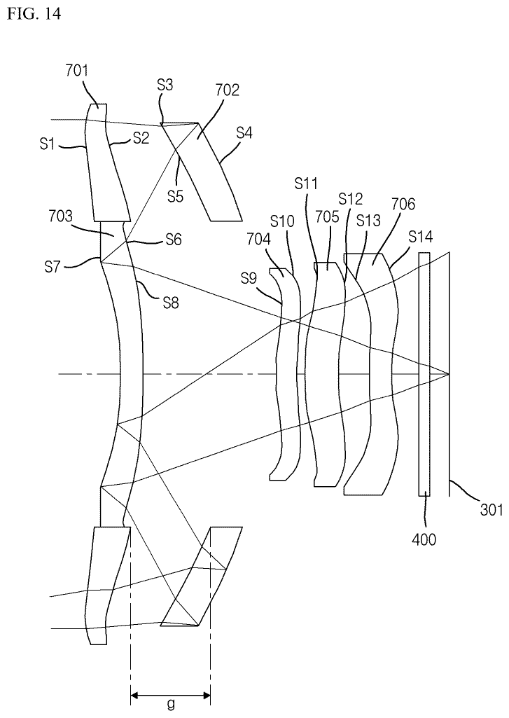

FIG. 14 is a side sectional view of the optical system according to the second embodiment and a camera module having the same.

The optical system according to the second embodiment may comprise a lens unit, which may include a first lens (701) to a sixth lens (706). The first to sixth lenses (701, 702, 703, 704, 705, 706) may be disposed sequentially along the optical path. Light corresponding to the information of the object may pass through the first lens (701) to the sixth lens (706) and the filter (400) and enter the image sensor (301).

The lens unit may be disposed in order from the object side along the optical path toward the image side, comprising the first lens (701), the second lens (702), the third lens (703), the fourth lens (704), the fifth lens (705), and the sixth lens (706). The lens unit may include a first lens (701) and a third lens (703) coupled in order from the object side to the image side, followed by a second lens (702), a fourth lens (704), a fifth lens (705), and a sixth lens (706).

In the optical system according to the second embodiment, the first lens (701) is formed in a ring shape, and the third lens (703) is disposed at the center portion of the first lens (701) and may be formed in a circular shape. Therefore, the lens unit may include the first lens (701), the third lens (703), the second lens (702), the fourth lens (704), the fifth lens (705), and the sixth lens (706) disposed in order from the object side toward the image side.

In another embodiment, one or more additional lenses, plates, or optical components may be added between the first lens (701) and the sixth lens (706). Additionally, one or more additional lenses, plates, or optical components may be added in front of the first lens (701) or behind the sixth lens (706). Additionally, one or more of other lenses, plates, and optical components may be added between the aperture (STOP) and the lens, between the lens and the filter (400), and between the filter (400) and the image sensor (301). In this case, the filter (400) may be a plate lens. The refractive power of the plate lens may be ‘0’. The refractive power of the flat lens may be zero. Additionally, a filter layer may be disposed between the aperture (STOP) and the lens, between the lens and the filter (400), and between the filter (400) and the image sensor (301). In this case, the filter layer may be coated to function as a filter.

The lens unit may include a first lens (701). The first lens (701) may be closest to the object side. The first lens (701) may be the first lens disposed on the object side. The first lens (701) may be the first lens adjacent to the object side. An additional lens may be disposed between the first lens (701) and the second lens (702). The second to fifth lenses (702, 703, 704, 705) may be disposed between the first lens (701) and the sixth lens (706). An additional lens other than the second to fifth lenses (702, 703, 704, 705) may be disposed between the first lens (701) and the sixth lens (706). At least two lenses may be additionally disposed between any two of the first to sixth lenses (701, 702, 703, 704, 705, 706).

The first lens (701) may be formed in a ring shape including a hole at the center. The third lens (703) may be disposed at the center portion of the first lens (701). The first lens (701) and the third lens (703) may be formed integrally. The first lens (701) and the third lens (703) may be combined to form a single lens. The curvature radii of the outer portion and the center portion of the first lens (701) may be different from each other. The outer portion of the first lens (701) may have the curvature radius of the first lens (701) and may have the curvature radius of the third lens (703). A staircase may be formed at a boundary between the center portion and the peripheral portion of the first lens (701). A staircase may be formed at the portion where the first lens (701) and the third lens (703) are connected. The center portion of the first lens (701) may have one side mirror-coated. The center portion of the first lens (701) may have its object side mirror-coated. The center portion of the first lens (701) may be mirror-coated to have the curvature radius of the third lens (703).

Below, the first lens (701) and the third lens (703) are described as separate components from an optical design perspective; however, the first lens (701) has a mirror coated on one surface of its center portion, and the lens data for the first lens (701) may correspond to the outer portion of the first lens (701), and the lens data for the third lens (703) may correspond to the center portion of the first lens (701). Therefore, the first lens (701) may refer to the lens corresponding to the outer portion of the first lens (701), and the third lens (703) may refer to the lens corresponding to the center portion of the first lens (701).

The first lens (701) may have a positive (+) refractive power. The curvature radius of the object side surface (S1) of the first lens (701) may be positive. The curvature radius of the image side surface (S2) of the first lens (701) may be negative. The absolute value of the curvature radius of the object side surface (S1) of the first lens (701) may be greater than the absolute value of the curvature radius of the image side surface (S2) of the first lens (701). The first lens (701) may be a solid lens. Both sides of the first lens (701) may be formed as non-spherical surfaces. One of the two surfaces of the first lens (701) may be formed as a spherical surface, and the other surface may be formed as a non-spherical surface.

The first lens (701) may satisfy the range 1.6<N1<1.7. Additionally, the first lens (701) may satisfy the range 1.62<N1<1.68. N1 is the refractive index of the first lens (701). The first lens (701) may satisfy the range 15<V1<25. Additionally, the first lens (701) may satisfy the range 18<V1<22. V1 is the Abbe number of the first lens (701).

The lens unit may include a third lens (703). The third lens (703) may be closest to the object side. The third lens (703) may be the first lens disposed on the object side. The third lens (703) may be the first lens adjacent to the object side. The third lens (703) may be the third lens disposed on the object side along the optical path. An additional lens may be disposed between the third lens (703) and the second lens (702). The second to fifth lenses (702, 703, 704, 705) may be disposed between the third lens (703) and the sixth lens (706). Between the third lens (703) and the sixth lens (706), additional lenses other than the second to fifth lenses (702, 703, 704, 705) may be disposed.

The third lens (703) may be disposed in a hole of the first lens (701). The third lens (703) may be disposed at the center portion of the first lens (701) formed in a ring shape. The first lens (701) formed in a ring shape may be disposed at the outer portion of the third lens (703). The third lens (703) and the first lens (701) may be formed integrally. The third lens (703) and the first lens (701) may be combined to form a single lens. One surface of the third lens (703) may be mirror-coated. The object side surface (S7) of the third lens (703) may be mirror-coated. One surface of the third lens (703) may be a reflective surface capable of reflecting light. The object side surface (S7) of the third lens (703) may be a reflective surface capable of reflecting light.

The third lens (703) may have a negative (−) refractive power. The third lens (703) may have a convex meniscus shape on the sensor side. The third lens (703) may have a concave object side (S7). The third lens (703) may have a concave object side (S7) relative to the optical axis. The third lens (703) may have the upper side surfaces (S6, S8) formed convexly. The third lens (703) may have the upper side surfaces (S6, S8) formed convexly relative to the optical axis. The object side surface or upper side surface of the third lens (703) may include at least one inflection point.

The curvature radius of the object side surface (S7) of the third lens (703) may be negative. The curvature radius of the object side surface (S7) of the third lens (703) relative to the optical axis may be negative. The curvature radius of the upper side surface (S6, S8) of the third lens (703) may be negative. The curvature radius of the upper side surface (S6, S8) of the third lens (703) along the optical axis may be negative. The absolute value of the curvature radius of the object side surface (S7) of the third lens (703) may be smaller than the absolute value of the curvature radius of the upper side surface (S6, S8) of the third lens (703). The third lens (703) may be a solid lens. Both surfaces of the third lens (703) may be formed as aspherical surfaces. One of the two surfaces of the third lens (703) may be formed as a spherical surface, and the other surface may be formed as an aspherical surface.

The third lens (703) may satisfy the range of 1.6<N3<1.7. Additionally, the third lens (703) may satisfy the range of 1.62<N3<1.68. N3 is the refractive index of the third lens (703). The third lens (703) may satisfy the range of 15<V3<25. Additionally, the third lens (703) may satisfy the range of 18<V3<22. V3 is the Abbe number of the third lens (703).

The lens unit may include a second lens (702). The second lens (702) may be the second lens disposed from the object side. The second lens (702) may be the second lens adjacent to the object side. The second lens (702) may be disposed between the first lens (701) and the upper side. The second lens (702) may be disposed between the third lens (703) and the upper side. The second lens (702) may be disposed between the first lens (701) and the fourth lens (704). An additional lens may be disposed between the second lens (702) and the first lens (701) or between the second lens (702) and the fourth lens (704).

The second lens (702) may be formed in a ring shape including a hole at the center. By including the hole, the second lens (702) can reduce the overall weight of the lens unit. One surface of the second lens (702) may be mirror-coated. The upper side surface (S4) of the second lens (702) may be mirror-coated. One surface of the second lens (702) may be a reflective surface capable of reflecting light. The upper side surface (S4) of the second lens (702) may be a reflective surface capable of reflecting light.

The second lens (702) may have a negative (−) refractive power. The curvature radius of the object side surface (S3, S5) of the second lens (702) may be negative. The curvature radius of the upper side surface (S4) of the second lens (702) may be negative. The absolute value of the curvature radius of the object side surface (S3, S5) of the second lens (702) may be smaller than the absolute value of the curvature radius of the upper side surface (S4) of the second lens (702). The second lens (702) may be a solid lens. The object side surface (S3, S5) or the upper side surface (S4) of the second lens (702) may include at least one inflection point.

The second lens (702) may satisfy the range of 1.5<N2<1.6. Additionally, the second lens (702) may satisfy the range of 1.52<N2<1.55. N2 is the refractive index of the second lens (702). The second lens (702) may satisfy the range of 50<V2<60. Additionally, the second lens (702) may satisfy the range of 52<V2<58. V2 is the Abbe number of the second lens (702).

Light incident from the object side passes through the first surface (S1) on the object side of the first lens (701), the second surface (S2) of the image side, and the third surface (S3) of the object side of the second lens (702), is reflected at the fourth surface (S4) of the second lens (702), which is the image surface, and then passes through the fifth surface (S5) of the second lens (702), which is the object side, and the sixth surface (S6) of the third lens (703), which is the image surface, and is reflected at the seventh surface (S7) of the third lens (703) on the object side, and then passes through the eighth surface (S8) of the third lens (703) on the sensor side. The light incident from the object side is reflected twice at the fourth surface (S4) of the second lens (702) and the seventh surface (S7) of the third lens (130) in the lens unit.

Here, the object side of the second lens (702) is described as being divided into the third surface (S3) and the fifth surface (S5), but the third surface (S3) and the fifth surface (S5) may be the same surface representing the object side surface of the second lens (702). The third surface (S3) of the second lens (702) may be the incident surface of the second lens (702), and the fifth surface (S5) may be the exit surface of the second lens (702). The third surface (S3) and the fifth surface (S5) of the second lens (702) may have different effective diameters. The effective diameter of the third surface (S3) of the second lens (702) may be larger than the effective diameter of the fifth surface (S5) of the second lens (702).

Here, although the image side of the third lens (703) is described as being divided into the sixth surface (S6) and the eighth surface (S8), the sixth surface (S6) and the eighth surface (S8) may be the same surface indicating the upper side surface of the third lens (703). The sixth surface (S6) of the third lens (703) may be the incident surface of the third lens (703), and the eighth surface (S8) may be the exit surface of the third lens (703). The sixth surface (S6) and the eighth surface (S8) of the third lens (703) may have different effective diameters. The effective diameter of the sixth surface (S6) of the third lens (703) may be larger than the effective diameter of the eighth surface (S8) of the third lens (703).

The diameter of the hole in the second lens (702) may be smaller than the diameter of the third lens (703). The diameter of the hole in the second lens (702) may be larger than the size of the effective diameter of the third lens (703). The diameter of the hole in the second lens (702) may be the same as the size of the effective diameter of the sixth surface (S6) of the third lens (703). The difference between the diameter of the hole in the second lens (702) and the effective diameter of the third lens (703) may be less than 5, and preferably less than 3.

The distance (g) between the object-side edge portion of the hole in the second lens (702) and the image side edge portion of the hole in the first lens (701) may be 1.3 or more and less than 2. The distance (g) between the object-side edge portion of the hole of the second lens (702) and the edge portion of the third lens (703) may be 1.3 or more and less than 2. The distance (g) between the object-side edge portion of the hole in the second lens (702) and the edge portion of the third lens (703) may be the largest among the distances between adjacent lenses in the lens unit. This minimizes flare and ghosting phenomena caused by reflection and refraction of light through the first to third lenses (701, 702, 703).

The first lens (701) and the third lens (703) may be made of the same material and may have the same refractive index and Abbe number. The difference in Abbe numbers between the first lens (701) and the second lens (702) may be between 30 and 40. The difference in the Abbe number between the third lens (703) and the second lens (702) may be 30 or more and 40 or less. The first lens (701), the third lens (703), and the second lens (702) can correct chromatic aberration caused by the same material by having a significant difference in their Abbe numbers. The Abbe number of one of the first to third lenses (701, 702, 703) may have a different value from the Abbe numbers of the remaining lenses.

The lens unit may include a fourth lens (704). The fourth lens (704) may be the fourth lens disposed along the optical path from the object side. The fourth lens (704) may be the third lens disposed from the image side. The fourth lens (704) may be disposed between the second lens (702) and the image side. The fourth lens (704) may be disposed between the second lens (702) and the fifth lens (705). An additional lens may be disposed between the fourth lens (704) and the second lens (702) or between the fourth lens (704) and the fifth lens (705).

The fourth lens (704) may have a positive (+) refractive power. The fourth lens (704) may have a convex meniscus shape on the object side. The fourth lens (704) may have the object side surface (S9) formed convexly. The fourth lens (704) may have the object side surface (S9) formed convexly relative to the optical axis. The fourth lens (704) may have an upper side surface (S10) formed concavely. The fourth lens (704) may have the upper side surface (S10) formed concavely relative to the optical axis. The object side or upper side surface of the fourth lens (704) may include at least one inflection point.

The curvature radius of the object side surface (S9) of the fourth lens (704) may be positive. The curvature radius of the object side surface (S9) of the fourth lens (704) relative to the optical axis may be positive. The curvature radius of the upper side surface (S10) of the fourth lens (704) may be positive. The curvature radius of the fourth lens (704) on the optical axis of the upper side surface (S10) may be positive. The absolute value of the curvature radius of the object side surface (S9) of the fourth lens (704) may be smaller than the absolute value of the curvature radius of the upper side surface (S10) of the fourth lens (704). The fourth lens (704) may be a solid lens. Both surfaces of the fourth lens (704) may be formed as aspherical surfaces. One of the two surfaces of the fourth lens (704) may be formed as a spherical surface, and the other surface may be formed as an aspherical surface.

The fourth lens (704) may satisfy the range of 1.5<N4<1.6. Additionally, the fourth lens (704) may satisfy the range of 1.52<N4<1.55. N4 is the refractive index of the fourth lens (704). The fourth lens (704) may satisfy the range of 50<V4<60. Additionally, the fourth lens (704) may satisfy the range of 52<V4<58. V4 is the Abbe number of the fourth lens (704).

The lens unit may include a fifth lens (705). The fifth lens (705) may be the fifth lens disposed along the optical path from the object side. The fifth lens (705) may be the second lens disposed from the image side. The fifth lens (705) may be disposed between the fourth lens (704) and the image side. The fifth lens (705) may be disposed between the fourth lens (704) and the sixth lens (706). An additional lens may be disposed between the fifth lens (705) and the fourth lens (704) or between the fifth lens (705) and the sixth lens (706).

The fifth lens (705) may have a positive (+) refractive power. The fifth lens (705) may have a convex meniscus shape on the object side. The fifth lens (705) may have the object side surface (S11) formed convexly. The fifth lens (705) may have the object side surface (S11) formed convexly relative to the optical axis. The fifth lens (705) may have a concave upper side surface (S12). The fifth lens (705) may have a concave upper side surface (S12) relative to the optical axis. The object side surface or upper side surface of the fifth lens (705) may include at least one inflection point.

The curvature radius of the object side (S11) of the fifth lens (705) may be positive. The curvature radius of the object side (S11) of the fifth lens (705) relative to the optical axis may be positive. The curvature radius of the upper side (S12) of the fifth lens (705) may be positive. The curvature radius of the upper surface (S12) of the fifth lens (705) along the optical axis may be positive. The absolute value of the curvature radius of the object side (S11) of the fifth lens (705) may be smaller than the absolute value of the curvature radius of the upper surface (S12) of the fifth lens (705). The fifth lens (705) may be a solid lens. Both surfaces of the fifth lens (705) may be formed as aspherical surfaces. One of the two surfaces of the fifth lens (705) may be formed as a spherical surface, and the other surface may be formed as an aspherical surface.

The fifth lens (705) may satisfy the range 1.6<N5<1.7. Additionally, the fifth lens (705) may satisfy the range 1.62<N5<1.68. N5 is the refractive index of the fifth lens (705). The fifth lens (705) may satisfy the range 20<V5<25. Additionally, the fifth lens (705) may satisfy the range 22<V5<24. V5 is the Abbe number of the fifth lens (705).

The lens unit may include a sixth lens (706). The sixth lens (706) may be the sixth lens disposed along the optical path from the object side. The sixth lens (706) may be the first lens disposed from the image side. The sixth lens (706) may be disposed between the fifth lens (705) and the image side. An additional lens may be disposed between the sixth lens (706) and the image side.

The sixth lens (706) may have a negative (−) refractive power. The sixth lens (706) may have a convex meniscus shape on the object side. The sixth lens (706) may have an object side surface (S13) formed convexly. The sixth lens (706) may have the object side surface (S13) formed convexly relative to the optical axis. The sixth lens (706) may have an upper side surface (S14) formed concavely. The sixth lens (706) may have an upper side surface (S14) that is concave relative to the optical axis. The object side surface or upper side surface of the sixth lens (706) may include at least one inflection point.

The curvature radius of the object side surface (S13) of the sixth lens (706) may be positive. The curvature radius of the object side surface (S13) of the sixth lens (706) relative to the optical axis may be positive. The curvature radius of the upper side surface (S14) of the sixth lens (706) may be positive. The curvature radius of the upper side surface (S14) of the sixth lens (706) along the optical axis may be positive. The absolute value of the curvature radius of the object side surface of the sixth lens (706) may be smaller than the absolute value of the curvature radius of the upper side surface of the sixth lens (706). The sixth lens (706) may be a solid lens. Both surfaces of the sixth lens (706) may be formed as aspherical surfaces. One of the two surfaces of the sixth lens (706) may be formed as a spherical surface, and the other surface may be formed as an aspherical surface. The sixth lens (706) may have a surface including one or more inflection points.

The sixth lens (706) may satisfy the range of 1.5<N6<1.6. Additionally, the sixth lens (706) may satisfy the range of 1.52<N6<1.57. N6 is the refractive index of the sixth lens (706). The sixth lens (706) may satisfy the range of 20<V6<50. Additionally, the sixth lens (706) may satisfy the range of 30<V6<40. V6 is the Abbe number of the sixth lens (706).

The lens unit may include multiple lens groups (LG1, LG2). Specifically, each of the multiple lens groups (LG1, LG2) may include at least one lens. For example, the lens unit may include a first lens group (LG1) and a second lens group (LG2) disposed sequentially along the optical axis (OA) toward the image sensor (301) from the object side.

The first lens group (LG1) may include at least one lens. The first lens group (LG1) may have three or fewer lenses. The second lens group (LG2) may be configured to include two or more lenses. The second lens group (LG2) may be configured to include two to four lenses. The first lens group (LG1) may be configured to include at least one lens that includes a reflective surface on one side. The second lens group (LG2) may not include a lens with a reflective surface. The first lens group (LG1) may include the first to third lenses (701, 702, 703). The second lens group (LG2) may include the fourth to sixth lenses (704, 705, 706).

The composite focal length (f1 to f3) of the first lens group (LG1) may be 10 to 20. The composite focal length (f4 to f6) of the second lens group (LG2) may be −100 to −250. The composite focal length (f1-3) of the first lens group (LG1) may be shorter than that of the second lens group (LG2). The power of the first lens group (LG1) may be greater than that of the second lens group (LG2). The first lens group (LG1) is an area where reflection occurs twice, and the power of the first lens group (LG1) may affect the overall power of the lens unit. The second lens group (LG2), which is disposed above the first lens group (LG1), can correct aberrations and may have a smaller influence on the overall power of the lens unit. Additionally, the second lens group (LG2) may include lenses with many bends on one surface, enabling correction of astigmatism and improving the overall optical performance of the lens unit.

Among the lenses included in the first lens group (LG1), the minimum effective diameter may be larger than the maximum effective diameter of the lenses included in the second lens group (LG2). The lens with the smallest effective diameter in the first lens group (LG1) is the third lens (703), and the lens with the largest effective diameter in the second lens group (LG2) is the sixth lens (706). The average effective diameter of the lenses included in the first lens group (LG1) may be larger than the average effective diameter of the lenses included in the second lens group (LG2). That is, light entering the lens unit is reflected and refracted in the first lens group (LG1) and directed toward the direction adjacent to the optical axis, entering the second lens group (LG2). This enables the implementation of a narrow-angle and telephoto optical system.

The lens unit may include an aperture (STOP). The aperture can control the amount of light entering the optical system. In the lenses placed between an object and the aperture, the effective diameter of the lens surface tends to increase as the distance from the object to the aperture increases. For the lens surfaces disposed between the aperture and the sensor, there is a tendency for the effective diameter of the lens surfaces to decrease as one moves from the aperture toward the sensor side. The tendency for the effective aperture of the lens surfaces to increase or decrease does not mean that the effective aperture of the lens surfaces only increases or decreases. For example, it also includes cases where the effective diameter of the lens surfaces increases and then decreases as moving from the aperture toward the sensor side.

The optical system or camera module may include a filter (400). The filter (400) may be disposed between the lens closest to the sensor side among the lenses of the lens unit (100) and the image sensor (301). For example, the filter (400) may be disposed between the nth lens and the image sensor (301).

The cover glass may be disposed between the filter (400) and the image sensor (301), protecting the upper part of the image sensor (301) and preventing a decrease in the reliability of the image sensor (301). The cover glass may be removable. The cover glass may be a protective glass.

The filter (400) may include an infrared filter or an infrared cut-off filter (IR cut-off). The filter (400) may transmit light within a set wavelength band and filter out light from other wavelength bands. When the filter (400) includes an infrared filter, it can block radiant heat emitted from external light from being transmitted to the image sensor (301). Additionally, the filter (400) can transmit visible light and reflect infrared light.

TABLE 3

| | | | | | | Semi | Focal |
|---|---|---|---|---|---|---|---|
| Lens | Surface | Radius | Thickness | nd | vd | Aperture | length |
| L1 | S1 | 167.413 | 0.906 | 1.636 | 23.901 | 5.301 | 35.797 |
| | S2 | −26.497 | 2.017 | | | 5.197 | |
| L2 | S3 | −6.899 | 0.451 | 1.534 | 55.656 | 4.932 | −5.036 |
| | S4 | −8.990 | −0.451 | | | 4.950 | |
| | S5 | −6.899 | −2.003 | | | 4.384 | |
| L3 | S6 | −11.860 | −0.450 | 1.636 | 23.901 | 3.000 | −2.527 |
| | S7 | −6.341 | 0.450 | | | 2.200 | |
| | S8 | −11.860 | 2.603 | | | 2.218 | |
| L4 | S9 | 7.646 | 0.400 | 1.534 | 55.656 | 1.980 | 83.849 |
| | S10 | 9.046 | 0.150 | | | 2.063 | |
| L5 | S11 | 3.913 | 0.670 | 1.636 | 23.901 | 2.044 | 28.371 |
| | S12 | 4.653 | 0.584 | | | 2.195 | |
| L6 | S13 | 5.301 | 0.450 | 1.567 | 37.565 | 2.210 | −15.362 |
| | S14 | 3.199 | 0.528 | | | 2.350 | |
| IR | | Infinity | 0.210 | | | 2.382 | |
| | | Infinity | 0.384 | | | 2.387 | |
| Image | | Infinity | 0.001 | | | 2.400 | |

Table 3 shows the surface number (Surface), curvature radius (Radius), center thickness of each lens or distance between lens surfaces (Thickness), refractive index (Index, nd), Abbe number (Abbe, vd), and focal length (Focal length) of the lens according to the second embodiment of the present invention. Here, the units for the curvature radius and thickness or distance may be mm.

Since the first lens (701) and the second lens (702) have a ring shape, the first lens (701) and the second lens (702) may refer only to the ring-shaped portions of the virtual circular-shaped lens formed by the curvature radius and thickness of the lenses in Table 3. Therefore, the data regarding the thickness of the first lens (701) and the second lens (702) in Table 3 may refer to the lens thickness at the optical axis of the virtual circular-shaped lens formed by the curvature radius and thickness.

TABLE 4

| | First | | Second |
|---|---|---|---|
| | embodiment | | embodiment |
| TTL | 6.9000 | ΣIndex | 9.542 |
| TD(L1S1~L6S2) | 5.7770 | ΣAbb | 220.580 |
| F | 13.985 | ΣL_CT | 3.328 |
| f1~3 | 16.460 | CA_Max | 10.6 |
| f4~6 | −127.001 | CA_Min | 3.96 |
| Fno | 1.4007 | CA_Aver | 6.14 |
| ImgH | 4.80 | L_CT_max | 0.906 |
| FOV | 19.1 | L_CT_min | 0.4 |
| EPD | 9.9843 | L_CT_aver | 0.555 |
| BFL | 1.1230 | L2~L3 edge (g) | 1.59 |
| L3~L4 distance | 2.905 | L2 hole size | 6 |

Table 4 shows the characteristics of the imaging lens according to the second embodiment of the present invention.

TTL means the optical axis distance from the object side surface vertex of the first lens (701) to the image surface, TD means the optical axis distance from the object side surface vertex of the first lens (701) to the upper side surface of the sixth lens (706), F denotes the total focal length, f1 to f3 denote the composite focal lengths of the first lens (701) to the third lens (703), f4 to f9 denote the composite focal lengths of the fourth lens (704) to the sixth lens (706), Fno denotes the ratio of the focal length to the effective diameter of the lens, ImgH denotes the diagonal distance or maximum diagonal length of the image sensor (301), FOV denotes the diagonal field of view of the optical system, EPD denotes the diameter of the entrance pupil (effective opening), BFL denotes the optical axis distance from the upper side surface of the sixth lens (706) to the image surface, L3~L4 distance denotes the distance between the third lens (703) and the fourth lens (704) along the optical axis, ΣIndex denotes the sum of the refractive indices of the first to sixth lenses (701, 702, 703, 704, 705, 706) constituting the lens unit, ΣAbb denotes the sum of the Abbe numbers of the first to sixth lenses (701, 702, 703, 704, 705, 706) that constitute the lens unit, ΣL_CT denotes the sum of the center thicknesses of the first to sixth lenses (701, 702, 703, 704, 705, 706) that constitute the lens unit, CA_Max denotes the maximum effective diameter of the first to sixth lenses (701, 702, 703, 704, 705, 706) that constitute the lens unit, CA_Min denotes the size of the smallest effective diameter among the first to sixth lenses (701, 702, 703, 704, 705, 706) that constitute the lens unit, CA_Aver denotes the average value of the effective diameter of the first to sixth lenses (701, 702, 703, 704, 705, 706) that constitute the lens unit, L_CT_max denotes the maximum value of the center thickness among the first to sixth lenses (701, 702, 703, 704, 705, 706) that constitute the lens unit, L_CT_min denotes the minimum value of the center thickness of the first to sixth lenses (701, 702, 703, 704, 705, 706) that constitute the lens unit, L_CT_aver denotes the average value of the center thickness of the first to sixth lenses (701, 702, 703, 704, 705, 706) that constitute the lens unit, L2~L3 edge denotes the distance between the edge region of the object side surface of the second lens (702) and the edge region of the upper side surface of the third lens (703), and L2 hole size denotes the diameter size of the hole in the second lens (702).

The optical system according to the first and second embodiments described above may satisfy at least one or more of the mathematical equations described below. Accordingly, the optical system according to the first and second embodiments may have improved optical characteristics. For example, if the optical system according to the present embodiment satisfies at least one of the mathematical equations, the optical system can effectively control aberration characteristics such as chromatic aberration and distortion aberration, and can have good optical performance not only in the center portion but also in the peripheral portion of the field of view (FOV). Additionally, the optical system according to the first and second embodiments may have improved resolution. Furthermore, the thickness of the lens at the optical axis (OA) and the gap between adjacent lenses at the optical axis (OA) as described in the mathematical equations may be referred to the embodiments disclosed above.

$$0.1 < BFL / TTL < 0.3 \qquad [ Mathematical Equation 1 ]$$

In Mathematical Equation 1, TTL (Total track length) denotes the distance (mm) along the optical axis (OA) from the object-side surface vertex of the first lens (601, 701) to the image surface of the image sensor (301), and BFL denotes the distance along the optical axis from the image sensor (301) to the center of the sensor-side surface of the last lens. If the first and second embodiments satisfy Mathematical Equation 1, the optical system can achieve a BFL suitable for a mobile camera. Mathematical Equation 1 preferably may satisfy 0.1<BFL/TTL<0.2 in the first and second embodiments.

$$0.2 < BFL / ImgH < 0.5 \qquad [ Mathematical Equation 2 ]$$

In Mathematical Equation 2, BFL is the optical axis distance from the image sensor (301) to the center of the sensor side surface of the last lens, and ImgH is the distance to the diagonal end of the image sensor (301) or the maximum diagonal length. When the first to second embodiments satisfy Mathematical Equation 2, the optical system (2000) can secure the BFL (back focal length) required to accommodate the size of the image sensor (301) of the mobile camera, set the distance between the last lens and the image sensor (301), and achieve good optical characteristics in both the central and peripheral regions of the field of view (FOV). Mathematical Equation 2 may preferably satisfy 0.2<BFL/ImgH<0.3 in the first and second embodiments.

$$2 < F / TTL < 2.5 \qquad [ Mathematical Equation 3 ]$$

Mathematical Equation 3 may allow the total focal length (F) and total optical axis length (TTL) of an optical system to be set. If an optical system according to the first to second embodiments satisfies Mathematical Equation 3, the optical system can have an appropriate focal length within the set TTL range. If the value is below the lower limit of Mathematical Equation 3, it is necessary to increase the refractive power of the lenses, which makes it difficult to correct spherical aberration or distortion aberration. If the value exceeds the upper limit of Mathematical Equation 3, the effective diameter of the lenses or the TTL becomes longer, which may result in the imaging lens system becoming larger. Mathematical Equation 3 is preferably satisfied in the first and second embodiments, where 2<F/TTL<2.2.

$$1 < TTL / ImgH < 1.5 \qquad [ Mathematical Equation 4 ]$$

Mathematical Equation 4 may allow setting the total optical axis length (TTL) of the optical system and the diagonal length (ImgH) of the image sensor. If the optical system according to the first to second embodiments satisfies Mathematical Equation 4, the optical system can have a TTL suitable for an image sensor for a mobile camera, thereby providing improved image quality. Additionally, the ultra-thin characteristics of the camera lens group can be effectively achieved. Mathematical Equation 4 may preferably satisfy the condition 1.3<TTL/ImgH<1.5 in the first and second embodiments.

$$0.5 < TTL / CA\_L1S1 < 1 \qquad [ Mathematical Equation 5 ]$$

In Mathematical Equation 5, the relationship between the total optical axis length (TTL) of the optical system and the effective diameter of the first surface (S1) of the first lens (601, 701) on the object side can be established. When Mathematical Equation 5 is satisfied, the relationship between the total optical axis length of the optical system and the effective diameter of the first lens (601, 701) where light first enters the optical system can be established, thereby enabling both the overall size of the optical system to be miniaturized and bright images to be provided. Mathematical Equation 5 may preferably satisfy 0.5<TTL/CA_L1S1<0.8 in the first and second embodiments.

$$0.5 < CA\_L3S8 / CA\_L1S1 < 0.9 \qquad [ Mathematical Equation 6 ]$$

In Mathematical Equation 6, the relationship between the size of the effective diameter of the image side 8th surface (S8) of the third lens (603, 703) and the size of the effective diameter of the object side first surface (S1) of the first lens (601, 701) can be established. When Mathematical Equation 6 is satisfied, the overall size of the optical system can be miniaturized while providing a bright image. Mathematical Equation 6 may be preferably satisfied in the first and second embodiments, where 0.5<CA_L3S8/CA_L1S1<0.7.

$$0.5 < L2\_hole / CA\_L2S4 < 1 \qquad [ Mathematical Equation 7 ]$$

In Mathematical Equation 7, the relationship between the diameter of the hole in the second lens (602, 702) and the effective diameter of the image side fourth surface (S4) of the second lens (602, 702) can be established. When Mathematical Equation 7 is satisfied, the requirements of a Cassegrain optical system are met, and the balance between the effects of reflection and refraction of light is maintained. Mathematical Equation 7 may be preferably satisfied in the first and second embodiments, where 0.5<L2_hole/CA_L2S4<0.7.

$$0.5 < F / f 1 ∼ 3 < 1 \qquad [ Mathematical Equation 8 ]$$

Mathematical Equation 8 may establish the relationship between the total focal length (F) of the optical system and the composite focal length of the first lens group (LG1), which consists of the first to third lenses. Mathematical Equation 8 serves as a condition equation related to the overall length of the optical system and its resolution performance, particularly spherical aberration and coma aberration. When Mathematical Equation 8 is satisfied, it enables the provision of a narrow-angle optical system with a field of view (FOV) of less than 30 degrees. If the upper limit of Mathematical Equation 8 is exceeded, the overall length of the optical system decreases, but the correction effect for spherical aberration and coma aberration becomes lower. If the lower limit of Mathematical Equation 8 is not met, the overall length of the optical system increases, which is undesirable. Mathematical Equation 8 may be satisfactorily satisfied in the first to second embodiments, where 0.7<F/f1~3<0.9.

$$0.5 < CA\_L6S14 / ImgH < 1 \qquad [ Mathematical Equation 9 ]$$

In Mathematical Equation 9, the size of the effective diameter of the image side 14th surface (S14) of the sixth lens (606, 706) and the length of the diagonal direction of the image sensor (ImgH) may be set. When Mathematical Equation 9 is satisfied, the ultra-thin characteristics suitable for a mobile camera can be effectively achieved, and the peripheral light ratio can be effectively controlled. Mathematical Equation 9 may be preferably satisfied in the first to second embodiments, where 0.8<CA_L6S14/ImgH<1.

$$0.2 < L 3 \sim L 4 distance / TTL < 0.5 \qquad [ Mathematical Equation 10 ]$$

Mathematical Equation 10 may establish the relationship between the total optical axis length (TTL) of the optical system and the distance between the third lens (603, 703) and the fourth lens (604, 704). If the optical system according to the first to second embodiments satisfies Mathematical Equation 10, it can meet the requirements of a Cassegrain optical system and reduce the overall size of the optical system. Mathematical Equation 10 may preferably satisfy 0.4<L3~L4 distance/TTL<0.5 in the first and second embodiments.

$$5 < Fno / tan ( FOV ) < 8 \qquad [ Mathematical Equation 11 ]$$

Mathematical Equation 11 may establish the relationship between the field of view (FOV) and the F number (Fno) of an optical system. If the optical system according to the first to second embodiments satisfies Mathematical Equation 11, it can provide a bright image. Here, Fno may be provided to be less than 1.5. Mathematical Equation 11 may preferably satisfy 5<Fno/tan (FOV)<6 in the first to second embodiments.

$$0.1 < L 2 \sim L 3 edge / TTL < 0.3 \qquad [ Mathematical Equation 12 ]$$

Mathematical Equation 12 may establish the relationship between the distance between the edge region of the third lens (603, 703) and the edge region of the hole of the second lens (602, 702) (indicated as g in FIGS. 10 and 14, L2~L3 edge) and the overall size of the optical system (TTL). Mathematical Equation 12 is an expression related to spherical aberration and coma aberration, which affect resolution performance. If the upper limit of Mathematical Equation 12 is exceeded, the size of the entire optical system increases, if the value falls below the lower limit of Mathematical Equation 12, the reflected and refracted light from the second and third lenses change abruptly, resulting in increased spherical aberration and coma aberration, which are difficult to correct. Mathematical Equation 12 may be preferably satisfied in the first and second embodiments, where 0.1<L2~L3 edge/TTL<0.3.

$$30 < \vert v 1 - v 2 \vert < 50 \qquad [ Mathematical Equation 13 ]$$

Mathematical Equation 13 may establish the relationship between the Abbe number of the first lens (601, 701) and the Abbe number of the second lens (602, 702). If the optical system according to the first to second embodiments satisfies Mathematical Equation 13, chromatic aberration occurring in the first lens (601, 701) and the second lens (602, 702) made of the same material or in the entire optical system can be corrected. Mathematical Equation 13 may preferably satisfy 30<|v1−v2|<45 in the first and second embodiments.

$$5 < \vert f 4 ∼ 6 / f 1 ∼ 3 \vert < 20 \qquad [ Mathematical Equation 14 ]$$

Mathematical Equation 14 may establish the relationship between the composite focal length of the first lens group (LG1), consisting of the first to third lenses, and the composite focal length of the second lens group (LG2), consisting of the fourth to sixth lenses. The composite focal length of the first lens group (LG1) may be greater than that of the second lens group (LG2). The first lens group (LG1) is an element that influences the overall focal length of the optical system, while the second lens group (LG2) can correct various aberrations, particularly spherical aberrations, and may serve as an element to improve optical performance. If the optical system according to the first to second embodiments satisfies Mathematical Equation 14, the optical performance of the entire optical system can be ensured. Mathematical Equation 14 may preferably satisfy 6<|f4~6/f1~3|<15 in the first to second embodiments.

$$5 < \sum Index < 15 \qquad [ Mathematical Equation 15 ]$$

In Mathematical Equation 15, Eindex denotes the sum of the refractive indices at the d-line of each of the multiple lenses. When Mathematical Equation 15 is satisfied, it is possible to control TTL in an optical system composed of aspherical lenses and achieve improved resolution. Mathematical Equation 15 may preferably satisfy 7<ΣIndex<10.

$$1 < Fno < 1.5 \qquad [ Mathematical Equation 16 ]$$

Mathematical Equation 16 may be used to set the range of Fno. When the optical system according to the first to second embodiments satisfies Mathematical Equation 16, the optical system can provide a bright image and effectively ensure a large aperture characteristic to emphasize the subject. Mathematical Equation 16 may preferably satisfy 1.2<Fno<1.5 in the first and second embodiments.

$$6 < TTL < 7.5 \qquad \{ Mathematical Equation 17 ]$$

Mathematical Equation 17 may allow setting the range of TTL, which is the distance from the center of the object side surface of the first lens in the optical system to the optical axis (OA) of the image sensor. Mathematical Equation 17 enables the provision of a compact mobile optical system. In the first and second embodiments, Mathematical Equation 17 may preferably satisfy the condition 6<TTL<7.

$$10 < FOV < 30 \qquad [ Mathematical Equation 18 ]$$

Mathematical Equation 18 may set the range of the field of view (Degree) in the diagonal direction of the optical system. If the optical system according to the first to second embodiments satisfies Mathematical Equation 18, the optical system can provide a mobile optical system with a telephoto angle of less than 30 degrees. Mathematical Equation 18 may preferably satisfy 10<FOV<20 in the first to second embodiments.

$$2 < F / ImgH < 3 \qquad [ Mathematical Equation 19 ]$$

Mathematical Equation 19 may allow setting the total effective focal length (F) of the optical system and the diagonal length (ImgH) of the image sensor. Such an optical system can have improved aberration characteristics in the size of a mobile image sensor. In the first to second embodiments, Mathematical Equation 19 may preferably satisfy 2.5<F/ImgH<3.

$$0 < BFL / TD < 0.3 \qquad [ Mathematical Equation 20 ]$$

Mathematical Equation 20 may be used to set the relationship between the optical axis distance (TD) and the back focal length (BFL) of the lenses in an optical system. As a result, the optical system can maintain its resolution while controlling the overall size. In the first to second embodiments, Mathematical Equation 20 may preferably satisfy 0<BFL/TD<0.2. If the upper limit of Mathematical Equation 20 is exceeded, the BFL becomes significantly larger relative to the TD, resulting in an increase in the overall size of the optical system, which makes miniaturization difficult, the distance between the sixth lens (606, 706) and the image sensor increases, which may result in an increase in unnecessary light passing through the space between the sixth lens (606, 706) and the image sensor, thereby degrading aberration characteristics and reducing resolution.

$$2 < CA\_L1 \sim L2\_Aver / CA\_L3 < 2.5 \qquad [ Mathematical Equation 21 ]$$

Mathematical Equation 21 may establish the relationship between the average effective focal length of the first lens (601, 701) and the second lens (602, 702) and the effective focal length of the third lens (603, 703). When the optical system according to the first and second embodiments satisfies Mathematical Equation 21, the size of the effective focal length of the lens surface where light reflection occurs can be set to establish a desirable reflection light path. Mathematical Equation 21 may be satisfactorily satisfied in the first and second embodiments such that 2<CA_L1~L2_Aver/CA_L3<2.3.

$$2 < CA\_L1 \sim L2\_Aver / CA\_L4 \sim L6\_Aver < 2.5 \qquad [ Mathematical Equation 22 ]$$

Mathematical Equation 22 may establish the relationship between the average effective focal length of the first lens (601, 701) and the second lens (602, 702) and the average effective focal length of the fourth lens (604, 704), the fifth lens (605, 705), and the sixth lens (606, 706). When the optical system according to the first and second embodiments satisfies Mathematical Equation 22, the size of the effective focal length of the lens surface where light reflection occurs can be set to establish a desirable reflection light path. Mathematical Equation 22 may be satisfactorily satisfied in the first and second embodiments such that 2.2<CA_L1~L2_Aver/CA_L4~L6_Aver<2.4.

$$2 < CA\_L1 / ImgH < 2.5 \qquad [ Mathematical Equation 23 ]$$

Mathematical Equation 23 may establish the relationship between the effective focal length of the first lens (601, 701) and the diagonal length of the image sensor (ImgH). When the optical system according to the first to second embodiments satisfies Mathematical Equation 23, the size of the effective diameter of the lens surface where light reflection occurs can be set to establish a desirable reflection light path. Mathematical Equation 23 may satisfactorily satisfy 2<CA_L1/ImgH<2.3 in the first to second embodiments.

$$2 < CA\_Max / ImgH < 2.5 \qquad [ Mathematical Equation 24 ]$$

Mathematical Equation 24 may allow setting the maximum effective focal length among the lenses and the diagonal length (ImgH) of the image sensor. When the optical system according to the first to second embodiments satisfies Mathematical Expression 24, the optical system can maintain good optical performance and set the size for a slim and compact structure. Mathematical Equation 24 can preferably satisfy 2<CA_Max/ImgH<2.5 in the first to second embodiments.

$$1 < CA\_L3 / CA\_L4 \sim L6\_Aver < 15 \qquad [ Mathematical Equation 25 ]$$

Mathematical Equation 25 may establish the relationship between the effective focal length of the third lens (603, 703) and the average effective focal length of the fourth lens (604, 704), fifth lens (605, 705), and sixth lens (606, 706). When the optical system according to the first and second embodiments satisfies Mathematical Equation 22, the size of the effective focal length of the lens surface where light reflection occurs can be set to establish a desirable reflection light path. Mathematical Equation 25 may be satisfactorily satisfied in the first and second embodiments such that 1<CA_L3/CA_L4~L6_Aver<1.3.

$$2.5 < CA\_Max / CA\_Min < 3 \qquad [ Mathematical Equation 26 ]$$

Mathematical Equation 26 may establish the relationship between the maximum effective focal length among the lenses and the minimum effective focal length among the lenses. If the optical system according to the first to second embodiments satisfies Mathematical Equation 26, the optical system can maintain good optical performance and set the size for a slim and compact structure. Mathematical Equation 26 may preferably satisfy the condition 2.5<CA_Max/CA_Min<2.8 in the first and second embodiments.

$$z = \frac{c {Y}^{2}}{1 + \sqrt{1 - ( 1 + K ) {c}^{2} {Y}^{2}}} + A {Y}^{4} + B {Y}^{5} + C {Y}^{4} + D {Y}^{5} + E {Y}^{4} + … \qquad [ Mathematical Equation 27 ]$$

In Mathematical Equation 27, Z may represent the distance in the direction of the optical axis from any point on the aspherical surface to the vertex of the aspherical surface. Y can represent the distance perpendicular to the optical axis from an arbitrary point on the aspherical surface to the optical axis. c can represent the lens curvature, and K can represent the conic constant. Additionally, A, B, C, D, E, and F can represent aspheric constants.

Table 5 shows the results of the Mathematical Equations 1 to 26 described above in the optical system of the embodiment. Referring to Table 5, it can be seen that the optical system satisfies at least one, two or more, or three or more of the mathematical equations 1 to 26. In detail, the optical system according to the embodiment satisfies all of the mathematical expressions 1 to 26. As a result, the optical system can achieve good optical performance in both the central and peripheral regions of the field of view (FOV) and exhibit excellent optical characteristics.

TABLE 5

| | | First | Second |
|---|---|---|---|
| Mathematical Equation | | embodiment | embodiment |
| 1 | 0.1 < BFL/TTL < 0.3 | 0.159 | 0.162 |
| 2 | 0.2 < BFL/ImgH < 0.5 | 0.228 | 0.234 |
| 3 | 2 < F/TTL < 2.5 | 2.027 | 2.027 |
| 4 | 1 < TTL/ImgH < 1.5 | 1.437 | 1.438 |
| 5 | 0.5 < TTL/CA_L1S1 < 1 | 0.651 | 0.651 |
| 6 | 0.5 < CA_L3S8/CA_L1S1 < 0.9 | 0.566 | 0.566 |
| 7 | 0.5 < L2_hole/CA_L2S4 < 1 | 0.606 | 0.606 |
| 8 | 0.5 < F/f1~3 < 1 | 0.859 | 0.850 |
| 9 | 0.5 < CA_L6S14/ImgH < 1 | 0.979 | 0.979 |
| 10 | 0.2 < L3~L4 distance / TTL < 0.5 | 0.414 | 0.421 |
| 11 | 5 < Fno/tan(FOV) < 8 | 5.218 | 5.218 |
| 12 | 0.1 < L2~L3 edge/TTL < 0.3 | 0.226 | 0.230 |
| 13 | 30 < \|v1-v2\| < 50 | 35.308 | 31.755 |
| 14 | 5 < \|f4~6/f1~3\| < 20 | 14.985 | 7.715 |
| 15 | 5 < ΣIndex < 15 | 9.597 | 9.542 |
| 16 | 1 < Fno < 1.5 | 1.4047 | 1.4007 |
| 17 | 6 < TTL < 7.5 | 6.9 | 6.9 |
| 18 | 10 < FOV < 30 | 19.1 | 19.1 |
| 19 | 2 < F/ImgH < 3 | 2.913 | 2.913 |
| 20 | 0 < BFL/TD < 0.3 | 0.1885 | 0.1943 |
| 21 | 2 < CA_L1~L2_Aver/CA_L3 < 2.5 | 2.022 | 2.022 |
| 22 | 2 < CA_L1~L2_Aver/CA_L4~L6_Aver < 2.5 | 2.336 | 2.336 |
| 23 | 2 < CA_L1/ImgH < 2.5 | 2.186 | 2.186 |
| 24 | 2 < CA_Max/ImgH < 2.5 | 2.186 | 2.186 |
| 25 | 1 < CA_L3/CA_L4~L6_Aver < 1.5 | 1.155 | 1.155 |
| 26 | 2.5 < CA_Max/CA_Min < 3 | 2.596 | 2.596 |

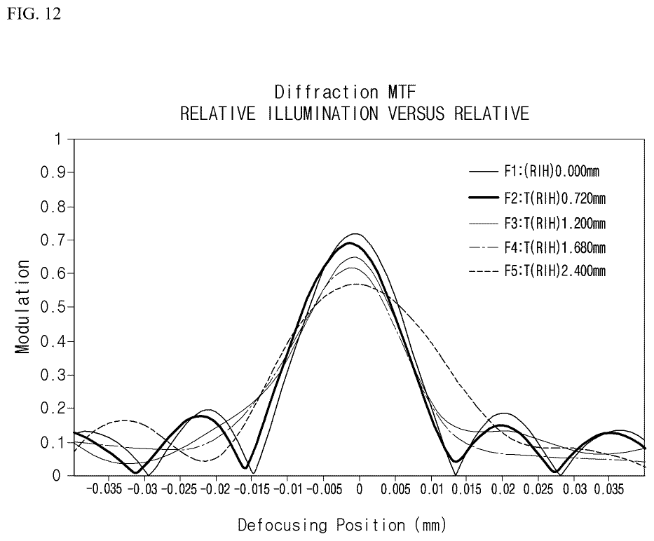

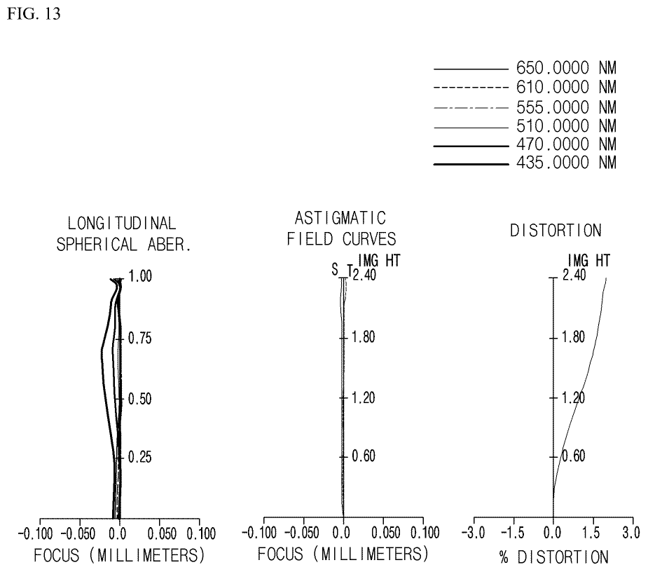

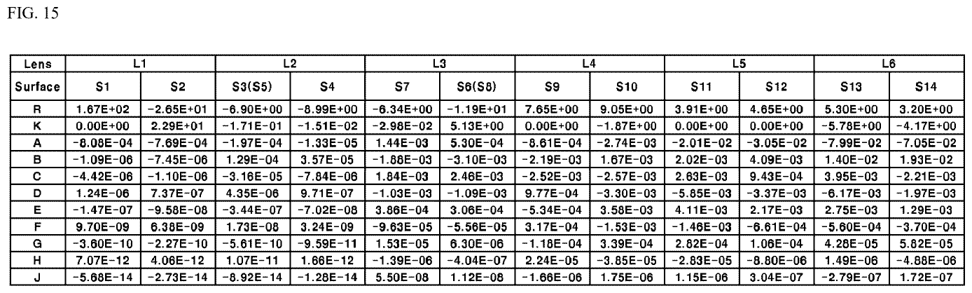

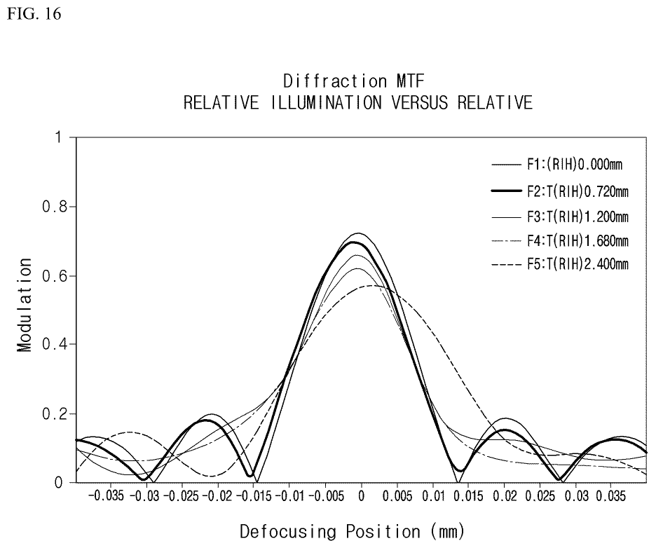

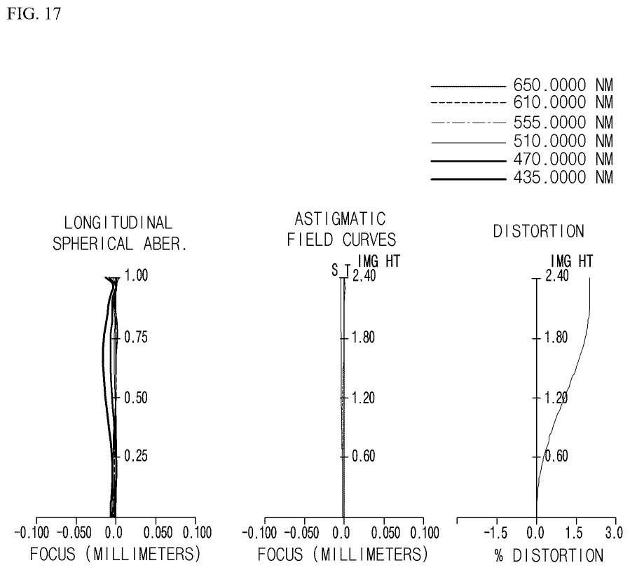

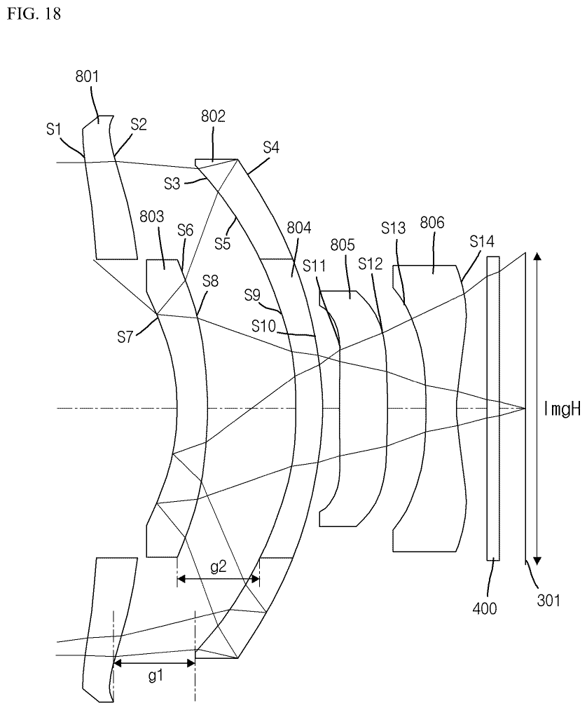

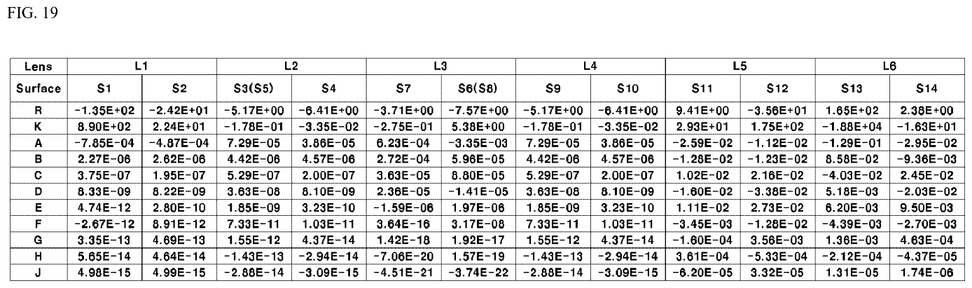

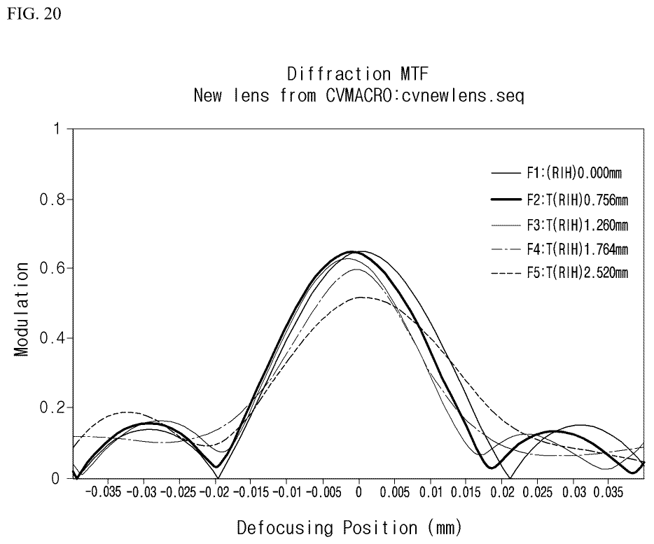

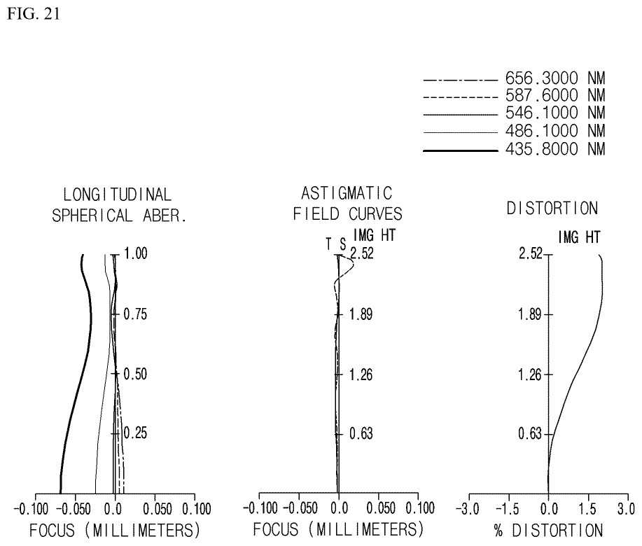

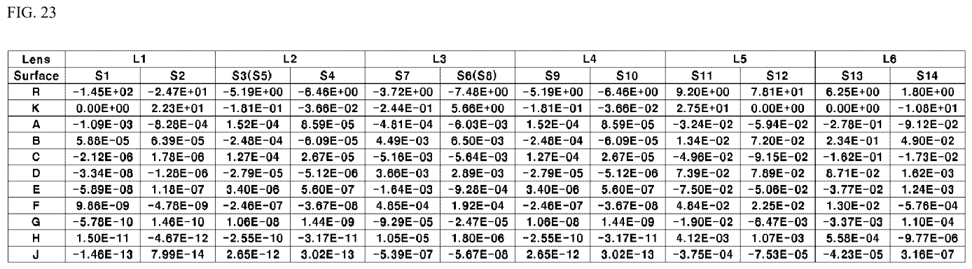

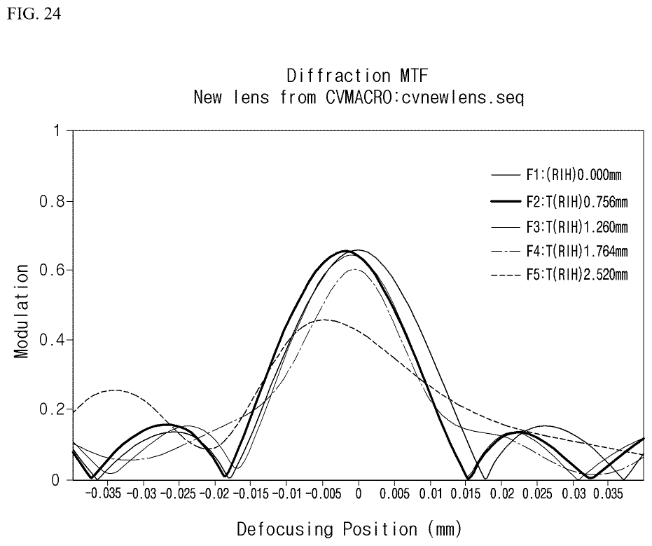

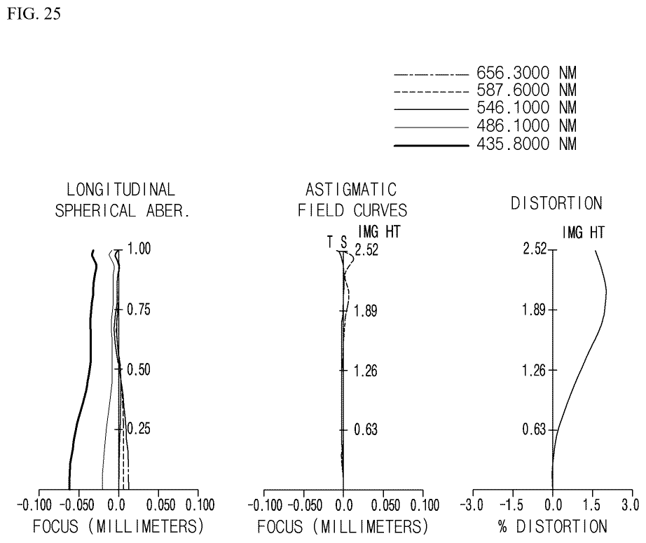

As described above, the optical system according to the first and second embodiments of the present invention has been described with reference to FIGS. 10 to 17. Hereinafter, the optical system according to the third and fourth embodiments of the present invention will be described with reference to FIGS. 18 to 25. The detailed description of the optical systems according to the third and fourth embodiments of the present invention is based on the detailed descriptions of the optical systems according to the first and second embodiments of the present invention, and the names, terms, and functions may be the same or different between the embodiments.

The configuration of the optical system according to the third embodiment of the present invention will be described below with reference to the drawings.

FIG. 18 is a side sectional view of the optical system according to the third embodiment and a camera module having the same.

The optical system according to the third embodiment may include a lens unit, which may include a first lens (801) to a sixth lens (806). The first to sixth lenses (801, 802, 803, 804, 805, 806) may be sequentially arranged along the optical path. Light corresponding to the information of the object may pass through the first lens (801) to the sixth lens (806) and the filter (400) and enter the image sensor (301).

The lens unit may be disposed, in order from the object side along the optical path toward the image side, comprising the first lens (801), the second lens (802), the third lens (803), the fourth lens (804), the fifth lens (805), and the sixth lens (806). The lens unit may include a first lens (801), a third lens (803), a second lens (802), a fourth lens (804), a fifth lens (805), and a sixth lens (806) disposed in order from the object side to the image side and coupled together.

In other embodiments, one or more additional lenses, plates, or optical components may be added between the first lens (801) and the sixth lens (806). Additionally, one or more additional lenses, plates, or optical components may be added in front of the first lens (801) or behind the sixth lens (806). Furthermore, one or more additional lenses, plates, or optical elements may be added between the aperture (STOP) and the lens, between the lens and the filter (400), and between the filter (400) and the image sensor (301). In this case, the filter (400) may be a plate lens. The refractive power of the plate lens may be ‘0’. The refractive power of the flat lens may be zero. Additionally, a filter layer may be disposed between the aperture (STOP) and the lens, between the lens and the filter (400), and between the filter (400) and the image sensor (301). In this case, the filter layer may be coated to function as a filter.

The lens unit may include a first lens (801). The first lens (801) may be closest to the object side. The first lens (801) may be the first lens disposed on the object side. The first lens (801) may be the first lens adjacent to the object side. An additional lens may be disposed between the first lens (801) and the second lens (802). The second to fifth lenses (802, 803, 804, 805) may be disposed between the first lens (801) and the sixth lens (806). An additional lens other than the second to fifth lenses (802, 803, 804, 805) may be disposed between the first lens (801) and the sixth lens (806). At least two lenses may be additionally disposed between any two of the first to sixth lenses (801, 802, 803, 804, 805, 806).

The first lens (801) may be formed in a ring shape including a hole at its center. By including the hole, the first lens (801) can reduce the overall weight of the lens unit. The hole in the first lens (801) may be smaller in size than the diameter of the third lens (803). The size of the hole in the first lens (801) may be larger than the diameter of the third lens (803). The size of the hole in the first lens (801) may be larger than the effective diameter of the third lens (803). The first lens (801) may include the outer portion excluding the center portion. The first lens (801) may include only the outer portion of the overall shape of the lens formed by the lens data of the first lens (801) in Table 6.

The first lens (801) may have a positive (+) refractive power. The curvature radius of the object side surface (S1) of the first lens (801) may be negative. The curvature radius of the upper surface (S2) of the first lens (801) may be negative. The absolute value of the curvature radius of the object side surface (S1) of the first lens (801) may be greater than the absolute value of the curvature radius of the upper side surface (S2) of the first lens (801). The first lens (801) may be a solid lens. Both surfaces of the first lens (801) may be formed as aspherical surfaces. One of the two surfaces of the first lens (801) may be formed as a spherical surface, and the other surface may be formed as an aspherical surface.

The first lens (801) may satisfy the range 1.6<N1<1.7. Additionally, the first lens (801) may satisfy the range 1.62<N1<1.68. N1 is the refractive index of the first lens (801). The first lens (801) may satisfy the range 15<V1<25. Additionally, the first lens (801) may satisfy the range 18<V1<22. V1 is the Abbe number of the first lens (801).

The lens unit may include a third lens (803). The third lens (803) may be the second lens disposed from the object side. The third lens (803) may be the lens adjacent to the second lens from the object side. The third lens (803) may be the third lens disposed along the optical path from the object side. The third lens (803) may be disposed between the first lens (801) and the image side. The third lens (803) may be disposed between the first lens (801) and the second lens (802). The third lens (803) may be disposed between the first lens (801) and the fourth lens (804). An additional lens may be disposed between the third lens (803) and the first lens (801), or between the third lens (803) and the second lens (802), or between the third lens (803) and the fourth lens (804).

The third lens (803) may be disposed to face the hole of the first lens (801). The edge region of the third lens (803) may be disposed by being spaced apart at a distance from the edge region of the hole of the first lens (801). The diameter of the third lens (803) may be smaller than the size of the hole in the first lens (801). The diameter of the third lens (803) may be the same as the size of the hole in the first lens (801). The diameter of the third lens (803) may be larger than the size of the hole in the first lens (801). The effective diameter of the third lens (803) may be smaller than the size of the hole in the first lens (801).

One surface of the third lens (803) may be mirror-coated. The object side surface (S7) of the third lens (803) may be mirror-coated. One surface of the third lens (803) may be a reflective surface capable of reflecting light. The object side (S7) of the third lens (803) may be a reflective surface capable of reflecting light.

The third lens (803) may have a negative (−) refractive power. The third lens (803) may have a convex meniscus shape on the sensor side. The third lens (803) may have the object side surface (S7) formed concavely. The third lens (803) may have the object side surface (S7) formed concavely relative to the optical axis. The third lens (803) may have the upper surfaces (S6, S8) formed convexly. The third lens (803) may have the upper side surfaces (S6, S8) formed convexly relative to the optical axis. The object side surface or upper side surface of the third lens (803) may include at least one inflection point.

The curvature radius of the object side surface (S7) of the third lens (803) may be negative. The curvature radius of the object side surface (S7) of the third lens (803) in the optical axis may be negative. The curvature radius of the upper side surface (S6, S8) of the third lens (803) may be negative. The curvature radius of the upper side surface (S6, S8) of the third lens (803) in the optical axis may be negative. The absolute value of the curvature radius of the object side surface (S7) of the third lens (803) may be smaller than the absolute value of the curvature radius of the upper side surface (S6, S8) of the third lens (803). The third lens (803) may be a solid lens. Both surfaces of the third lens (803) may be formed as aspherical surfaces. One of the two surfaces of the third lens (803) may be formed as a spherical surface, and the other surface may be formed as an aspherical surface.

The third lens (803) may satisfy the range 1.5<N3<1.6. Additionally, the third lens (803) may satisfy the range 1.5<N3<1.55. N3 is the refractive index of the third lens (803). The third lens (803) may satisfy the range 50<V3<60. Additionally, the third lens (803) may satisfy the range 52<V3<58. V3 is the Abbe number of the third lens (803).

The lens unit may include a second lens (802). The second lens (802) may be the third lens disposed from the object side. The second lens (802) may be the third lens adjacent to the object side. The second lens (802) may be the second lens disposed along the optical path from the object side. The second lens (802) may be disposed between the first lens (801) and the image side. The second lens (802) may be disposed between the third lens (803) and the image side. The second lens (802) may be disposed between the first lens (801) and the fourth lens (804). An additional lens may be arranged between the second lens (802) and the first lens (801) or between the second lens (802) and the fourth lens (804).

The second lens (802) may be formed in a ring shape including a hole at the center. The fourth lens (804) may be disposed at the center portion of the second lens (802). The second lens (802) and the fourth lens (804) may be formed integrally. The second lens (802) and the fourth lens (804) may be combined to form a single lens. The second lens (802) may include a center portion and an outer portion excluding the center portion. The curvature radii of the object side surface and the upper side surface of the center portion and the outer portion of the second lens (802) may be the same. The peripheral portion of the second lens (802) may have the curvature radius of the second lens (802) or the curvature radius of the fourth lens (804). The curvature radius of the object side surface (S3, S5) of the second lens (802) and the curvature radius of the object side surface (S9) of the fourth lens (804) may be the same. The curvature radius of the upper side surface (S4) of the second lens (802) may be the same as the curvature radius of the upper side surface (S10) of the fourth lens (804).

A boundary between the center portion and the peripheral portion of the second lens (802) may be formed smoothly without any staircase. The outer portion of the second lens (802) may have one surface mirror-coated. The outer portion of the second lens (802) may have the upper side surface (S4) mirror-coated. The upper side surface (S4) of the second lens (802) may be mirror-coated in a ring shape.

Hereinafter, the second lens (802) and the fourth lens (804) are described as separate components from an optical design perspective; however, the second lens (802) may have a configuration where one surface of its outer portion is mirror-coated, and the lens data for the second lens (802) may correspond to the outer portion of the second lens (802), and the lens data for the fourth lens (804) may correspond to the center portion of the second lens (802). Therefore, the peripheral portion of the second lens (802) may refer to the second lens (802), and the center portion of the second lens (802) may refer to the fourth lens (804).

The second lens (802) may have a negative (+) refractive power. The curvature radius of the object side surface (S3, S5) of the second lens (802) may be negative. The curvature radius of the upper side surface (S4) of the second lens (802) may be negative. The absolute value of the curvature radius of the object side surface (S3, S5) of the second lens (802) may be smaller than the absolute value of the curvature radius of the upper side surface (S4) of the second lens (802). The second lens (802) may be a solid lens. The object side surface (S3, S5) or the upper side surface (S4) of the second lens (802) may include at least one inflection point.

The second lens (802) may satisfy the range of 1.5<N2<1.6. Additionally, the second lens (802) may satisfy the range of 1.52<N2<1.55. N2 is the refractive index of the second lens (802). The second lens (802) may satisfy the range of 50<V2<60. Additionally, the second lens (802) may satisfy the range of 52<V2<58. V2 is the Abbe number of the second lens (802).

The lens unit may include a fourth lens (804). The fourth lens (804) may be the fourth lens disposed along the optical path from the object side. The fourth lens (804) may be the third lens disposed from the object side. The fourth lens (804) may be the third lens disposed from the top. The fourth lens (804) may be disposed between the third lens (803) and the top. The fourth lens (804) may be disposed between the third lens (803) and the fifth lens (805). An additional lens may be disposed between the fourth lens (804) and the third lens (803) or between the fourth lens (804) and the fifth lens (805).

The fourth lens (804) may be disposed in the hole of the second lens (802). The fourth lens (804) may refer to the center portion of the second lens (802). The fourth lens (804) and the second lens (802) may be formed integrally. The fourth lens (804) and the second lens (802) may be combined to form a single lens. The fourth lens (804) and the second lens (802) may be formed smoothly into a single lens without any staircase. The curvature radius of the fourth lens (804) and the curvature radius of the second lens (802) may be the same. The curvature radius of the object side surface (S9) of the fourth lens (804) and the curvature radius of the object side surface (S3, S5) of the second lens (802) may be the same. The curvature radius of the upper side surface (S10) of the fourth lens (804) may be the same as the curvature radius of the upper side surface (S4) of the second lens (802).

The fourth lens (804) may have a negative (−) refractive power. The fourth lens (804) may have a convex meniscus shape on the sensor side. The fourth lens (804) may have the object side surface (S9) formed concavely. The fourth lens (804) may have the object side surface (S9) formed concavely relative to the optical axis. The fourth lens (804) may have a convex upper side surface (S10). The fourth lens (804) may have a convex upper side surface (S10) relative to the optical axis. The object side surface or upper side surface of the fourth lens (804) may include at least one inflection point.

The curvature radius of the object side surface (S9) of the fourth lens (804) may be negative. The curvature radius of the object side surface (S9) of the fourth lens (804) relative to the optical axis may be negative. The curvature radius of the upper side surface (S10) of the fourth lens (804) may be negative. The curvature radius of the fourth lens (804) on the optical axis of the upper side surface (S10) may be negative. The absolute value of the curvature radius of the object side surface (S9) of the fourth lens (804) may be smaller than the absolute value of the curvature radius of the upper side surface (S10) of the fourth lens (804). The fourth lens (804) may be a solid lens. Both surfaces of the fourth lens (804) may be formed as aspherical surfaces. One of the two surfaces of the fourth lens (804) may be formed as a spherical surface, and the other surface may be formed as an aspherical surface.

The fourth lens (804) may satisfy the range 1.5<N4<1.6. Additionally, the fourth lens (804) may satisfy the range 1.52<N4<1.55. N4 is the refractive index of the fourth lens (804). The fourth lens (804) may satisfy the range 50<V4<60. Additionally, the fourth lens (804) may satisfy the range 52<V4<58. V4 is the Abbe number of the fourth lens (804).

Light incident from the object side passes through the object side first surface (S1) of the first lens (801), the image side second surface (S2) and the object side third surface (S3) of the second lens (802), and is reflected at the image side fourth surface (S4) of the second lens (802) before passing through the object side fifth surface (S5) of the second lens (802), the image side sixth surface (S6) of the third lens (803), and is reflected at the object side seventh surface (S7) of the third lens (803), and then passes through the sensor side eighth surface (S8) of the third lens (803). The light incident from the object side is reflected twice at the fourth surface (S4) of the second lens (802), which is a reflective surface, and the seventh surface (S7) of the third lens (130), which is a reflective surface.

Here, the object side of the second lens (802) is described as being divided into the third surface (S3) and the fifth surface (S5), but the third surface (S3) and the fifth surface (S5) may be the same surface representing the object side surface of the second lens (802). The third surface (S3) of the second lens (802) may be the incident surface of the second lens (802), and the fifth surface (S5) may be the exit surface of the second lens (802). The third surface (S3) and the fifth surface (S5) of the second lens (802) may have different effective diameters. The effective diameter of the third surface (S3) of the second lens (802) may be larger than the effective diameter of the fifth surface (S5) of the second lens (802).

Although the image side of the third lens (803) has been described as being divided into the sixth surface (S6) and the eighth surface (S8), the sixth surface (S6) and the eighth surface (S8) may be the same surface representing the upper side surface of the third lens (803). The sixth surface (S6) of the third lens (803) may be the incident surface of the third lens (803), and the eighth surface (S8) may be the exit surface of the third lens (803). The sixth surface (S6) and the eighth surface (S8) of the third lens (803) may have different effective diameters. The effective diameter of the sixth surface (S6) of the third lens (803) may be larger than the effective diameter of the eighth surface (S8) of the third lens (803).

The diameter of the hole in the first lens (801) may be the same as the diameter of the third lens (803). The diameter of the hole in the first lens (801) may be larger than the effective diameter size of the third lens (803). The difference between the diameter of the hole in the first lens (801) and the effective diameter of the third lens (803) may be less than 5, and preferably less than 3.

The distance (g1) between the edge portion of the object side surface (S3, S5) of the second lens (802) and the upper side surface (S2) of the first lens (801) in the optical axis direction may be 1.2 or more and 1.5 or less. The distance (g2) in the optical axis direction between the edge portions of the upper side surface (S6, S8) of the third lens (803) and the edge portions of the object side surface (S4) of the fourth lens (804) may be 1.3 or more and 1.5 or less. The distance (g2) in the optical axis direction between the edge portions of the upper side surface (S6, S8) of the third lens (803) and the edge portions of the hole of the second lens (802) may be 1.3 or greater and 1.5 or less. This minimizes flare and ghosting phenomena caused by reflection and refraction of light through the first to third lenses (801, 802, 803).

The lens unit may include a fifth lens (805). The fifth lens (805) may be the fifth lens disposed along the optical (light) path from the object side. The fifth lens (805) may be the second lens disposed from the image side. The fifth lens (805) may be disposed between the fourth lens (804) and the image side. The fifth lens (805) may be disposed between the fourth lens (804) and the sixth lens (806). An additional lens may be disposed between the fifth lens (805) and the fourth lens (804) or between the fifth lens (805) and the sixth lens (806).

The fifth lens (805) may have a positive (+) refractive power. The fifth lens (805) may have a shape with both surfaces being convex. The fifth lens (805) may have the object side surface (S11) formed convexly. The fifth lens (805) may have the object side surface (S11) formed convexly relative to the optical axis. The fifth lens (805) may have an upper side surface (S12) formed convexly. The fifth lens (805) may have the upper side surface (S12) formed convexly relative to the optical axis. The object side surface or upper side surface of the fifth lens (805) may include at least one inflection point.

The curvature radius of the object side surface (S11) of the fifth lens (805) may be positive. The curvature radius of the object side surface (S11) of the fifth lens (805) relative to the optical axis may be positive. The curvature radius of the upper side surface (S12) of the fifth lens (805) may be negative. The curvature radius of the upper side surface (S12) of the fifth lens (805) along the optical axis may be negative. The absolute value of the curvature radius of the object side surface (S11) of the fifth lens (805) may be smaller than the absolute value of the curvature radius of the upper side surface (S12) of the fifth lens (805). The fifth lens (805) may be a solid lens. Both surfaces of the fifth lens (805) may be formed as aspherical surfaces. One of the two surfaces of the fifth lens (805) may be formed as a spherical surface, and the other surface may be formed as an aspherical surface.

The fifth lens (805) may satisfy the range 1.6<N5<1.7. Additionally, the fifth lens (805) may satisfy the range 1.62<N5<1.69. N5 is the refractive index of the fifth lens (805). The fifth lens (805) may satisfy the range 15<V5<25. Additionally, the fifth lens (805) may satisfy the range 18<V5<22. V5 is the Abbe number of the fifth lens (805).

The lens unit may include a sixth lens (806). The sixth lens (806) may be the sixth lens disposed along the optical path from the object side. The sixth lens (806) may be the first lens disposed from the image side. The sixth lens (806) may be disposed between the fifth lens (805) and the image side. An additional lens may be positioned between the sixth lens (806) and the image side.

The sixth lens (806) may have a negative (−) refractive power. The sixth lens (806) may have a convex meniscus shape on the object side. The sixth lens (806) may have a convex object side surface (S13). The sixth lens (806) may have a convex object side surface (S13) relative to the optical axis. The sixth lens (806) may have a concave upper side surface (S14). The sixth lens (806) may have an upper surface (S14) that is concave relative to the optical axis. The object side surface or upper side surface of the sixth lens (806) may include at least one inflection point.

The curvature radius of the object side surface (S13) of the sixth lens (806) may be positive. The curvature radius of the object side surface (S13) of the sixth lens (806) relative to the optical axis may be positive. The curvature radius of the upper side surface (S14) of the sixth lens (806) may be negative. The curvature radius of the upper side surface (S14) of the sixth lens (806) along the optical axis may be negative. The absolute value of the curvature radius of the object side surface of the sixth lens (806) may be greater than the absolute value of the curvature radius of the upper side surface of the sixth lens (806). The sixth lens (806) may be a solid lens. Both surfaces of the sixth lens (806) may be formed as aspherical surfaces. One of the two surfaces of the sixth lens (806) may be formed as a spherical surface, and the other surface may be formed as an aspherical surface. The sixth lens (806) may have a surface including one or more inflection points.

The sixth lens (806) may satisfy the range of 1.5<N6<1.6. Additionally, the sixth lens (806) may satisfy the range of 1.53<N6<1.58. N6 is the refractive index of the sixth lens (806). The sixth lens (806) may satisfy the range of 30<V6<40. Additionally, the sixth lens (806) may satisfy the range of 32<V6<38. V6 is the Abbe number of the sixth lens (806).

The lens unit may include multiple lens groups (LG1, LG2). Specifically, each of the multiple lens groups (LG1, LG2) may include at least one lens. For example, the lens unit may include a first lens group (LG1) and a second lens group (LG2) disposed sequentially along the optical axis (OA) toward the image sensor (301) from the object side.

The first lens group (LG1) may include at least one lens. The first lens group (LG1) may have four or fewer lenses. The second lens group (LG2) may include two or more lenses. The second lens group (LG2) may have two to four lenses. The first lens group (LG1) may include at least one lens that includes a reflective surface on one side. The second lens group (LG2) may not include a lens with a reflective surface. The first lens group (LG1) may include the first to fourth lenses (801, 802, 803, 804). The second lens group (LG2) may include the fifth and sixth lenses (805, 806).

The composite focal length (f1 to 4) of the first lens group (LG1) may be 10 to 20. The composite focal length (f5 to f6) of the second lens group (LG2) may be −5 to −20. The absolute value of the composite focal length (f1 to f4) of the first lens group (LG1) may be greater than the absolute value of the composite focal length (f5 to f6) of the second lens group (LG2). The power of the first lens group (LG1) may be smaller than that of the second lens group (LG2). The first lens group (LG1) is an area where reflection occurs twice, and the power of the first lens group (LG1) may affect the overall power of the lens unit. The second lens group (LG2), which is disposed above the first lens group (LG1), can correct aberrations and may have a smaller influence on the power of the entire lens unit. Additionally, the second lens group (LG2) may include lenses with many bends on one surface, enabling correction of spherical aberrations and improving the optical performance of the entire lens unit.

The lens with the smallest effective diameter in the first lens group (LG1) is the fourth lens (804), and the lens with the largest effective diameter in the second lens group (LG2) is the sixth lens (806). The average effective diameter size of the lenses included in the first lens group (LG1) may be larger than the average effective diameter size of the lenses included in the second lens group (LG2). That is, light entering the lens unit is reflected and refracted in the first lens group (LG1) and directed toward a direction adjacent to the optical axis, then enters the second lens group (LG2). This enables the implementation of narrow-angle and telephoto optical systems.

The lens unit may include an aperture (STOP). The aperture controls the amount of light entering the optical system. For lenses disposed between the object and the aperture, there is a tendency for the effective diameter of the lens surfaces to increase as they move from the object side toward the aperture. For the lens surfaces disposed between the aperture and the sensor, there is a tendency for the effective diameter of the lens surfaces to decrease as one moves from the aperture toward the sensor side. The tendency for the effective aperture of lens surfaces to increase or decrease does not mean that the effective aperture of lens surfaces only increases or decreases. For example, it also includes cases where the effective diameter of lens surfaces increases and then decreases as the distance from the aperture to the sensor increases.

The optical system or camera module may include a filter (400). The filter (400) may be disposed between the lens closest to the sensor side among the lenses of the lens unit (100) and the image sensor (301). For example, the filter (400) may be disposed between the nth lens and the image sensor (301).

The cover glass may be disposed between the filter (400) and the image sensor (301), protecting the upper part of the image sensor (301) and preventing a decrease in the reliability of the image sensor (301). The cover glass may be removable. The cover glass may be a protective glass.

The filter (400) may include an infrared filter or an infrared cut-off filter (IR cut-off). The filter (400) may transmit light within a set wavelength band and filter out light from other wavelength bands. When the filter (400) includes an infrared filter, it can block radiant heat emitted from external light from being transmitted to the image sensor (301). Additionally, the filter (400) can transmit visible light and reflect infrared light.

The following describes the concept of the diagonal field of view (DFOV) of the imaging lens according to the present embodiment.

The imaging lens may have a field of view (FOV) of less than 30°. In this case, the field of view (FOV) may be the diagonal field of view (DFOV). The diagonal field of view (DFOV) may be distinguished from the horizontal field of view (HFOV) and the vertical field of view (VFOV). For example, the horizontal field of view (HFOV) may be 0.8 times the diagonal field of view (DFOV). Additionally, the field of view (FOV) may be distinguished from the horizontal field of view (HFOV). The field of view (FOV) refers to the diameter of an imaginary circle connecting the four corners of an image sensor, while the horizontal field of view (HFOV) may refer to the radius of the aforementioned imaginary circle. In other words, the field of view (FOV) may be twice the horizontal field of view (HFOV).

The diagonal field of view (DFOV) may be calculated using the following Mathematical Equation.

$$DFOV = arctan ( ImgH / F ) \qquad [ Mathematical Equation ]$$

Here, ImgH denotes the diagonal length of the effective area of the imaging surface of the image sensor (301), and F denotes the effective focal length of the entire optical system.

TABLE 6

| | | | | | | Semi | Focal |
|---|---|---|---|---|---|---|---|
| Lens | Surface | Radius | Thickness | nd | vd | Aperture | length |
| L1 | S1 | −134.782 | 0.749 | 1.661 | 20.348 | 4.700 | 43.869 |
| | S2 | −24.177 | 2.393 | | | 4.297 | |
| L2 | S3 | −5.172 | 0.408 | 1.534 | 55.656 | 3.911 | −3.414 |
| | S4 | −6.411 | −0.408 | | | 4.000 | |
| | S5 | −5.172 | −1.407 | | | 3.522 | |
| L3 | S6 | −7.573 | −0.500 | 1.534 | 55.656 | 2.391 | −1.532 |
| | S7 | −3.708 | 0.500 | | | 1.898 | |
| | S8 | −7.573 | 1.407 | | | 1.915 | |
| L4 | S9 | −5.172 | 0.408 | 1.534 | 55.656 | 1.681 | −56.321 |
| | S10 | −6.411 | 0.266 | | | 1.689 | |
| L5 | S11 | 9.405 | 0.765 | 1.661 | 20.348 | 1.664 | 11.185 |
| | S12 | −35.617 | 0.620 | | | 1.898 | |
| L6 | S13 | 164.644 | 0.500 | 1.567 | 37.565 | 1.940 | −4.240 |
| | S14 | 2.384 | 0.479 | | | 2.301 | |
| IR | | Infinity | 0.210 | | | 2.406 | |
| | | Infinity | 0.410 | | | 2.435 | |
| Image | | Infinity | 0.002 | | | 2.520 | |

Table 6 shows the surface number (Surface), curvature radius (Radius), center thickness of each lens or distance between lens surfaces (Thickness), refractive index (Index, nd), Abbe number (Abbe, vd), and focal length (Focal length) of the lens according to the third embodiment of the present invention. Here, the units for curvature radius and thickness or distance may be mm.

The first lens (801) has a ring shape, so the first lens (801) may refer only to the ring-shaped portion of the virtual circular lens formed by the curvature radius and thickness of the lens in Table 6. The second lens (802) has a ring shape, so the first lens (802) may refer only to the ring-shaped portion of the virtual circular lens formed by the curvature radius and thickness of the lens in Table 6. Therefore, the data regarding the thickness of the first lens (801) and the second lens (802) in Table 6 may refer to the lens thickness at the optical axis of the virtual circular shape lens formed by the curvature radius and thickness.

TABLE 7

| | Third embodiment | | Third embodiment |
|---|---|---|---|
| TTL | 6.8000 | ΣIndex | 9.4925 |
| TD(L1S1 ~L6S2) | 5.6996 | ΣAbb | 245.229 |
| F | 14.775 | ΣL_CT | 3.3285 |
| f1~4 | 14.708 | CA_Max | 9.400 |
| f5~6 | −8.414 | CA_Min | 3.328 |
| Fno | 1.8706 | CA_Aver | 5.314 |
| ImgH | 5.040 | L_CT_max | 0.765 |
| FOV | 19.000 | L_CT_min | 0.408 |
| EPD | 7.899 | L_CT_aver | 0.555 |
| BFL | 1.100 | L1~L2 edge (g1) | 1.26 |
| L3~L4 distance | 1.407 | L2~L3 edge (g2) | 1.31 |
| L1 hole size | 4.8 | | |

Table 7 shows the characteristics of the imaging lens according to the third embodiment of the present invention.

TTL means the optical axis distance from the object side vertex of the first lens (801) to the image surface, TD means the optical axis distance from the object side surface vertex of the first lens (801) to the upper side surface of the sixth lens (806), F denotes the total focal length, f1 to f4 denote the composite focal lengths of the first lens (801) to the fourth lens (804), f5 to f6 denote the composite focal lengths of the fifth lens (805) to the sixth lens (806), Fno denotes the ratio of the focal length to the effective diameter of the lens, ImgH denotes the diagonal distance or maximum diagonal length of the image sensor (301), FOV denotes the diagonal field of view of the optical system, EPD denotes the diameter of the entrance pupil (effective diameter), BFL denotes the optical axis distance from the upper side surface of the sixth lens (806) to the image surface, L3~L4 distance denotes the distance between the third lens (803) and the fourth lens (804) along the optical axis, ΣIndex denotes the sum of the refractive indices of the first to sixth lenses (801, 802, 803, 804, 805, 806) that constitute the lens unit, ΣAbb denotes the sum of the Abbe numbers of the first to sixth lenses (801, 802, 803, 804, 805, 806) that constitute the lens unit, ΣL_CT denotes the sum of the center thicknesses of the first to sixth lenses (801, 802, 803, 804, 805, 806) that constitute the lens unit, CA_Max denotes the maximum effective diameter of the first to sixth lenses (801, 802, 803, 804, 805, 806) that constitute the lens unit, CA_Min denotes the size of the smallest effective diameter among the first to sixth lenses (801, 802, 803, 804, 805, 806) that constitute the lens unit, CA_Aver denotes the average value of the effective diameter of the first to sixth lenses (801, 802, 803, 804, 805, 806) that constitute the lens unit, L_CT_max denotes the maximum value of the center thickness among the first to sixth lenses (801, 802, 803, 804, 805, 806) that constitute the lens unit, L_CT_min denotes the minimum value of the center thickness of the first to sixth lenses (801, 802, 803, 804, 805, 806) that constitute the lens unit, L_CT_aver denotes the average value of the center thickness of the first to sixth lenses (801, 802, 803, 804, 805, 806) that constitute the lens unit, L1 hole size denotes the diameter size of the hole in the first lens (801), L3~L4 distance denotes the distance between the third lens (803) and the fourth lens (804) in the optical axis direction, L1~L2 edge (g1) denotes the distance between the edge region of the object side surface of the second lens (802) and the edge region of the upper side surface of the first lens (801), L2~L3 edge (g2) denotes the distance between the edge region of the upper side surface of the third lens (803) and the edge region of the object side surface of the fourth lens (804).

The configuration of the optical system according to the fourth embodiment of the present invention will be described below with reference to the drawings.

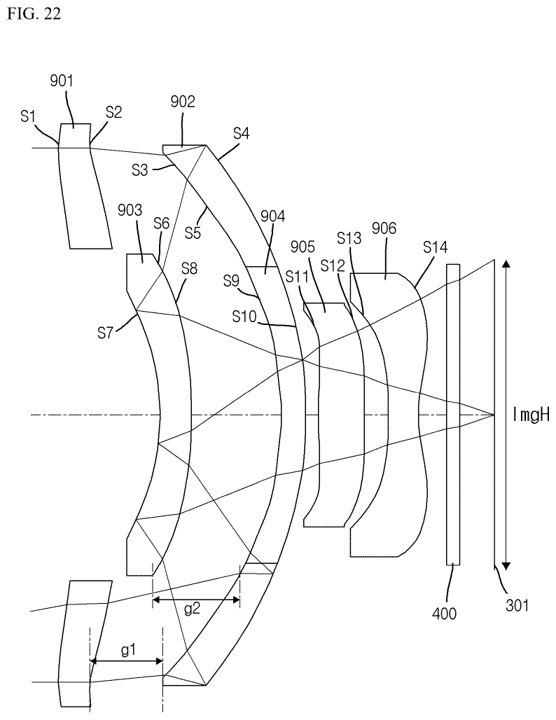

FIG. 22 is a side sectional view of the optical system according to the fourth embodiment and a camera module having the same.

The optical system according to the third embodiment includes a lens unit, which may include a first lens (901) to a sixth lens (906). The first to sixth lenses (901, 902, 903, 904, 905, 906) may be sequentially disposed along the optical (light) path. Light corresponding to the information of the object may pass through the first lens (901) to the sixth lens (906) and the filter (400) and enter the image sensor (301).

The lens unit may be disposed, in order from the object side along the optical path toward the image side, comprising the first lens (901), the second lens (902), the third lens (903), the fourth lens (904), the fifth lens (905), and the sixth lens (906). The lens unit may include a first lens (901), a third lens (903), a second lens (902), a fourth lens (904), a fifth lens (905), and a sixth lens (906) disposed in order from the object side to the image side and coupled together.

In another embodiment, one or more additional lenses, plates, or optical components may be added between the first lens (901) and the sixth lens (906). Additionally, one or more additional lenses, plates, or optical components may be added in front of the first lens (901) or behind the sixth lens (906). Furthermore, one or more additional lenses, plates, or optical components may be added between the aperture (STOP) and the lens, between the lens and the filter (400), and between the filter (400) and the image sensor (301). In this case, the filter (400) may be a plate lens. The refractive power of the plate lens may be ‘0’. The refractive power of the flat lens may be zero. Additionally, a filter layer may be disposed between the aperture (STOP) and the lens, between the lens and the filter (400), and between the filter (400) and the image sensor (301). In this case, the filter layer may be coated to function as a filter.

The lens unit may include a first lens (901). The first lens (901) may be closest to the object side. The first lens (901) may be the first lens disposed on the object side. The first lens (901) may be the first lens adjacent to the object side. An additional lens may be disposed between the first lens (901) and the second lens (902). The second to fifth lenses (902, 903, 904, 905) may be disposed between the first lens (901) and the sixth lens (906). An additional lens other than the second to fifth lenses (902, 903, 904, 905) may be disposed between the first lens (901) and the sixth lens (906). At least two lenses may be additionally disposed between any two of the first to sixth lenses (901, 902, 903, 904, 905, 906).

The first lens (901) may be formed in a ring shape including a hole at the center. The first lens (901) may reduce the overall weight of the lens unit by including the hole. The size of the hole in the first lens (901) may be smaller than the diameter of the third lens (903). The size of the hole in the first lens (901) may be larger than the diameter of the third lens (903). The size of the hole in the first lens (901) may be larger than the effective diameter of the third lens (903). The first lens (901) may include the outer portion excluding the center portion. The first lens (901) may include only the outer portion of the entire lens shape formed by the lens data of the first lens (901) in Table 6.

The first lens (901) may have a positive (+) refractive power. The curvature radius of the object side surface (S1) of the first lens (901) may be negative. The curvature radius of the upper side surface (S2) of the first lens (901) may be negative. The absolute value of the curvature radius of the object side surface (S1) of the first lens (901) may be greater than the absolute value of the curvature radius of the upper side surface (S2) of the first lens (901). The first lens (901) may be a solid lens. Both sides of the first lens (901) may be formed as non-spherical surfaces. One of the two surfaces of the first lens (901) may be formed as a spherical surface, and the other surface may be formed as a non-spherical surface.

The first lens (901) may satisfy the range of 1.6<N1<1.7. Additionally, the first lens (901) may satisfy the range of 1.62<N1<1.68. N1 is the refractive index of the first lens (901). The first lens (901) may satisfy the range of 15<V1<25. Additionally, the first lens (901) may satisfy the range of 18<V1<22. V1 is the Abbe number of the first lens (901).

The lens unit may include a third lens (903). The third lens (903) may be the third lens disposed along the optical path from the object side. The third lens (903) may be the second lens disposed from the object side. The third lens (903) may be the second lens adjacent to the second lens disposed from the object side. The third lens (903) may be disposed between the first lens (901) and the image side. The third lens (903) may be disposed between the first lens (901) and the second lens (902). The third lens (903) may be disposed between the first lens (901) and the fourth lens (904). An additional lens may be disposed between the third lens (903) and the first lens (901), or between the third lens (903) and the second lens (902), or between the third lens (903) and the fourth lens (904).

The third lens (903) may be disposed facing the hole of the first lens (901). The edge region of the third lens (903) may be disposed spaced apart from the edge region of the hole of the first lens (901). The diameter of the third lens (903) may be smaller than the size of the hole in the first lens (901). The diameter of the third lens (903) may be the same as the size of the hole in the first lens (901). The diameter of the third lens (903) may be larger than the size of the hole in the first lens (901). The effective diameter of the third lens (903) may be smaller than the size of the hole in the first lens (901).

One surface of the third lens (903) may be mirror-coated. The object side surface (S7) of the third lens (903) may be mirror-coated. The one surface of the third lens (903) may be a reflective surface capable of reflecting light. The object side surface (S7) of the third lens (903) may be a reflective surface capable of reflecting light.

The third lens (903) may have a negative (−) refractive power. The third lens (903) may have a convex meniscus shape on the sensor side. The third lens (903) may have the object side surface (S7) formed concavely. The third lens (903) may have the object side surface (S7) formed concavely relative to the optical axis. The third lens (903) may have convex upper side surfaces (S6, S8). The third lens (903) may have convex upper side surfaces (S6, S8) relative to the optical axis. The object side surface or upper side surface of the third lens (903) may include at least one inflection point.

The curvature radius of the object side surface (S7) of the third lens (903) may be negative. The curvature radius of the object side surface (S7) of the third lens (903) relative to the optical axis may be negative. The curvature radius of the upper side surface (S6, S8) of the third lens (903) may be negative. The curvature radius of the upper side surface (S6, S8) of the third lens (903) along the optical axis may be negative. The absolute value of the curvature radius of the object side surface (S7) of the third lens (903) may be smaller than the absolute value of the curvature radius of the upper side surface (S6, S8) of the third lens (903). The third lens (903) may be a solid lens. Both surfaces of the third lens (903) may be formed as aspherical surfaces. One of the two surfaces of the third lens (903) may be formed as a spherical surface, and the other surface may be formed as an aspherical surface.

The third lens (903) may satisfy the range 1.5<N3<1.6. Additionally, the third lens (903) may satisfy the range 1.5<N3<1.55. N3 is the refractive index of the third lens (903). The third lens (903) may satisfy the range 50<V3<60. Additionally, the third lens (903) may satisfy the range 52<V3<58. V3 is the Abbe number of the third lens (903).

The lens unit may include a second lens (902). The second lens (902) may be the second lens disposed along the optical path from the object side. The second lens (902) may be the third lens disposed from the object side. The second lens (902) may be the third lens adjacent to the object side. The second lens (902) may be disposed between the first lens (901) and the image side. The second lens (902) may be disposed between the third lens (903) and the image side. The second lens (902) may be disposed between the first lens (901) and the fourth lens (904). An additional lens may be disposed between the second lens (902) and the first lens (901) or between the second lens (902) and the fourth lens (904).

The second lens (902) may be formed in a ring shape including a hole at the center. The fourth lens (904) may be disposed at the center portion of the second lens (902). The second lens (902) and the fourth lens (904) may be formed integrally. The second lens (902) and the fourth lens (904) may be combined to form a single lens. The second lens (902) may include a center portion and an outer portion excluding the center portion. The curvature radii of the object side surface and upper side surface of the center portion and peripheral portion of the second lens (902) may be the same. The peripheral portion of the second lens (902) may have the curvature radius of the second lens (902) or the curvature radius of the fourth lens (904). The curvature radius of the object side surface (S3, S5) of the second lens (902) and the curvature radius of the object side surface (S9) of the fourth lens (904) may be the same. The curvature radius of the upper side surface (S4) of the second lens (902) may be the same as the curvature radius of the upper side surface (S10) of the fourth lens (904).

A boundary between the center part and the outer part of the second lens (902) may be formed smoothly without a staircase. The outer portion of the second lens (902) may have one surface mirror-coated. The outer portion of the second lens (902) may have the upper side surface (S4) mirror-coated. The upper side surface (S4) of the second lens (902) may be mirror-coated in a ring shape.

Hereinafter, the second lens (902) and the fourth lens (904) are described as separate components from an optical design perspective; however, the second lens (902) may have a mirror coated on one surface of its outer portion, and the lens data for the second lens (902) may correspond to the outer portion of the second lens (902). The lens data for the fourth lens (904) may correspond to the center portion of the second lens (902). Therefore, the peripheral portion of the second lens (902) may refer to the second lens (902), and the center portion of the second lens (902) may refer to the fourth lens (904).

The second lens (902) may have a negative (−) refractive power. The curvature radius of the object side surface (S3, S5) of the second lens (902) may be negative. The curvature radius of the upper side surface (S4) of the second lens (902) may be negative. The absolute value of the curvature radius of the object side surface (S3, S5) of the second lens (902) may be smaller than the absolute value of the curvature radius of the upper side surface (S4) of the second lens (902). The second lens (902) may be a solid lens. The object side surface (S3, S5) or the upper side surface (S4) of the second lens (902) may include at least one inflection point.

The second lens (902) may satisfy the range 1.5<N2<1.6. Additionally, the second lens (902) may satisfy the range 1.52<N2<1.55. N2 is the refractive index of the second lens (902). The second lens (902) may satisfy the range 50<V2<60. Additionally, the second lens (902) may satisfy the range 52<V2<58. V2 is the Abbe number of the second lens (902).

The lens unit may include a fourth lens (904). The fourth lens (904) may be the fourth lens disposed along the optical path from the object side. The fourth lens (904) may be the third lens disposed from the object side. The fourth lens (904) may be the third lens disposed from the image side. The fourth lens (904) may be disposed between the third lens (903) and the upper side. The fourth lens (904) may be disposed between the third lens (903) and the fifth lens (905). An additional lens may be disposed between the fourth lens (904) and the third lens (903) or between the fourth lens (904) and the fifth lens (905).

The fourth lens (904) may be disposed in the hole of the second lens (902). The fourth lens (904) may refer to the center portion of the second lens (902). The fourth lens (904) and the second lens (902) may be formed integrally. The fourth lens (904) and the second lens (902) may be combined to form a single lens. The fourth lens (904) and the second lens (902) may be formed into a single lens without any staircases or gaps. The curvature radius of the fourth lens (904) and the curvature radius of the second lens (902) may be the same. The curvature radius of the object side surface (S9) of the fourth lens (904) and the curvature radius of the object side surface (S3, S5) of the second lens (902) may be the same. The curvature radius of the upper side surface (S10) of the fourth lens (904) may be the same as the curvature radius of the upper side surface (S4) of the second lens (902).

The fourth lens (904) may have a negative (−) refractive power. The fourth lens (904) may have a convex meniscus shape on the sensor side. The fourth lens (904) may have the object side surface (S9) formed concavely. The fourth lens (904) may have the object side surface (S9) formed concavely relative to the optical axis. The fourth lens (904) may have an upper side surface (S10) formed convexly. The fourth lens (904) may have the upper side surface (S10) formed convexly relative to the optical axis. The object side surface or upper side surface of the fourth lens (904) may include at least one inflection point.

The curvature radius of the object side surface (S9) of the fourth lens (904) may be negative. The curvature radius of the object side surface (S9) of the fourth lens (904) in the optical axis may be negative. The curvature radius of the upper side surface (S10) of the fourth lens (904) may be negative. The curvature radius of the fourth lens (904) on the optical axis of the upper side surface (S10) may be negative. The absolute value of the curvature radius of the object side surface (S9) of the fourth lens (904) may be smaller than the absolute value of the curvature radius of the upper side surface (S10) of the fourth lens (904). The fourth lens (904) may be a solid lens. Both surfaces of the fourth lens (904) may be formed as aspherical surfaces. One of the two surfaces of the fourth lens (904) may be formed as a spherical surface, and the other surface may be formed as an aspherical surface.

The fourth lens (904) may satisfy the range 1.5<N4<1.6. Additionally, the fourth lens (904) may satisfy the range 1.52<N4<1.55. N4 is the refractive index of the fourth lens (904). The fourth lens (904) may satisfy the range 50<V4<60. Additionally, the fourth lens (904) may satisfy the range 52<V4<58. V4 is the Abbe number of the fourth lens (904).

Light incident from the object side passes through the object side first surface (S1) of the first lens (901), the image side second surface (S2) and the object side third surface (S3) of the second lens (902), reflected at the image side fourth surface (S4) of the second lens (902), and then passes through the object side fifth surface (S5) of the second lens (902), and the image side sixth surface (S6) of the third lens (903), and is reflected at the object side seventh surface (S7) of the third lens (903), and then passes through the sensor side eighth surface (S8) of the third lens (903). Light incident from the object side undergoes two reflections at the reflective surface fourth surface (S4) of the second lens (902) and the reflective surface seventh surface (S7) of the third lens (130) within the lens unit.

Here, although the object side of the second lens (902) is described as being divided into the third surface (S3) and the fifth surface (S5), the third surface (S3) and the fifth surface (S5) may be the same surface representing the object side surface of the second lens (902). The third surface (S3) of the second lens (902) may be the incident surface of the second lens (902), and the fifth surface (S5) may be the exit surface of the second lens (902). The third surface (S3) and the fifth surface (S5) of the second lens (902) may have different effective diameters. The effective diameter of the third surface (S3) of the second lens (902) may be larger than the effective diameter of the fifth surface (S5) of the second lens (902).

Although the image side of the third lens (903) has been described as being divided into the sixth surface (S6) and the eighth surface (S8), the sixth surface (S6) and the eighth surface (S8) may be the same surface representing the upper side surface of the third lens (903). The sixth surface (S6) of the third lens (903) may be the incident surface of the third lens (903), and the eighth surface (S8) may be the exit surface of the third lens (903). The effective diameters of the sixth surface (S6) and the eighth surface (S8) of the third lens (903) may be different. The effective diameter of the sixth surface (S6) of the third lens (903) may be larger than the effective diameter of the eighth surface (S8) of the third lens (903).

The diameter of the hole in the first lens (901) may be the same as the diameter of the third lens (903). The diameter of the hole in the first lens (901) may be larger than the size of the effective diameter of the third lens (903). The difference between the diameter of the hole in the first lens (901) and the effective diameter of the third lens (903) may be less than 5, and preferably less than 3.

The distance (g1) between the edge portion of the object side surface (S3, S5) of the second lens (902) and the upper side surface (S2) of the first lens (901) in the optical axis direction may be 1.2 or more and 1.5 or less. The distance (g2) in the optical axis direction between the edge portions of the upper side surface (S6, S8) of the third lens (903) and the edge portions of the object side surface (S4) of the fourth lens (904) may be 1.3 or more and 1.5 or less. The distance (g2) in the optical axis direction between the edge portions of the upper side surface (S6, S8) of the third lens (903) and the edge portions of the hole of the second lens (902) may be 1.3 or more and 1.5 or less. This minimizes flare and ghosting phenomena caused by reflection and refraction of light through the first to third lenses (901, 902, 903).

The lens unit may include a fifth lens (905). The fifth lens (905) may be the fifth lens disposed along the optical path from the object side. The fifth lens (905) may be the second lens disposed from the image side. The fifth lens (905) may be disposed between the fourth lens (904) and the image side. The fifth lens (905) may be disposed between the fourth lens (904) and the sixth lens (906). An additional lens may be disposed between the fifth lens (905) and the fourth lens (904) or between the fifth lens (905) and the sixth lens (906).

The fifth lens (905) may have a positive (+) refractive power. The fifth lens (905) may have a convex meniscus shape toward the object side. The fifth lens (905) may have an object side surface (S11) formed convexly. The fifth lens (905) may have the object side surface (S11) formed convexly relative to the optical axis. The fifth lens (905) may have an upper side surface (S12) formed concavely. The fifth lens (905) may have an upper side surface (S12) that is concave relative to the optical axis. The object side surface or upper side surface of the fifth lens (905) may include at least one inflection point.

The curvature radius of the object side surface (S11) of the fifth lens (905) may be positive. The curvature radius of the object side surface (S11) of the fifth lens (905) relative to the optical axis may be positive. The curvature radius of the upper side surface (S12) of the fifth lens (905) may be positive. The curvature radius of the upper side surface (S12) of the fifth lens (905) along the optical axis may be positive. The absolute value of the curvature radius of the object side surface (S11) of the fifth lens (905) may be smaller than the absolute value of the curvature radius of the upper side surface (S12) of the fifth lens (905). The fifth lens (905) may be a solid lens. Both surfaces of the fifth lens (905) may be formed as aspherical surfaces. One of the two surfaces of the fifth lens (905) may be formed as a spherical surface, and the other surface may be formed as an aspherical surface.

The fifth lens (905) may satisfy the range 1.6<N5<1.7. Additionally, the fifth lens (905) may satisfy the range 1.62<N5<1.69. N5 is the refractive index of the fifth lens (905). The fifth lens (905) may satisfy the range 15<V5<25. Additionally, the fifth lens (905) may satisfy the range 18<V5<22. V5 is the Abbe number of the fifth lens (905).

The lens unit may include a sixth lens (906). The sixth lens (906) may be the sixth lens disposed along the optical path from the object side. The sixth lens (906) may be the first lens disposed on the imager side. The sixth lens (906) may be disposed between the fifth lens (905) and the image side. An additional lens may be disposed between the sixth lens (906) and the image side.

The sixth lens (906) may have a negative (−) refractive power. The sixth lens (906) may have a convex meniscus shape on the object side. The sixth lens (906) may have an object side surface (S13) formed convexly. The sixth lens (906) may have the object side surface (S13) formed convexly relative to the optical axis. The sixth lens (906) may have an upper side surface (S14) formed concavely. The sixth lens (906) may have an upper side surface (S14) that is concave relative to the optical axis. The object side surface or upper side surface of the sixth lens (906) may include at least one inflection point.

The curvature radius of the object side surface (S13) of the sixth lens (906) may be positive. The curvature radius of the object side surface (S13) of the sixth lens (906) relative to the optical axis may be positive. The curvature radius of the upper side surface (S14) of the sixth lens (906) may be negative. The curvature radius of the upper side surface (S14) of the sixth lens (906) along the optical axis may be negative. The absolute value of the curvature radius of the object side surface of the sixth lens (906) may be greater than the absolute value of the curvature radius of the upper side surface of the sixth lens (906). The sixth lens (906) may be a solid lens. Both surfaces of the sixth lens (906) may be formed as aspherical surfaces. One of the two surfaces of the sixth lens (906) may be formed as a spherical surface, and the other surface may be formed as an aspherical surface. The sixth lens (906) may have a surface including one or more inflection points.

The sixth lens (906) may satisfy the range 1.5<N6<1.6. Additionally, the sixth lens (906) may satisfy the range 1.53<N6<1.58. N6 is the refractive index of the sixth lens (906). The sixth lens (906) may satisfy the range 30<V6<40. Additionally, the sixth lens (906) may satisfy the range 32<V6<38. V6 is the Abbe number of the sixth lens (906).

The lens unit may include multiple lens groups (LG1, LG2). In detail, each of the multiple lens groups (LG1, LG2) includes at least one lens. For example, the lens unit may include a first lens group (LG1) and a second lens group (LG2) disposed sequentially along the optical axis (OA) toward the image sensor (301) from the object side.

The first lens group (LG1) may include at least one lens. The first lens group (LG1) may have four or fewer lenses. The second lens group (LG2) may include two or more lenses. The second lens group (LG2) may have two to four lenses. The first lens group (LG1) may include at least one lens having a reflective surface on one side. The second lens group (LG2) may not include any lenses having a reflective surface. The first lens group (LG1) may include the first to fourth lenses (901, 902, 903, 904). The second lens group (LG2) may include the fifth to sixth lenses (905, 906).

The composite focal length (f1~4) of the first lens group (LG1) may be 10 to 20. The composite focal length (f5~6) of the second lens group (LG2) may be −5 to −20. The absolute value of the composite focal length (f1~4) of the first lens group (LG1) may be greater than the absolute value of the composite focal length (f5~6) of the second lens group (LG2). The power of the first lens group (LG1) may be smaller than that of the second lens group (LG2). The first lens group (LG1) is an area where reflection occurs twice, and the power of the first lens group (LG1) may affect the overall power of the lens unit. The second lens group (LG2), which is disposed above the first lens group (LG1), can correct aberrations and may have a smaller influence on the power of the entire lens unit. Additionally, the second lens group (LG2) may include lenses with many curvatures on one surface, enabling correction of spherical aberrations and improving the optical performance of the entire lens unit.

The lens with the minimum effective diameter in the first lens group (LG1) is the fourth lens (904), and the lens with the maximum effective diameter in the second lens group (LG2) is the sixth lens (906). The average effective diameter size of the lenses included in the first lens group (LG1) may be larger than the average effective diameter size of the lenses included in the second lens group (LG2). That is, light entering the lens unit is reflected and refracted in the first lens group (LG1) and directed toward the direction adjacent to the optical axis, then enters the second lens group (LG2). This enables the implementation of narrow-angle and telephoto optical systems.

The lens unit may include an aperture (STOP). The aperture controls the amount of light entering the optical system. For lenses disposed between an object and an aperture, there is a tendency for the effective diameter of the lens surfaces to increase as they move from the object side toward the aperture. For the lens surfaces disposed between the aperture and the sensor, there is a tendency for the effective diameter of the lens surfaces to decrease as one moves from the aperture toward the sensor side. The tendency for the effective aperture of the lens surfaces to increase or decrease does not mean that the effective diameter of the lens surfaces only increases or decreases. For example, it also includes cases where the effective diameter of the lens surfaces increases and then decreases as moving from the aperture toward the sensor side.

The optical system or camera module may include a filter (400). The filter (400) may be disposed between the lens closest to the sensor side among the lenses of the lens unit (100) and the image sensor (301). For example, the filter (400) may be disposed between the nth lens and the image sensor (301).

The cover glass may be disposed between the filter (400) and the image sensor (301), protecting the upper part of the image sensor (301) and preventing a decrease in the reliability of the image sensor (301). The cover glass may be removable. The cover glass may be a protective glass.

The filter (400) may include an infrared filter or an infrared cut-off filter (IR cut-off). The filter (400) may transmit light within a set wavelength band and filter out light from other wavelength bands. When the filter (400) includes an infrared filter, it can block radiant heat emitted from external light from being transmitted to the image sensor (301). Additionally, the filter (400) can transmit visible light and reflect infrared light.

TABLE 8

| | | | | | | Semi | Focal |
|---|---|---|---|---|---|---|---|
| Lens | Surface | Radius | Thickness | nd | vd | Aperture | length |
| L1 | S1 | −145.032 | 0.810 | 1.661 | 20.348 | 4.737 | 44.293 |
| | S2 | −24.684 | 2.544 | | | 4.636 | |
| L2 | S3 | −5.192 | 0.400 | 1.534 | 55.656 | 4.290 | −3.453 |
| | S4 | −6.457 | −0.400 | | | 4.400 | |
| | S5 | −5.192 | −1.455 | | | 3.879 | |
| L3 | S6 | −7.484 | −0.500 | 1.534 | 55.656 | 2.619 | −1.541 |
| | S7 | −3.716 | 0.500 | | | 2.048 | |
| | S8 | −7.484 | 1.455 | | | 2.058 | |
| L4 | S9 | −5.192 | 0.400 | 1.534 | 55.656 | 1.730 | −55.479 |
| | S10 | −6.457 | 0.200 | | | 1.725 | |
| L5 | S11 | 9.199 | 0.749 | 1.651 | 21.495 | 1.691 | 15.758 |
| | S12 | 78.124 | 0.375 | | | 1.808 | |
| L6 | S13 | 6.253 | 0.500 | 1.534 | 55.656 | 1.849 | −4.900 |
| | S14 | 1.800 | 0.457 | | | 2.301 | |
| IR | | Infinity | 0.210 | | | 2.418 | |
| | | Infinity | 0.556 | | | 2.439 | |
| Image | | Infinity | −0.001 | | | 2.520 | |

Table 8 shows the surface number (Surface), curvature radius (Radius), center thickness of each lens or distance between lens surfaces (Thickness), refractive index (Index, nd), Abbe number (Abbe, vd), and focal length (Focal length) of the lens according to the fourth embodiment of the present invention. Here, the units for curvature radius and thickness or distance may be mm.

Since the first lens (901) and the second lens (902) have a ring shape, the first lens (901) and the second lens (902) may refer only to the ring-shaped portions of the virtual circular-shaped lens formed by the curvature radius and thickness of the lenses in Table 9. Therefore, the data for the thickness of the first lens (901) and the second lens (902) in Table 9 may refer to the lens thickness at the optical axis of the virtual circular-shaped lens formed by the curvature radius and thickness.

TABLE 9

| | Fourth embodiment | | Fourth embodiment |
|---|---|---|---|
| TTL | 6.8000 | ΣIndex | 9.450 |
| TD(L1S1 ~L6S2) | 5.5771 | ΣAbb | 264.467 |
| F | 14.824 | ΣL_CT | 3.358 |
| f1~4 | 14.273 | CA_Max | 9.473 |
| f5~6 | −8.128 | CA_Min | 3.382 |
| Fno | 1.7068 | CA_Aver | 5.547 |
| ImgH | 5.04 | L_CT_max | 0.810 |
| FOV | 19.000 | L_CT_min | 0.400 |
| EPD | 8.686 | L_CT_aver | 0.560 |
| BFL | 1.223 | L1~L2 edge (g1) | 1.16 |
| L3~L4 distance | 1.455 | L2~L3 edge (g2) | 1.38 |
| L1 hole size | 5.4 | | |

Table 9 shows the characteristics of the imaging lens according to the fourth embodiment of the present invention.

TTL means the optical axis distance from the object side surface vertex of the first lens (901) to the image surface, TD means the optical axis distance from the object side surface vertex of the first lens (901) to the upper side surface of the sixth lens (906), F denotes the total focal length, f1 to f4 denote the composite focal lengths of the first lens (901) to the fourth lens (904), f5 to f6 denote the composite focal lengths of the fifth lens (905) to the sixth lens (906), Fno denotes the ratio of the focal length to the effective diameter of the lens, ImgH denotes the diagonal distance or maximum diagonal length of the image sensor (301), FOV denotes the diagonal field of view of the optical system, EPD denotes the diameter of the entrance pupil (effective opening), BFL denotes the optical axis distance from the upper side surface of the sixth lens (906) to the optical axis, L3~L4 distance denotes the distance between the third lens (903) and the fourth lens (904) along the optical axis, ΣIndex denotes the sum of the refractive indices of the first to sixth lenses (901, 902, 903, 904, 905, 906) constituting the lens unit, ΣAbb denotes the sum of the Abbe numbers of the first to sixth lenses (901, 902, 903, 904, 905, 906) that constitute the lens unit, ΣL_CT denotes the sum of the center thicknesses of the first to sixth lenses (901, 902, 903, 904, 905, 906) that constitute the lens unit, CA_Max denotes the maximum effective diameter of the first to sixth lenses (901, 902, 903, 904, 905, 906) that constitute the lens unit, CA_Min denotes the size of the smallest effective diameter among the first to sixth lenses (901, 902, 903, 904, 905, 906) that constitute the lens unit, CA_Aver denotes the average value of the effective diameter of the first to sixth lenses (901, 902, 903, 904, 905, 906) that constitute the lens unit, L_CT_max denotes the maximum value of the center thickness among the first to sixth lenses (901, 902, 903, 904, 905, 906) that constitute the lens unit, L_CT_min denotes the minimum value of the center thickness of the first to sixth lenses (901, 902, 903, 904, 905, 906) that constitute the lens unit, L_CT_aver denotes the average value of the center thickness of the first to sixth lenses (901, 902, 903, 904, 905, 906) that constitute the lens unit, L1 hole size denotes the diameter size of the hole in the first lens (901), L3~L4 distance denotes the distance in the optical axis direction between the third lens (903) and the fourth lens (904), L1~L2 edge (g1) denotes the distance between the edge region of the object side surface of the second lens (902) and the edge region of the upper side surface of the first lens (901), L2~L3 edge (g2) denotes the distance between the edge region of the upper side surface of the third lens (903) and the edge region of the object side surface of the fourth lens (904).

The optical system according to the third to fourth embodiments disclosed above may satisfy at least one or more of the mathematical equations described below. Accordingly, the optical system according to the third to fourth embodiments may have improved optical characteristics. For example, if the optical system according to the present embodiment satisfies at least one of the mathematical equations, the optical system can effectively control aberration characteristics such as chromatic aberration and distortion aberration, and can have good optical performance not only in the center part but also in the peripheral part of the field of view (FOV). Additionally, the optical system according to the third to fourth embodiments may have improved resolution. Furthermore, the thickness of the lens at the optical axis (OA) and the gap between adjacent lenses at the optical axis (OA) as described in the mathematical equations may be referred to the embodiments disclosed above.

$$0.1 < BFL / TTL < 0.3 \qquad [ Mathematical Equation 28 ]$$

In Mathematical Equation 28, TTL (Total track length) denotes the distance (mm) along the optical axis (OA) from the object-side surface vertex of the first lens (801, 901) to the image surface of the image sensor (301), and BFL denotes the optical axis distance from the image sensor (301) to the center of the sensor-side surface of the last lens. If the third to fourth embodiments satisfy Mathematical Equation 28, the optical system can achieve a BFL suitable for a mobile camera. Mathematical Equation 28 may preferably satisfy 0.1<BFL/TTL<0.2 in the third to fourth embodiments.

$$0. 2 < BFL / ImgH < 0.5 \qquad [ Mathematical Equation 29 ]$$

In Mathematical Equation 29, BFL is the optical axis distance from the image sensor (301) to the center of the sensor side surface of the last lens, and ImgH is the diagonal direction distance or maximum diagonal length of the image sensor (301). When the third to fourth embodiments satisfy Mathematical Equation 29, the optical system (2000) can secure the BFL (back focal length) required to accommodate the size of the image sensor (301) of the mobile camera, set the distance between the last lens and the image sensor (301), and achieve good optical characteristics in both the central and peripheral regions of the field of view (FOV). Mathematical Equation 29 may preferably satisfy 0.2<BFL/ImgH<0.3 in the third to fourth embodiments.

$$2 < F / TTL < 2.5 \qquad [ Mathematical Equation 30 ]$$

Mathematical Equation 30 may allow setting the total focal length (F) and total optical axis length (TTL) of an optical system. If an optical system according to the third to fourth embodiments satisfies Mathematical Equation 30, the optical system can have an appropriate focal length within the set TTL range. If the value is below the lower limit of Mathematical Equation 30, it is necessary to increase the refractive power of the lenses, which makes it difficult to correct spherical aberration or distortion aberration. If the value exceeds the upper limit of Mathematical Equation 30, the effective diameter of the lenses or the TTL becomes longer, which may result in the imaging lens system becoming larger. Mathematical Equation 30 is preferably satisfied in the third to fourth embodiments, where 2<F/TTL<2.2.

$$1 < TTL / ImgH < 1.5 \qquad [ Mathematical Equation 31 ]$$

Mathematical Equation 31 may allow setting the total optical axis length (TTL) of the optical system and the diagonal length (ImgH) of the image sensor. When the optical system according to the third to fourth embodiments satisfies Mathematical Equation 31, the optical system can have a TTL suitable for an image sensor for a mobile camera, thereby providing improved image quality. Additionally, the ultra-thin characteristics of the camera lens group can be effectively achieved. Mathematical Equation 31 may preferably satisfy the condition 1.3<TTL/ImgH<1.4 in the third to fourth embodiments.

$$0.5 < TTL / CA\_LlS1 < 1 \qquad [ Mathematical Equation 32 ]$$

In Mathematical Equation 32, the relationship between the total optical axis length (TTL) of the optical system and the effective diameter of the first surface (S1) of the first lens (801, 901) on the object side may be established. When Mathematical Equation 32 is satisfied, the relationship between the total optical axis length of the optical system and the effective diameter of the first lens (801, 901) through which light first enters the optical system can be established, thereby enabling both the overall size of the optical system to be miniaturized and bright images to be provided. Mathematical Equation 32 may preferably satisfy 0.5<TTL/CA_L1S1<0.8 in the third to fourth embodiments.

$$0.5 < CA\_L3S8 / CA\_L1S1 < 0.9 \qquad [ Mathematical Equation 33 ]$$

In Mathematical Equation 33, the relationship between the size of the effective diameter of the image side eighth surface (S8) of the third lens (803, 903) and the size of the effective diameter of the object side first surface (S1) of the first lens (801, 901) may be established. When Mathematical Equation 33 is satisfied, the overall size of the optical system can be miniaturized while providing a bright image. Mathematical Equation 33 may be preferably satisfied in the third to fourth embodiments, where 0.5<CA_L3S8/CA_L1S1<0.7.

$$0.5 < L1\_hole / CA\_L1S2 < 1 \qquad [ Mathematical Equation 34 ]$$

In Mathematical Equation 34, the relationship between the diameter of the hole in the first lens (801, 901) and the effective diameter of the image side first surface (S1) of the first lens (801, 901) can be established. When Mathematical Equation 34 is satisfied, the requirements of a Cassegrain optical system are met, and the balance between the effects of reflection and refraction of light is maintained. Mathematical Equation 34 may be preferably satisfied in the third to fourth embodiments, where 0.5<L1_hole/CA_L1S2<0.8.

$$0.8 < F / f 1 \sim 4 < 1.5 \qquad [ Mathematical Equation 35 ]$$

In Mathematical Equation 35, the relationship between the total focal length (F) of the optical system and the composite focal length of the first lens group (LG1), which consists of the first to fourth lenses, can be established. Mathematical Equation 35 serves as a condition equation related to the overall length and resolution performance of the optical system, particularly spherical aberration and coma aberration. When Mathematical Equation 35 is satisfied, it enables the provision of a narrow-angle optical system with a field of view (FOV) of less than 30 degrees. If the upper limit of Mathematical Equation 35 is exceeded, the overall length of the optical system decreases, but the correction effect for spherical aberration and coma aberration becomes lower. If the lower limit of Mathematical Equation 35 is not met, the overall length of the optical system increases, which is undesirable. Mathematical Equation 35 may be preferably satisfied in the third to fourth embodiments, where 1<F/f1~4<1.3.

$$0.5 < C\_L6S14 / ImgH < 1 \qquad [ Mathematical Equation 36 ]$$

In Mathematical Equation 36, the size of the effective diameter of the image side 14th surface (S14) of the sixth lens (806, 906) and the diagonal length (ImgH) of the image sensor can be set. When Mathematical Equation 36 is satisfied, the ultra-thin characteristics suitable for a mobile camera can be effectively achieved, and the peripheral light ratio can be effectively controlled. Mathematical Equation 36 may be preferably satisfied in the third to fourth embodiments, where 0.8<CA_L6S14/ImgH<1.

$$0.1 < L 3 \sim L 4 distance / TTL < 0.5 \qquad [ Mathematical Equation 37 ]$$

Mathematical Equation 37 may establish the relationship between the total optical axis length (TTL) of the optical system and the distance between the third lens (803, 903) and the fourth lens (804, 904). If the optical system according to the third to fourth embodiments satisfies Mathematical Equation 37, it can meet the requirements of a Cassegrain optical system and enable the overall size of the optical system to be miniaturized. Mathematical Equation 37 may preferably satisfy 0.1<L3~L4 distance/TTL<0.3 in the third to fourth embodiments.

$$3 < Fno / tan ( FOV ) < 7 \qquad [ Mathematical Equation 38 ]$$

Mathematical Equation 38 may establish the relationship between the field of view (FOV) and the F number (Fno) of an optical system. If the optical system according to the third to fourth embodiments satisfies Mathematical Equation 38, it can provide a bright image. Here, Fno can be provided to be less than 1.9. Mathematical Equation 38 may preferably satisfy 4<Fno/tan (FOV)<6 in the third to fourth embodiments

$$0.1 < L 1 \sim L 2 edge ( g 1 ) / TTL < 0.3 \qquad [ Mathematical Equation 39 ]$$

Mathematical Equation 39 may establish the relationship between the distance between the upper side surface (S2) edge regions of the first lens (801, 901) and the object side surface (S3, S5) edge region of the second lens (802, 902) (indicated as g1 in FIGS. 1 and 22, L1 to L2 edge) and the overall size of the optical system (TTL). Mathematical Equation 39 is an expression related to spherical aberration and coma aberration, which affect resolution performance. If the upper limit of Mathematical Equation 39 is exceeded, the size of the entire optical system increases. If the lower limit of Mathematical Equation 39 is not met, the reflected and refracted light from the first lens (801, 901) and the second lens (802, 902) change abruptly, resulting in increased spherical aberration and coma aberration, making correction difficult. Mathematical Equation 39 may preferably satisfy the condition 0.1<L1~L2 edge(g1)/TTL<0.2 in the third to fourth embodiments.

$$0.1 < L 2 \sim L 3 edge ( g 2 ) / TTL < 0.3 \qquad [ Mathematical Equation 40 ]$$

Mathematical Equation 40 may establish the relationship between the distance between the upper side surface (S6, S8) edge regions of the third lens (803, 903) and the edge regions of the hole of the second lens (802) (indicated as g2 in FIGS. 1 and 22, L2~L3 edge) and the overall size of the optical system (TTL). Mathematical Equation 40 is an expression related to spherical aberration and coma aberration, which affect resolution performance. If the upper limit of Mathematical Equation 40 is exceeded, the size of the entire optical system increases, and if it is below the lower limit of Mathematical Equation 40, the reflected and refracted light from the second and third lenses change abruptly, resulting in increased spherical aberration and coma aberration, which are difficult to correct. Mathematical Equation 40 may be preferably satisfied in the third to fourth embodiments, where 0.15<L2~L3 edge/TTL<0.25.

$$30 < \vert v 1 - v 2 \vert < 50 \qquad [ Mathematical Equation 41 ]$$

Mathematical Equation 41 may establish the relationship between the Abbe number of the first lens (801, 901) and the Abbe number of the second lens (802, 902). If the optical system according to the third to fourth embodiments satisfies Mathematical Equation 41, chromatic aberration occurring in the first lens (801, 901) and the second lens (802, 902) made of the same material or in the entire optical system can be corrected. Mathematical Equation 41 may preferably satisfy 30<|v1−v2|<45 in the third to fourth embodiments.

$$1 < \vert f 1 \sim 4 / f 5 \sim 6 \vert < 2 \qquad [ Mathematical Equation 42 ]$$

Mathematical Equation 42 may establish the relationship between the composite focal length of the first lens group (LG1), consisting of the first to fourth lenses, and the composite focal length of the second lens group (LG2), consisting of the fifth and sixth lenses. The composite focal length of the first lens group (LG1) may be greater than that of the second lens group (LG2). The first lens group (LG1) is an element that influences the overall focal length of the optical system, while the second lens group (LG2) is an element that can correct various aberrations, particularly spherical aberrations, and improve optical performance compared to the first lens group (LG1). If the optical system according to the third to fourth embodiments satisfies Mathematical Equation 42, the optical performance of the entire optical system can be ensured. Mathematical Equation 42 may preferably satisfy 1.5<|f1~4/f5~6|<2 in the third to fourth embodiments.

$$5 < \sum Index < 15 \qquad [ Mathematical Equation 43 ]$$

In Mathematical Equation 43, index denotes the sum of the refractive indices at the d-line of each of the multiple lenses. When Mathematical Equation 43 is satisfied, it is possible to control TTL in an optical system composed of aspherical lenses and achieve improved resolution. Mathematical Equation 43 may preferably satisfy 7<ΣIndex<10.

$$1.5 < F n o < 2.0 \qquad [ Mathematical Equation 44 ]$$

Mathematical Equation 44 can be used to set the range of Fno. When the optical system according to the third to fourth embodiments satisfies Mathematical Equation 44, the optical system can provide a bright image and effectively ensure the characteristic of a large aperture, thereby emphasizing the subject. Mathematical Equation 44 may preferably satisfy 1.6<Fno<1.8 in the third to fourth embodiments.

$$6 < TTL < 7.5 \qquad [ Mathematical Equation 45 ]$$

Mathematical Equation 45 may set the range of TTL, which is the distance from the center of the object side surface center of the first lens (801, 901) to the optical axis (OA) of surface of the image sensor. Since the center portion of the first lens (801, 901) is a hole, TTL refers to the distance from the center of the object side surface of the first lens (801, 901), which is virtually formed by the lens data, to the surface of the image sensor. The Mathematical Equation 45 can be used to provide a compact mobile optical system. In the third to fourth embodiments, the Mathematical Equation 45 may preferably satisfy the condition 6<TTL<7.

$$10 < FOV < 30 \qquad [ Mathematical Equation 46 ]$$

Mathematical Equation 46 can set the range of the field of view (Degree) in the diagonal direction of the optical system. When the optical system according to the third to fourth embodiments satisfies Mathematical Equation 46, the optical system can provide a mobile optical system with a telephoto angle of less than 30 degrees and a narrow angle. Mathematical Equation 46 may preferably satisfy 10<FOV<20 in the third to fourth embodiments.

$$2 < F / ImgH < 3 \qquad [ Mathematical Equation 47 ]$$

Mathematical Equation 47 may allow setting the total effective focal length (F) of the optical system and the diagonal length (ImgH) of the image sensor. Such an optical system can have improved aberration characteristics in the size of a mobile image sensor. In the third to fourth embodiments, Mathematical Equation 47 may preferably satisfy 2.5<F/ImgH<3.

$$0.1 < BFL / TD < 0.3 \qquad [ Mathematical Equation 48 ]$$

Mathematical Equation 48 may establish the relationship between the optical axis distance (TD) and the back focal length (BFL) of the lenses in an optical system. This allows the resolution of the optical system to be maintained while controlling its overall size. In the third to fourth embodiments, Mathematical Equation 48 may preferably satisfy the condition 0.1<BFL/TD<0.2. If the upper limit of Mathematical Equation 48 is exceeded, the BFL becomes significantly larger relative to the TD, resulting in an increase in the overall size of the optical system. This makes it difficult to miniaturize the optical system and increases the distance between the sixth lens (806, 906) and the image sensor, This can result in an increase in unnecessary light passing through the space between the sixth lens (806, 906) and the image sensor, which may degrade aberration characteristics and reduce resolution.

$$1.5 < CA\_L1 \sim L2\_Aver / CA\_L3 < 2.2 \qquad [ Mathematical Equation 49 ]$$

Mathematical Equation 49 may establish the relationship between the average effective diameter of the first lens (801, 901) and the second lens (802, 902) and the effective diameter of the third lens (803, 903). When the optical system according to the third to fourth embodiments satisfies Mathematical Equation 49, the size of the effective focal length of the lens surface where light reflection occurs can be set to establish a desirable reflection light path. Mathematical Equation 49 may satisfactorily satisfy the condition 1.8<CA_L1~L2_Aver/CA_L3<2.1 in the third to fourth embodiments.

$$2 < CA\_L1 \sim L2\_Aver / CA\_L4 \sim L6\_Aver < 2.5 \qquad [ Mathematical Equation 50 ]$$

Mathematical Equation 50 may establish the relationship between the average effective diameter of the first lens (801, 901) and the second lens (802, 902) and the average effective diameter of the fourth lens (804, 904), the fifth lens (805, 905), and the sixth lens (806, 906). When the optical system according to the third to fourth embodiments satisfies Mathematical Equation 50, the size of the effective focal length of the lens surface where light reflection occurs can be set to establish a desirable reflection light path. Mathematical Equation 50 may be satisfactorily satisfied in the third to fourth embodiments such that 2.2<CA_L1~L2_Aver/CA_L4~L6_Aver<2.4.

$$2 < CA\_L1 \sim L2\_Aver / CA\_L5 \sim L6\_Aver < 2.5 \qquad [ Mathematical Equation 51 ]$$

Mathematical Equation 51 may establish the relationship between the average effective diameter of the first lens (801, 901) and the second lens (802, 902) and the average effective diameter of the fifth lens (805, 905) and the sixth lens (806, 906). When the optical system according to the third to fourth embodiments satisfies Mathematical Equation 51, the size of the effective focal length of the lens surface where light reflection occurs can be set to establish a desirable reflection light path. Mathematical Equation 51 may be satisfactorily satisfied in the third to fourth embodiments such that 2.1<CA_L1~L2_Aver/CA L5~L6_Aver<2.4.

$$1.5 < CA\_Max / ImgH < 2 \qquad [ Mathematical Equation 52 ]$$

Mathematical Equation 52 may allow setting the maximum effective diameter among the lenses and the diagonal length (ImgH) of the image sensor. When the optical system according to the third to fourth embodiments satisfies Mathematical Equation 52, the optical system can maintain good optical performance and set the size for a slim and compact structure. Mathematical Equation 52 may preferably satisfy the condition 1.6<CA_Max/ImgH<1.9 in the third to fourth embodiments.

$$0.5 < CA\_Min / ImgH < 1 \qquad [ Mathematical Equation 53 ]$$

Mathematical Equation 53 may allow setting the minimum effective diameter among the lenses and the diagonal length (ImgH) of the image sensor. When the optical system according to the third to fourth embodiments satisfies Mathematical Equation 53, the optical system can maintain good optical performance and set the size for a slim and compact structure. Mathematical Equation 53 may preferably satisfy the condition 0.5<CA_Min/ImgH<0.7 in the third to fourth embodiments.

$$1 < CA\_L3 / CA\_L4 \sim L6\_Aver < 1.5 \qquad [ Mathematical Equation 54 ]$$

Mathematical Equation 54 may establish the relationship between the effective diameter of the third lens (803, 903) and the average effective diameter of the fourth lens (804, 904), fifth lens (805, 905), and sixth lens (806, 906). When the optical system according to the third to fourth embodiments satisfies Mathematical Equation 54, the size of the effective diameter of the lens surface where light reflection occurs can be set to establish a desirable reflection light path. Mathematical Equation 54 may be satisfactorily satisfied in the third to fourth embodiments such that 1<CA_L3/CA_L4~L6_Aver<1.3.

$$2.5 < CA\_Max / CA\_Min < 3 \qquad [ Mathematical Equation 55 ]$$

Mathematical Equation 55 may establish the relationship between the maximum effective diameter of the lenses and the minimum effective diameter of the lenses. If the optical system according to the third to fourth embodiments satisfies Mathematical Equation 55, the optical system can maintain good optical performance and set the size for a slim and compact structure. Mathematical Equation 55 may preferably satisfy the condition 2.5<CA_Max/CA_Min<2.8 in the third to fourth embodiments.

Table 10 shows the results of the Mathematical Equations 28 to 55 described above in the optical system of the embodiment. Referring to Table 10, it can be seen that the optical system satisfies at least one, two or more, or three or more of the Mathematical Equations 28 to 55. In detail, the optical system according to the embodiment satisfies all of the Mathematical Equations 28 to 55. As a result, the optical system can have good optical performance in both the center and peripheral regions of the field of view (FOV) and excellent optical characteristics.

TABLE 10

| | | Third | Fourth |
|---|---|---|---|
| Mathematical Equation | | embodiment | embodiment |
| 28 | 0.1 < BFL/TTL < 0.3 | 0.162 | 0.179 |
| 29 | 0.2 < BFL/ImgH < 0.5 | 0.218 | 0.243 |
| 30 | 2 < F/TTL < 2.5 | 2.173 | 2.180 |
| 31 | 1 < TTL/ImgH < 1.5 | 1.349 | 1.349 |
| 32 | 0.5 < TTL/CA_L1S1 < 1 | 0.723 | 0.718 |
| 33 | 0.5 < CA_L3S8/CA_L1S1 < 0.9 | 0.509 | 0.553 |
| 34 | 0.5 < L1_hole/CA_L2S4 < 1 | 0.559 | 0.582 |
| 35 | 0.8 < F/f1~4 < 1 | 1.005 | 1.039 |
| 36 | 0.5 < CA_L6S14/ImgH < 1 | 0.913 | 0.913 |
| 37 | 0.1 < L3~L4 distance / TTL < 0.5 | 0.207 | 0.214 |
| 38 | 3 < Fno/tan(FOV) < 8 | 5.433 | 4.957 |
| 39 | 0.1 < L1~L2 edge(g1)/TTL < 0.3 | 0.185 | 0.170 |
| 40 | 0.1 < L2~L3 edge(g2)/TTL < 0.3 | 0.192 | 0.902 |
| 41 | 30 < \|v1-v2\| < 50 | 35.308 | 35.308 |
| 42 | 1 < \|f1~4/f5~6\| < 20 | 1.747 | 1.756 |
| 43 | 5 < ΣIndex < 15 | 9.492 | 9.450 |
| 44 | 1.5 < Fno < 2.0 | 1.8706 | 1.7068 |
| 45 | 6 < TTL < 7.5 | 6.80 | 6.80 |
| 46 | 10 < FOV < 30 | 19.00 | 19.00 |
| 47 | 2 < F/ImgH < 3 | 2.931 | 2.941 |
| 48 | 0.1 < BFL/TD < 0.3 | 0.192 | 0.219 |
| 49 | 1.5 < CA_L1~L2_Aver/CA_L3 < 2.2 | 2.009 | 1.979 |
| 50 | 2 < CA_L1~L2_Aver/CA_L4~L6_Aver < 2.5 | 2.231 | 2.398 |
| 51 | 2 < CA_L1~L2_Aver/CA_L5~L6_Aver < 2.5 | 2.130 | 2.320 |
| 52 | 1.5 < CA_Max/ImgH < 2 | 1.785 | 1.859 |
| 53 | 0.5 < CA_Min/ImgH < 1 | 0.668 | 0.685 |
| 54 | 1 < CA_L3/CA_L4~L6_Aver < 1.5 | 1.110 | 1.211 |
| 55 | 2.5 < CA_Max/CA_Min < 3 | 2.669 | 2.713 |

The camera module according to the embodiment of the present invention will be described below with reference to the drawings.

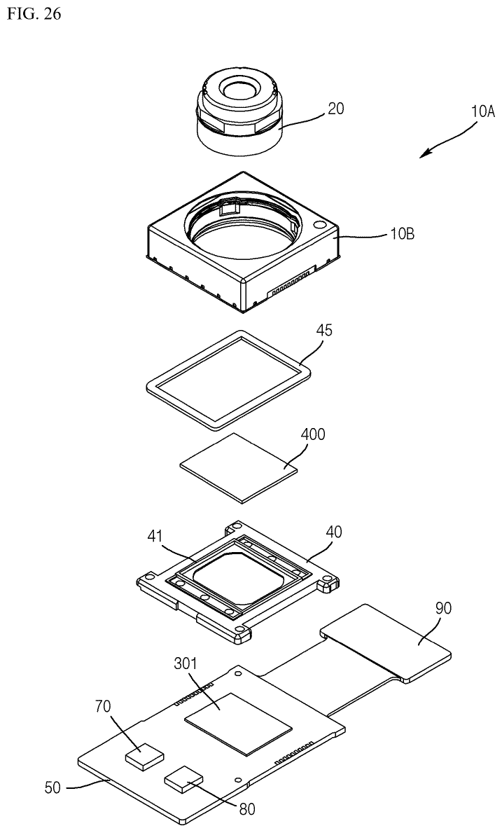

FIG. 26 is an exploded perspective view of a camera device according to the embodiment of the present invention.

The camera device (10A) may include a camera module.

The camera device (10A) may include a lens module (20). The lens module (20) may include at least one lens. The lens may be disposed at a position corresponding to an image sensor (301). The lens module (20) may include a lens and a barrel. The lens module (20) may be coupled to a bobbin (210) of the lens drive device (10B). The lens module (20) may be coupled to the bobbin (210) by screw coupling and/or adhesive. The lens module (20) may move integrally with the bobbin (210).

The camera device (10A) may include a filter (30). The filter (30) may serve to block light of a specific frequency band from passing through the lens module (20) and entering the image sensor (301). The filter (30) may be disposed parallel to the x-y plane. The filter (30) may be disposed between the lens module (20) and the image sensor (301). The filter (30) may be disposed on a sensor base (40). As a variant, the filter (30) may be disposed on the base of the lens drive device (10B). The filter (30) may include an infrared filter. The infrared filter may block infrared light from entering the image sensor (301).

The camera device (10A) may include a sensor base (40). The sensor base (40) may be disposed between the lens drive device (10B) and the printed circuit board (50). The sensor base (40) may include a protruder (41) on which the filter (30) is disposed. An opening may be formed in the portion of the sensor base (40) where the filter (30) is disposed to allow light passing through the filter (30) to enter the image sensor (301). An adhesive member (45) may be provided to bond or adhere the base (410) of a lens driving device (10B) to the sensor base (40). The adhesive member (45) may additionally serve to prevent foreign matter from entering the interior of the lens driving device (10B). The adhesive member (45) may include one or more of epoxy, thermosetting adhesive, or ultraviolet-curable adhesive.

The camera device (10A) may include a printed circuit board (PCB) (50). The printed circuit board (50) may be a substrate or a circuit board. The lens driving device (10B) may be disposed on the printed circuit board (50). A sensor base (40) may be disposed between the printed circuit board (50) and the lens driving device (10B). The printed circuit board (50) may be electrically connected to the lens driving device (10B). An image sensor (301) may be disposed on the printed circuit board (50). The printed circuit board (50) may be equipped with various circuits, devices, and controllers to convert the image formed on the image sensor (301) into an electrical signal and transmit it to an external device.

The camera device (10A) may include an image sensor (301). The image sensor (301) may be configured such that light passing through the lens and filter (30) is incident and an image is formed. The image sensor (301) may be mounted on the printed circuit board (50). The image sensor (301) may be electrically connected to the printed circuit board (50). For example, the image sensor (301) may be bonded to the printed circuit board (50) using surface mounting technology (SMT). Alternatively, the image sensor (301) may be bonded to the printed circuit board (50) using flip chip technology. The image sensor (301) may be disposed such that its optical axis aligns with the lens's optical axis. In other words, the optical axis of the image sensor (301) and the optical axis of the lens may be aligned. The image sensor (301) can convert light incident on the effective image area of the image sensor (301) into an electrical signal. The image sensor (301) may be any one of a CCD (charge-coupled device), MOS (metal-oxide semiconductor), CPD, or CID.

The camera device (10A) may include a motion sensor (70). The motion sensor (70) may be mounted on the printed circuit board (50). The motion sensor (70) may be electrically connected to a controller (80) through circuit patterns provided on the printed circuit board (50). The motion sensor (70) may output rotational angular velocity information based on the movement of the camera device (10A). The motion sensor (70) may include a two-axis or three-axis gyro sensor (Gyro Sensor) or an angular velocity sensor.

The camera device (10A) may include a controller (80). The controller (80) may be disposed on the printed circuit board (50). The controller (80) may be electrically connected to an AF coil and OIS coil of the lens driving device (10B). The controller (80) may individually control the direction, magnitude, and amplitude of the current supplied to the AF coil and OIS coil. The controller (80) may control the lens driving device (10B) to perform an auto-focus function and/or an image stabilization function. Furthermore, the controller (80) may perform auto-focus feedback control and/or image stabilization feedback control for the lens driving device (10B).

The camera device (10A) may include a connector (90). The connector (90) may be electrically connected to the printed circuit board (50). The connector (90) may include a port for electrically connecting to an external device.

Those skilled in the art related to the field of the present embodiment will understand that the methods disclosed herein may be implemented in modified forms without departing from the essential characteristics of the above-described embodiments. Therefore, the disclosed methods should be considered from an illustrative perspective rather than a limited perspective. The scope of the present invention is not limited to the above description but is defined by the scope of the appended claims, and all differences within the scope of the appended claims shall be deemed to be included in the scope of the present invention.

1. An optical system comprising: a first lens formed to have a ring shape and a third lens disposed in a center portion of the first lens and having an object-side reflective surface; a second lens formed to have a ring shape and having an image-side reflective surface; a fourth lens; a fifth lens; and a sixth lens, the first to sixth lenses being arranged in sequence from an object side to a sensor side, wherein the first lens has positive (+) refractive power and the third lens has negative (−) refractive power.

2. The optical system of claim 1, wherein the second lens has a negative (−) refractive power.

3. The optical system of claim 1, wherein the third lens has a convex meniscus shape to the sensor side.

4. The optical system of claim 1, wherein a diameter of a hole in the second lens is larger than an effective diameter of the third lens.

5. The optical system of claim 1, wherein the fourth lens and fifth lens have a positive (+) refractive power, and the sixth lens has a negative (−) refractive power.

6. The optical system of claim 1, satisfying the following condition equation:
$$5 < \vert f 4 \sim 6 / f 1 \sim 3 \vert < 20 \qquad 〈 Condition equation 〉$$
(In the above condition equation, f1~3 is a composite focal length of the first lens group (LG1), which consists of the first to third lenses, and f4~6 is a composite focal length of the second lens group (LG2), which consists of the fourth to sixth lenses).

7. The optical system of claim 1, satisfying the following condition equation:
$$0.5 < F / f 1 \sim 3 < 1 \qquad 〈 Condition equation 〉$$
(In the above condition equation, F is a total focal length of the optical system, and f1~3 is a composite focal length of the first lens group (LG1), which consists of first to third lenses).

8. An optical system, comprising: in order from an object side to a sensor side, a first lens having a reflective surface on the object side of a center portion; a second lens including a hole in a center portion and having a reflective surface on the sensor side; and at least one lens disposed on the sensor side of the second lens, wherein the first lens has refractive indices of the center portion and a peripheral portion that have different signs.

9. The optical system of claim 8, wherein the peripheral portion of the first lens has a positive (+) refractive power, and the center portions of the first lens and the second lens have a negative (−) refractive power.

10. The optical system of claim 8, wherein a size of effective diameter of the center portion of the first lens is smaller than the hole of the second lens.

11. The optical system of claim 8, wherein a curvature radius of an object side surface of the center portion of the first lens has a negative (−) value, and a curvature radius of a sensor side surface of the center portion of the first lens has a negative (−) value.

12. The optical system of claim 8, wherein the at least one lens disposed on the sensor side of the second lens comprises a fourth lens having a positive (+) refractive power, a fifth lens having a positive (+) refractive power, and a sixth lens having a negative (−) refractive power.

13. The optical system of claim 8, satisfying the following condition equation:
$$10 < FOV < 30 \qquad 〈 Condition equation 〉$$
(In the above condition equation, FOV refers to a diagonal angle of view of the optical system).

14. The optical system of claim 8, satisfying the following condition equation:
$$1 < F n o < 1.5 \qquad 〈 Condition equation 〉$$
(In the above condition equation, Fno refers to an F-number of the optical system).

15. The optical system of claim 8, satisfying the following condition equation:
$$1 < TTL / ImgH < 1.5 \qquad 〈 Condition equation 〉$$
(In the above condition equation, TTL is an optical axis distance from the object side surface of the first lens to an image sensor, and ImgH is a diagonal length of the image sensor).

16. An optical system, comprising: in order from the object side to the sensor side, a first lens comprising a hole in a center portion, a third lens disposed opposite to the hole of the first lens and having a reflective surface on the object side, a second lens formed in a ring shape and having a reflective surface on an upper side, a fourth lens disposed at a center portion of the second lens, a fifth lens, and a sixth lens, wherein the first lens has a positive (+) refractive power, and the third lens has a negative (−) refractive power.

17. The optical system of claim 16, wherein the second lens and the fourth lens have a negative (−) refractive power.

18. The optical system of claim 16, wherein the third lens has a convex meniscus shape to the sensor side.

19. The optical system of claim 16, wherein a diameter of the hole in the first lens is larger than an effective diameter of the third lens.

20. The optical system of claim 16, wherein the fourth lens and the sixth lens have a negative (−) refractive power, and the fifth lens has a positive (+) refractive power.
